(19) United States
(12) Patent Application Publication
(10) Pub. No.: US 2007/0043234 A1
(43) Pub. Date: Feb. 22, 2007

(54) Use of functionalized onium salts as a soluble support for organic synthesis

(75) Inventors: Michel Vaultier, Chateaugiron (FR); Said Gmouh, Cesson Sevignee (FR); Fatima Hassine, Rennes (FR)

Correspondence Address: YOUNG & THOMPSON, 745 SOUTH 23RD STREET, 2ND FLOOR, ARLINGTON, VA, 22202, US

(73) Assignees: CENTRE NATIONAL DE LA RECHERCHE SCIENTIFIQUE, Paris Cedex (FR); UNIVERSITE DE RENNES 1, Rennes (FR)

(21) Appl. No.: 10/563,562

(22) PCT Filed: Jul. 2, 2004
(86) PCT No.: PCT/FR04/01724

§ 371 Date: Jul. 13, 2006

(30) Foreign Application Priority Data
Jul. 9, 2003 (FR) 03/08413

(51) Int. Cl. C07F 9/28; C07F 9/02

(52) U.S. Cl. 562/1; 562/557; 564/15; 564/281

(57) ABSTRACT

The invention relates to the use of a onium salt functionalized by at least one organic function, as a soluble support, in the presence of at least one organic solvent, for organic synthesis of a molecule, in a homogenous phase, by at least one transformation of said organic function. The onium salt enables the synthesized molecule to be released. The onium salt is present in liquid or solid form at room temperature and corresponds to formula A₁⁺, X₁⁻, wherein A₁⁺ represents a cation and X₁⁻ represents an anion.

A subject of the present invention is the use of functionalized onium salts as a soluble support for organic synthesis.

Since the introduction of Merrifield's method for peptide synthesis (Merrifield, 1963), resin-type insoluble supports have been introduced into many syntheses in order to facilitate the purification of products and more particularly in the field of combinatorial chemistry during the last 10 years (Thompson et al., 1996; Toy et al., 2000; P.; Seeberger et al., 2000; V. Krchnja'k and M., W. Holladay, 2002; Mutter et al., 1979; Han et al., 1995; Harris et al., 1992; Nicolaou et al., 2002; Kates et al., 2000). Although very effective, solid-support synthesis still suffers from a certain number of problems linked to the heterogeneous nature of the reaction conditions. In fact, the non-linear kinetic behaviour, the unequal distributions, the sites which are non-accessible to reagents, the problems of salvation, of pure synthesis posed by the solid phase as well as the complex identification of the grafted resins remain major handicaps for this methodology.

The drawbacks of solid supports have led to the exploration of alternatives in order to find homogeneous reaction conditions. In fact, the use of soluble polymers bypasses the difficulties of synthesis on solid supports whilst retaining a large number of its positive features. The term “Synthesis on soluble polymer or SPOS” is used for reactions in homogeneous liquid phase carried out on a soluble functional polymer which serves as a protective group and the macromolecular properties of which facilitate the purification of the products (Haag, 2001; Haag et al., 2002; Kim et al., 2000; Kim et al., 1996; Hovestad et al., 2000; Hodge, 1997; Frank et al., 1975; Han et al., 1997).

These liquid-phase methodologies avoid the difficulties of solid-phase synthesis, for example the non-linear kinetic behaviour, the distribution (unequal access to the interaction sites), the problems of solvation linked to the nature of the support, and the operating conditions which cannot be simply transposed between the standard organic reactions in solution and the solid phase. However, by replacing the insoluble crosslinked resins with soluble polymer supports, the advantages of the solid support are retained: standard reaction conditions in homogeneous medium but also easy purification of the products. Moreover, the soluble supports present the possibility of analysis by the standard means used in organic chemistry such as UV-visible, IRTF and NMR spectroscopies as well as high-resolution mass spectrometry. Moreover, thin layer chromatography can be used to monitor the reactions without requiring preliminary cleavage of the support (Mutter et al., 1979; Han et al., 1995; Harris, 1992), which is an advantage of this technology. A rapid and effective characterization of the support is an important tool, particularly for parallel, combinatorial or multi-stage syntheses.

In the same manner as in solid phase, the soluble supports can be separated from the molecules of low molecular weight after each stage by ultrafiltration, dialysis, preparative exclusion chromatography (SEC), or precipitation. Even if the automation of these techniques is not as advanced as with resins, significant progress has been made in the last few years. The polymers which can be used as soluble supports must be commercially available or easily prepared, be chemically stable, be correctly functionalized in order to be able to attach an organic part and be very soluble in the usual solvents. In general the polymers are a mixture of molecules of different sizes which have different properties. The soluble supports should have a polydispersity as close to 1 as possible and a high enough molecular mass to be crystallized at ambient temperature. Most of the soluble polymers used have hydrocarbon skeletons (Janda polymers) or alkyl polyethers and more particularly polyethylene glycols (PEGs).

Up to now, the polymer most used as a soluble support in organic synthesis is monomethylated polyethylene glycol (MPEG 5000) containing only one OH or diol function and therefore has a low specific charge (0.2 mmol OH/g) (Mutter et al., 1974; Mutter et al., 1975; Gravert et al., 1997; Toy et al., 2000). More recently, PEGs with a higher specific charge have been prepared, being able to be purified by precipitation. These star-shaped (Chang et al., 1999; Knischka et al., 2000; Reed et al., 2000) or branched (Benaglia et al., 1998; Annunziata et al., 2000) PEGs at the terminal positions can reach specific charges of 1 mmol of OH/g of polymer but take a long time to prepare.

The linear polymers relating to the functional groups on each monomer unit, such as polyvinyl alcohol (Elias, 1997), the polyacrylamides (Wellings et al., 1987; Ranucci et al., 1994) and the polymers prepared by ROMP (“ring opening metathesis polymerization”) (Barrett et al., 1999; Barrett et al., 2000; Barrett et al., 2000) have also been used in SPOS. These polymers with a high specific charge are problematical to use in certain cases because of their limited solubility and stability (Meier et al., 2001).

Also, perfect dendrimers (polyamidoamine, polysilane, polyester) have been used as supports in combinatorial synthesis. These polymeric soluble supports with a high theoretical specific charge are fragile, with relatively low molecular weights and are prepared by multi-stage route, which limits their use in combinatorial chemistry (Burgath et al., 2000).

The aliphatic dendritic polyethers (branched analogues of PEGs) are on the other hand chemically stable under many reaction conditions and should therefore be useful as polymer supports in organic synthesis. Moreover, the chemical properties of these materials are ideal for synthesis supported in solution. Moreover, the globular form of these dendritic polymers can promote their purification by membrane techniques (dialysis and ultrafiltration). The dendrimeric aliphatic polyethers containing 1-3 diol and 1-2 diol units have recently been prepared in 6-7 stages. They have specific charges of 6-7 mmol of OH/g but they take a long time to prepare and have relatively low molecular weights (Jayaraman et al., 1998; Grayson et al., 1999; Haag et al., 2000).

Haag recently reported the controlled synthesis of dendritic polyglycerols. These aliphatic polyol polyethers have a stable skeleton and are easily prepared in one stage on a scale of 1 kg (Haag et al., 2002). They have molecular weights which can reach 30,000 g/mole with a polydispersity of Mw/Mn˜1.5. The dendrimeric structure statistically contains glycerol units incorporated linearly (primary and secondary OHs) and terminal 1,2 diols. The total density of functional groups reaches 13.5 mmol of OH/g of polymer approximately 30% (4.1 mmol/g) of which are easily accessible terminal 1,2 diols and which can be used directly for grafting aldehydes or ketones onto these polymers in the form of acetals. These dendritic polyglycerols have been used in SPOS for the functional arrangement of ω-halogenated ketones and for Suzuki coupling. Another problem results from their structure: the OH functions at the periphery which can be used for the synthesis are not identical, to the extent that there is a mixture of secondary and primary OHs which do not have the same reactivity and therefore lead to problems of selectivity and probably of secondary reactivity.

In spite of the different advantages presented by the soluble polymer supports currently used, the drawbacks linked to their high molecular weight and their limited usable specific charge are severe handicaps in generalized use. In fact, the PEGs most often used for organic synthesis and combinatorial chemistry on soluble supports have molecular weights comprised between 2000 and 10,000 daltons and have only a specific charge comprised between 0.1 and 1 mmol/g of polymer. ¹H and ¹³C NMR spectroscopy analysis of these polymers in solution can be carried out but presents difficulties as the signals corresponding to the protons and carbons of the PEGs have a strong intensity compared with the signals relating to the protons and carbons of the supported substrate. Problems of viscosity of the solutions are also encountered at high concentrations. The problems of purification of these polymers are also a severe limitation to their use and to their recycling, in particular with respect to automation of the syntheses.

For the last few years, certain onium salts referred to as “ionic liquids” (Welton et al., 1999; Wasserscheid et al., 2000; Wasserscheid and Welton, 2003), with an appropriate choice of anions, are increasingly used in organic synthesis and in catalysis as they have a certain number of useful and significant physico-chemical properties such as their great thermal stability, their low volatility and their very low vapour pressure, their low flammability, their high solubilization power both of the salts and the neutral organic molecules and the polymers and finally the possibility of easy recycling.

However, the onium salts described in the literature are generally synthesized and used as such for their biological or physical properties (surfactants for example).

The purpose of the present invention is to provide a novel use of onium salts as soluble supports for organic synthesis in homogeneous phase in the presence of at least one organic solvent.

The purpose of the present invention is to provide novel soluble supports for organic synthesis in the presence of at least one solvent, by replacing the soluble supports of the prior art such as PEGs, said novel soluble supports being easier to prepare, use and purify, perfectly defined and identified, less expensive and easy to functionalize.

The purpose of the present invention is to provide novel soluble supports having a high specific charge, the recycling of which is easy.

The present invention relates to the use of an onium salt functionalized by at least one organic function, as a soluble support, in the presence of at least one organic solvent, for the organic synthesis of a molecule, in homogeneous phase, by at least one conversion of said organic function, said onium salt allowing the release of the synthesized molecule,

said onium salt being presented in liquid or solid form at ambient temperature, and corresponding to the formula A₁⁺, X₁⁻,

in which:
A₁⁺ represents a cation,
X₁⁻ represents an anion,

A₁⁺ being a functional or polyfunctional cation, and/or

X₁⁻ being a functional or polyfunctional anion,

the onium salt being as in its initial form, i.e. before the first conversion of said organic function, A₁⁺ and X₁⁻ are not bound together by a covalent bond,

and when the anion and the cation respectively carry an organic function, these cannot react with each other before the first conversion of said organic function.

The use as a soluble support, i.e. in solution in a solvent or a mixture of solvents, of onium salts is demonstrated within the scope of the invention. This was not a priori evident given the knowledge about these salts. In the form of halides, they are generally not very soluble in the usual solvents used in organic chemistry. Moreover, their functionalization can, a priori, pose problems of chemoselectivity because of the presence of a positively charged onium group which is subject to β-elimination or to deprotonation in α position in basic medium.

The expression “functionalized onium salt” designates the ammonium, phosphonium, sulphonium salts, as well as all the salts resulting from the quaternization of an amine, phosphine, arsine, thioether or of a heterocycle containing one or more of these heteroatoms, and carrying at least one organic function Fᵢ or F′ᵢ. This expression also designates an onium salt the cation of which as defined above is not functionalized but the anion of which carries a function F′ᵢ. This expression can also designate a salt the anion and the cation of which carry at least one organic function.

The expression “soluble support” designates a functional polymer molecule or a salt serving as “anchor” in order to carry out, in solution, successive conversions of a molecule attached by the function. This anchor confers properties to the attached molecule (therefore finally to the assembly formed by the anchor and the attached molecule) which allow easy purification by washing, evaporation or any other technique. This could not be done easily with molecules which are volatile and/or soluble in the usual solvents for example. By using this technique, it is possible to use an excess of reagents, for example, as in the case of insoluble Merrifield resins. A soluble support must by definition be soluble in a solvent. This confers the advantage of carrying out the reactions in solution and being able to monitor their progress using analysis techniques in a standard fashion used in the field of organic chemistry. A soluble support must also be recoverable at the end of the conversions. In other words, the molecules synthesized on this support must be able to be easily released. Moreover, the skeleton of the soluble support must not react with the reagents used, the reactions taking place selectively on the functions attached to the basic skeleton.

The expression “organic synthesis of a molecule in homogeneous phase” designates the conversion or conversions of the chemical function or functions carried by said onium salt, followed by a cleavage reaction releasing the sought molecule in solution in a given solvent or in a mixture of solvents and the starting salt or a recyclable salt in the starting support.

The expression “functional cation” designates a molecular group which possesses at least one chemical function, as well as a head-carrying a positive charge.

The expression “functional anion” designates a molecular group which possesses at least one function chemical, as well as a head carrying a negative charge.

The abovementioned onium salts are solubilized in an organic solvent or in a mixture of organic solvents then brought into the presence of an excess or non-excess of reagent. They are then used as soluble supports. Another property of these salts is that they are not soluble in certain usual solvents such as ether, alkanes or hydrocarbons for example. Moreover, they have extremely low vapour pressures and can therefore be placed under a high vacuum without losses. These two properties allow the use of an excess of reagent which is then easily eliminated by washing, by extraction or under high vacuum as in the case of reactions on resins or on PEG. A large number of chemical conversions of the functional onium salts are possible. These salts can be used as resins or soluble polymers.

The specific charge of a support is defined by the quantity of reagent which can be supported per gram of support and is expressed in mmol/g. This in fact corresponds to what could be called the specific functionality of a support denoted f which can be expressed in millifunctions per gram (mf/g). If the salt is monofunctional, the specific functionality (f expressed in mf/g) is equal to the specific charge expressed in mmol/g. If the salt carries n times the same function, the specific functionality f is equal to n times the specific charge x of the salt. When the onium salts are in solution, which is practically always the case, the concepts defined above must be adapted. The molarity of a solution is expressed in mol/l or in mmol/ml. Knowing the density of the solutions, it is then easy to convert to mmol/g of solution thus producing precise elements on the specific charge of the solutions for comparison with Merrifield resins or the solutions of polymer-type soluble supports (PEG or others).

If the salt carries n times the same function, a solution containing for example a millimole of this salt per gram has a specific functionality f of n mf/g.

The monofunctionalized onium salts as used within the scope of the present invention have a specific charge greater than 1 mmol·g⁻¹ and are able to reach up to 7 mmol·g⁻¹, compared to that of PEG 5000 which is 0.2 mmol·g⁻¹.

The expression “conversion of the organic function” designates the modification of a function Fᵢ by one or more reagents and/or catalysts and/or by physical activation (heating, micro-waves, ultrasound, hv radiations, pressure, electrochemistry etc.).

The expression “onium salt in its initial form” designates the salt in which the initial organic function has not yet undergone conversion, i.e. has not yet been involved in a reaction, this function being hereafter designated F₀.

The expression “first conversion of the organic function” designates the modification of the initial organic function carried by the onium salt in its initial form, which is symbolized hereafter by the modification of F₀ to F₁.

A salt in which the cation and the anion respectively carry an initial organic function named F₀ and F′₀, and in which the anion and the cation do not react together before the first conversion of said organic functions, is a salt in which the functions F₀ and F′₀ are chemically compatible or also chemically inert in relation to each other. This therefore means that the salt in question is stable. F₀ and F′₀ can on the other hand react together under the effect of any activation which can be physical (hv radiations, micro-waves, pressure, heating etc.) or chemical (catalyst, other reagent etc.)

This novel fashion of carrying out supported synthesis is also called OSSOS (Onium Salt Supported Organic Synthesis).

An advantageous use according to the invention is characterized in that the onium salt is purified and/or recycled in its initial form after the release of the synthesized molecule.

The preferred processes for purification and/or recycling used are in particular a simple process of washing or recrystallization from an appropriate solvent.

An advantageous use of the present invention is characterized in that the functional cations and anions correspond to an ionic entity, cationic Y⁺—and anionic Z⁻—respectively, optionally bound by means of an arm, L and M respectively, in particular an alkyl or aralkyl or alkaryl group comprising 1 to 30 carbon atoms, to at least one function Fᵢ and F′ᵢ respectively, Fᵢ varying from F₀ to Fₙ, F′ᵢ varying from F′₀ to F′ₙ, n being an integer varying from 1 to 20,

the functional cation A₁⁺ being able to be represented in the form Y⁺-L-Fᵢ, and

the functional anion X₁⁻ in the form Z⁻-(M)ₖ-F′ᵢ, k being equal to 0 or 1.

The expression “ionic entity” designates the part of the cation or anion which carries the charge, positive or negative respectively.

The functions Fᵢ and F′ᵢ are in particular chosen from the following functions:

hydroxyl, carboxylic acid, amide, sulphone, primary amine, secondary amine, aldehyde, ketone, ethenyl, ethynyl, dienyl, ether, epoxide, phosphine (primary, secondary or tertiary), azide, imine, ketene, cumulene, heterocumulene, thiol, thioether, sulphoxide, phosphorated groups, heterocycles, sulphonic acid, silane, stannane or functional aryl, and any function resulting from a conversion of the preceding functions by chemical route or induced by thermal, electrochemical, photochemical activation or by any other physical technique such as micro-wave irradiation, ultrasound or pressure.

In the term “Y⁺—”, the dash “—” represents the optional bond between the cationic entity and the L arm.

In the term “Z⁻—”, the dash “—” represents the optional bond between the anionic entity and the L arm.

The term “L arm” designates an alkyl or aralkyl or alkaryl chain which can contain one or more heteroatoms such as nitrogen, phosphorus, sulphur, oxygen, silicon, tin, containing between 1 and 30 carbon atoms, and said arm is in particular chosen from an alkyl chain containing from 2 to 20 carbon atoms and from 1 to 6 of oxygen nitrogen atoms.

According to an advantageous embodiment, the functionalized onium salt A₁⁺, X₁⁻ used within the scope of the present invention is soluble in a organic solvent.

According to an advantageous embodiment, the functionalized onium salt A₁⁺, X₁⁻ used within the scope of the present invention is liquid at ambient temperature.

According to an advantageous embodiment, the onium salt A₁⁺, X₁⁻ used within the scope of the present invention is solid at ambient temperature and can be liquefied within a range of temperatures ranging from approximately 25° C. to approximately 450° C., in particular from approximately 30° C. to approximately 150° C.

An advantageous use of the invention is characterized in that the organic functions Fᵢ and F′ᵢ are chosen from the standard functions of organic chemistry, such as the hydroxyl functions, carboxylic acid, amide, sulphone, primary amine, secondary amine, aldehyde, ketone, ethenyl, ethynyl, dienyl, ether, epoxide, phosphine (primary, secondary or tertiary), azide, imine, ketene, cumulene, heterocumulene, thiol, thioether, sulphoxide, phosphorated groups, heterocycles, sulphonic acid, silane, stannane or functional aryl.

An advantageous use of the present invention is characterized in that the molecular weight of the functionalized onium salt is less than 1500 g·mol⁻¹, in particular less than 750 g·mol⁻¹, and is preferably comprised from 130 to 500 g·mol⁻¹.

In order to ensure a good productivity of the support, it is necessary for the molecular mass of the salt to be as low as possible (owing to the specific charge as defined previously). Thus, anions with the lowest possible mass, such as the chlorides, are preferably used in order to be able to optionally use cations with a higher mass (see Table 17 below representing the variations in specific charge as a function of mass).

An advantageous use of the present invention is characterized in that A₁⁺ is a functional cation and in that X₁⁻ is a non-functional anion.

The expression “non-functional anion” designates a molecular group which does not possess any chemical function, part of this group carrying a negative charge.

This embodiment makes it possible to carry out specific reactions on the cationic part of the onium salt. It is therefore possible to control the selectivity and the reactivity which could be different on the anion and the cation.

The present invention also relates to a use as defined above, in which the onium salt A₁⁺, X₁⁻ has as its initial form Y⁺-L-F₀, X₁⁻, for obtaining a molecule G, by conversion of said initial function F₀ according to the diagram
Y⁺-L-F₀,X₁⁻→Y⁺-L-Fᵢ,X₁⁻→ . . . →Y⁺-L-Fₙ,X₁⁻→G+Y⁺-L-F₀,X₁⁻

L being as defined above,

said molecule G being obtained by cleavage at the level of the function Fₙ,

and the functionalized onium salt being able to be recovered or recycled in its initial form Y⁺-L-F₀, X₁⁻, after the release of G.

The reactions used for the release of G by cleavage are in particular the following: transesterification, transamidation, reduction, lactonization, lactamization, releasing cyclization and releasing coupling.

An advantageous use of the invention is characterized in that the functional cation A₁⁺ is chosen from the pyridinium, imidazolium, ammonium, phosphonium or sulphonium cations, cyclic or non-cyclic, substituted or non-substituted, and preferably ammonium or phosphonium.

An advantageous use according to the invention is characterized in that the functional cation A₁⁺ is chosen from the quaternary ammonium cations, cyclic or non-cyclic.

An advantageous use according to the invention is characterized in that X₁⁻ is a functional anion and A₁⁺ is a non-functional cation.

The expression “non-functional cation” designates a molecular group which possesses no chemical function, part of this group carrying a positive charge.

This embodiment makes it possible to carry out functional modifications only on the anionic part.

The present invention also relates to a use as defined above, in which the onium salt A₁⁺, X₁⁻ has as its initial form A₁⁺, Z⁻-(M)ₖ-F′₀, for obtaining a molecule G, by conversion of said initial function F′₀ according to the diagram
A₁⁺,Z⁻-(M)ₖ-F′₀→A₁⁺,Z⁻-(M)ₖ-F′ᵢ→ . . . → A₁⁺,Z⁻-(M)ₖ-F′ₙ→G+A₁⁺,Z⁻-(M)ₖ-F′₀

k and M being as defined above, said molecule G being obtained by cleavage of the function F′ₙ, and the functionalized onium salt being able to be recovered or recycled in its initial form A₁⁺, Z⁻-(M)ₖ-F′₀, after the release of G.

The reactions used for the release of G by cleavage are in particular the following: transesterification, transamidation, reduction, lactonization, lactamization, releasing cyclization and releasing coupling.

An advantageous use of the invention is characterized in that X₁⁻ is chosen from:
the family of the phosphates: R₁PO₄²⁻, R₁R₂PO₄⁻,
the family of the sulphates: R₁SO₄⁻,
the family of the sulphonates: R₁SO₃⁻,
the family of the carboxylates: R₁CO₂⁻,

or from the following anions:

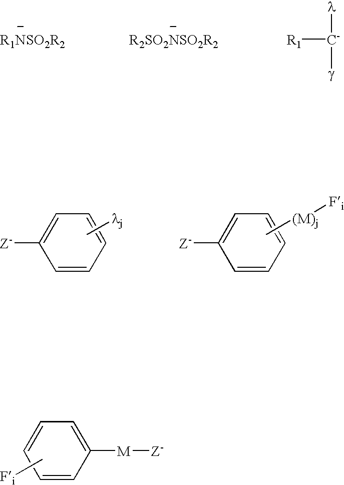

Z⁻, M and F′ᵢ being as defined above, Z⁻ representing in particular O⁻, SO₃⁻, CO₂⁻, R₁PO₃⁻ or R₁PO₂⁻,

j representing an integer comprised between 1 and 5,

R₁ and R₂ being able to represent independently of one another a functional alkyl group, a vinyl or alkynyl group, optionally functional, comprising from 1 to 20 carbon atoms, or being able to represent a functional aryl group comprising from 6 to 30 carbon atoms,

γ and λ representing an electroattractive group, in particular chosen from the groups: CO₂R′₁, SO₂R′₁, CN, NO₂, P(O)(OR′₁)₂, C(O)R′₁ and SO₃R′₁,

R′₁ representing an alkyl group, optionally functional, comprising from 1 to 20 carbon atoms, or an aryl group, optionally functional, comprising from 6 to 30 carbon atoms.

An advantageous use according to the invention is characterized in that A₁⁺ is a functional cation and X₁⁻ is a functional anion.

This embodiment makes it possible to carry out conversions in parallel as well as the intra- or intermolecular reaction of a function of A₁⁺ with a function of X₁⁻.

The present invention also relates to a use as defined above, in which the onium salt A₁⁺, X₁⁻ has as its initial form Y⁺-L-F₀, Z⁻-(M)ₖ-F′₀, for obtaining a molecule G, by conversion of said initial functions F₀ and F′₀ according to the diagram
Y⁺-L-F₀,Z⁻-(M)ₖ-F′₀→Y⁺-L-Fᵢ,Z⁻-(M)ₖ-F′ᵢ→ . . . →Y⁺-L-Fₙ,Z⁻-(M)ₖF′ₙ

L, k and M being as defined above,

and by reaction of Fₙ on F′ₙ in the functionalized onium salt Y⁺-L-Fₙ, Z⁻-(M)ₖ-F′ₙ

leading to the formation of an internal salt of formula:
Y⁺-L-Fₙ₊₁-F′ₙ₊₁-(M)ₖ-Z⁻

said molecule G being obtained by cleavage of the abovementioned internal salt and corresponding to the formula F₊₂-F′ₙ₊₂,

and the functionalized onium salt being able to be recovered or recycled in its initial form Y⁺-L-F₀,Z⁻-(M)ₖ-F′₀, after the release of G.

This embodiment makes it possible to carry out intramolecular reactions.

The expression “internal salt” designates an entity simultaneously carrying at least one positively charged group and one negatively charged group, separated by at least 2 atoms, linked by covalent bonds.

A use according to the present invention is characterized in that the onium salt is chosen from the following salts:

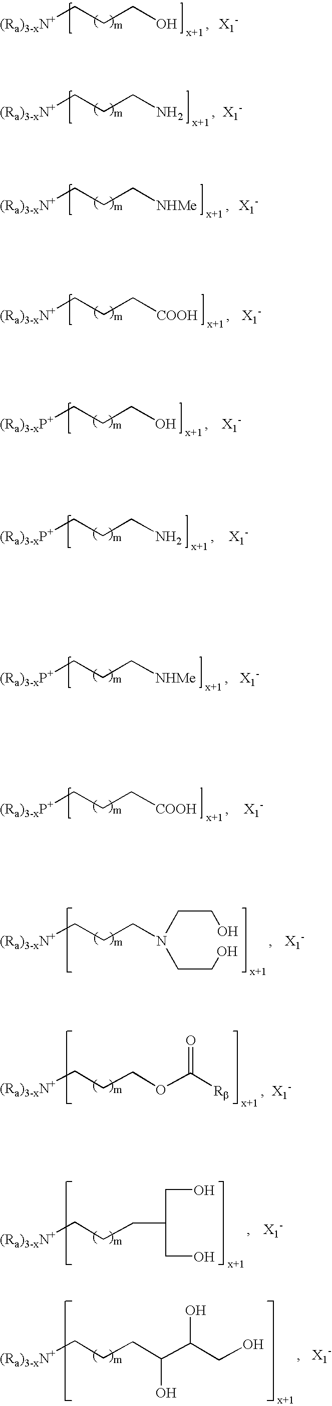

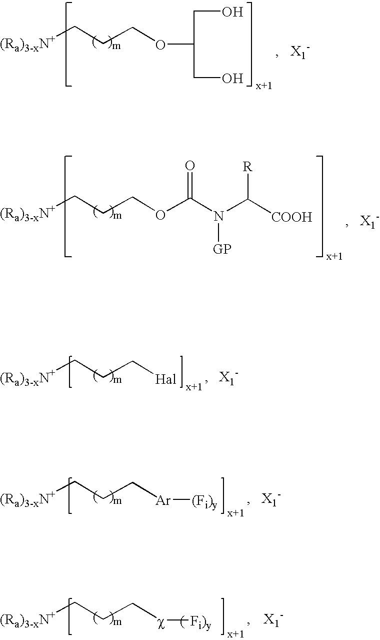

R representing a hydrogen atom, an alkyl, alkaryl or aralkyl group, functional or non-functional, comprising from 1 to 20 carbon atoms, or an aryl group, functional or non-functional, comprising from 6 to 30 carbon atoms,

x representing an integer comprised from 0 to 3,

y representing an integer comprised from 1 to 5,

Ar representing a functional or polyfunctional aromatic ring,

Fᵢ being as defined previously,

Hal representing a halogen atom, in particular chosen from chlorine, bromine and iodine,

λ representing a carbocycle or a functional heterocycle,

X₁⁻ being chosen from: NTf₂⁻, PF₆⁻, BF₄⁻, Cl⁻, Br⁻, I⁻, CF₃SO₃⁻, MeSO₄⁻, EtSO₄⁻, MeSO₃⁻, C₆H₅SO₃⁻, pMeC₆H₄SO₃⁻,

m being an integer comprised from 0 to 20,

R_{β} representing a dienyl, vinyl group, substituted or non-substituted, functional alkyl comprising from 1 to 20 carbon atoms, or functional aryl comprising from 6 to 30 carbon atoms, substituted or non-substituted alkynyl, and being in particular an alkylvinyl, alkylalkynyl, alkylaryl, alkyldienyl, alkylmnalonyl, acyl group,

and Rₐ representing a branched or non-branched alkyl group comprising from 1 to 20 carbon atoms, in particular an ethyl, propyl, butyl, pentyl, hexyl, heptyl or octyl group.

The present invention also relates to a use as defined above, characterized in that the solvent or solvents used are aprotic solvents, chosen from:
solvents the dielectric constant ε of which is less than or equal to 2, such as the alkanes, the aromatic carbides such as benzene, toluene or xylene,

solvents the dielectric constant ε of which is comprised between approximately 2 and 15, such as the ethers, halogenobenzenes or dichloromethane, and

solvents the dielectric constant ε of which is greater than 15, such as acetonitrile, nitromethane, DMF or dimethylacetamide.

The dielectric constant ε and/or the dipole moment are often used to characterize the polarity of a solvent. More recently, the Dimroth-Reichardt parameter E_{T}^{N} has been proposed in order to better describe the polarity of the solvents (Reichardt, 1988).

The solvents advantageously used in the invention are toluene, dichloromethane, THF, acetonitrile and DMF.

The present invention also relates to a use as defined above, for continuous, discontinuous, combinatorial or parallel organic synthesis, and/or for the preparation of banks of products.

The advantages of the use of the abovementioned onium salts are the following:
a large number of functional onium salts are known, which are easily accessible and certain of which are commercial;
the functional modifications of the onium salts are generally simple and easy to carry out according to methods described in the literature; if they do not exist, they can be worked out from knowledge of organic chemistry;
the reactions take place in homogeneous phase, which means that any knowledge of reactivity in organic, organometallic and catalytic chemistry is applicable; moreover, all analysis techniques, including ¹H, ¹³C, ¹⁹F, ³¹P, ¹¹B, ¹⁵N NMR etc., HPLC, IRTF, UV-visible, fluorescence, electrochemical techniques, electrophoresis, mass spectrometry etc., can be used under normal conditions without particular complications;
the reactions are carried out at the usual concentrations of 0.5 to 1 mole per litre (or even much more) which represents a huge advantage in terms of specific charge;
purification of the intermediates is generally easy;
the recycling of these supports is easy;
the solutions of salts in the usual solvents are easily transferable using syringe and/or pumping techniques;
the solutions of onium salts in the organic solvents easily lend themselves to partition techniques and therefore to parallel or combinatorial synthesis techniques; libraries of products can therefore be easily synthesized;
the reactivities and selectivities depend on the nature of the anion or the cation;
scaling-up does not pose any problems, which is a major advantage compared with resins and soluble polymers;
an analogy is easily established between this novel technology and synthesis techniques on Merrifield-type resins or soluble polymers of PEG, PG or JANDA type; these onium salts can be functionalized as Wang, Rink, silylalkyl, carbonate, carboxylic, formyl, hydroxyl, amino, oxime resins etc. or the functionalized polymers but are much easier and more advantageous to use;
they are much less expensive; this economic advantage is very important, being of a kind to open up a large substitution market.

The present invention also relates to a use as defined above, for the implementation of cycloaddition reactions, preferably for the implementation of the Diels-Alder reaction, according to one of the following reaction diagrams:

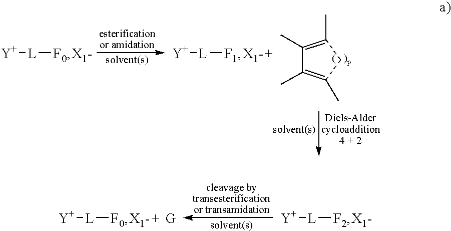

p being an integer varying from 0 to 2,

Y⁺— representing an onium cation as defined previously, and preferably being a trimethylalkylammonium, triethylalkylammonium, tributylalkylphosphonium, N-methylimidazolium or pyridinium cation,

L representing an aim, in particular a linear or branched alkyl group comprising from 1 to 20 carbon atoms, or an optionally functional aralkyl or alkaryl group, comprising from 6 to 30 carbon atoms, and preferably being a linear alkyl group, preferably a linear alkyl group of type (CH₂)ᵣ, r varying from 1 to 20, and preferably from 2 to 10,

X₁⁻ being as defined previously, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

the functions F₀, F₁, and F₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 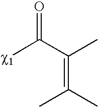
   λ₁ being as defined above,
F₂ corresponds to the following formula: 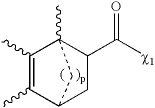
   λ₁ being as defined above,

G corresponding to the following formula:

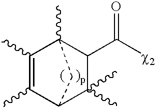

in which λ₂ represents either an OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms,

the esterification or amidation reaction in this reaction diagram being carried out by adding carboxylic acid of the following formula:

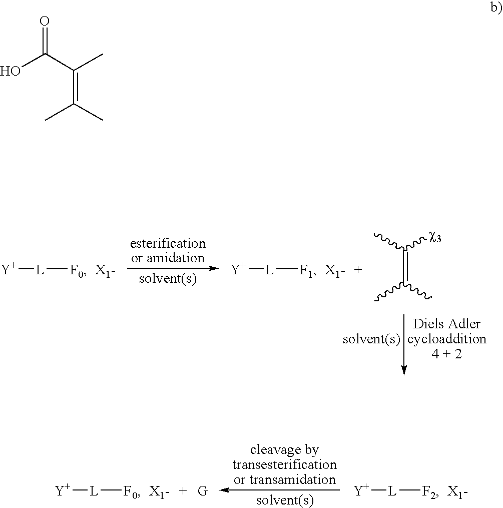

Y⁺—, L and X₁⁻ being as defined previously,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, or a mixture of these solvents,

the functions F₀, F₁, and F₂ being as defined below:
F₀ represents any function making it possible to attach a 1,3-diene, and is in particular chosen from the carbonyl, amine, alkoxy, silane, stannane and borane functions, comprising from 1 to 20 carbon atoms,
F₁ corresponds to the following formula: 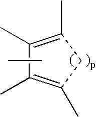
   p being an integer varying from 0 to 2,
F₂ corresponds to the following formula: 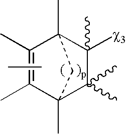
   λ₃ representing an electroattractive group, in particular chosen from the cyano, alkoxycarbonyl groups, comprising from 1 to 20 carbon atoms, acyl comprising from 2 to 20 carbon atoms, benzoyl, sulphonyl, dialkoxyphosphonyl comprising from 1 to 10 carbon atoms,

G corresponding to the following formula: 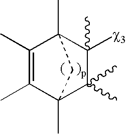
λ₃ being as defined above.

The passage from F₀ to F₁ is carried out as follows:
by esterification between the compound of formula Y⁺-L-OH X₁⁻ and the compound of formula 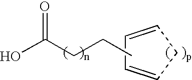
   or one of its derivatives such as an acid chloride in order to obtain the following compound: 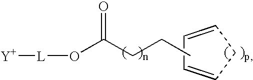
   X₁⁻
by acylation between the compound of formula 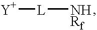
   X₁⁻ and the compound of formula 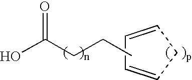
   or one of its derivatives such as an acid chloride in order to obtain the following compound: 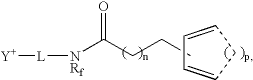
   X₁⁻

The product of formula 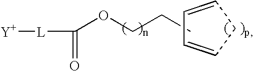
X₁⁻ is obtained by esterification of alcohols of formula 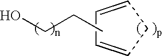
with Y⁺-L-COOH, X₁⁻ or Y⁺-L-COCl, X₁⁻

The product of formula 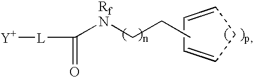
X₁⁻ is obtained by acylation of the amines of formula 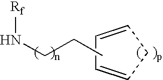
with Y⁺-L-COOH, X₁⁻ or Y⁺-L-COCl, X₁⁻

n, R_{f}, p, X₁⁻, Y and L being, as defined previously,

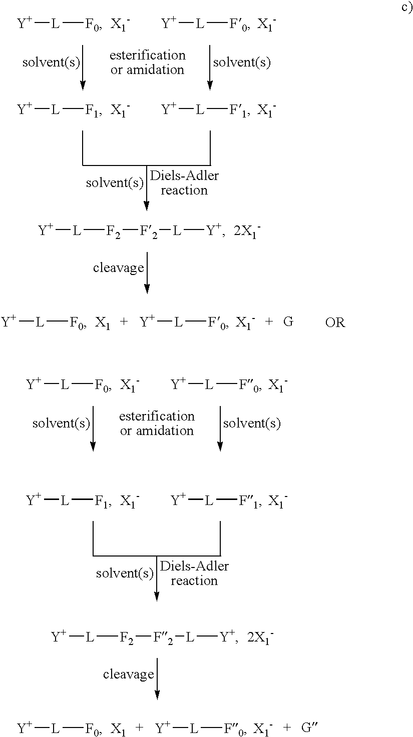

Y⁺—, L and X₁⁻ being as defined previously,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

the functions F₀, F′₀, F″₀, F₁, F′₁, F″₁, F₂, F′₂ and F″₂ being as defined below:
F₀ and F′₀ correspond respectively to a −λ₁H and −λ′₁H group, in which λ₁ and λ′₁, identical or different, represent an oxygen atom or an —NR_{f} group, R_{f} corresponding to a linear or branched alkyl group, comprising from 1 to 20 carbon atoms, or an aryl group comprising from 6 to 30 carbon atoms,
F″₀ corresponds to a —COOH function;
F₁ corresponds to the following formula: 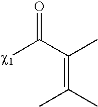
   λ₁ being as defined above,
F′₁ corresponds to the following formula: 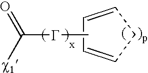
p being an integer varying from 0 to 2,
λ′₁ being as defined above,
x being equal to 0 or 1,
Γ representing an alkyl chain comprising from 1 to 30 carbon atoms, alkaryl, aralkyl, aryl comprising from 6 to 30 carbon atoms,
F″₁ corresponds to the following formula: 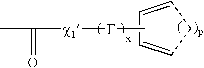
p, x and Γ being as defined above,
λ′₁ being as defined above,
F₂-F′₂ corresponds to the following formula: 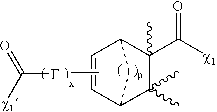
p, λ₁, λ′₁, x and Γ being as defined above,
F₂-F″₂ corresponds to the following formula: 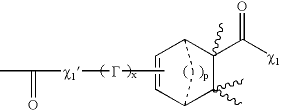
p, λ₁, λ′₁, x and Γ being as defined above,
G corresponds to the following formula: 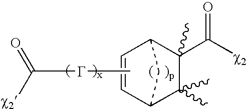
G″ corresponds to the following formula:

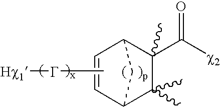

λ₂ and λ′₂, identical or different, represent either an OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms.

In the last reaction diagram (case c):
the passage from F₀ to F₁ is carried out by esterification or amidation of the carboxylic acid of formula 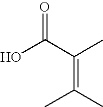
the passage from F′₀ to F′₁ is carried out by esterification or amidation of the carboxylic acid of formula

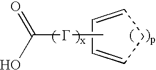

Γ, x and p being as defined above,
the passage from F″₀ to F″₁ is carried out by the addition of the compound of formula

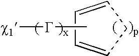

Γ, x, p and λ′₁ being as defined above.

The present invention relates to the use as defined above, for the implementation of coupling reactions such as the Heck, Suzuki, Sonogashira or Ullmann reactions.

The present invention also relates to the use as defined above for the implementation of the Heck reaction, according to one of the following reaction diagrams:

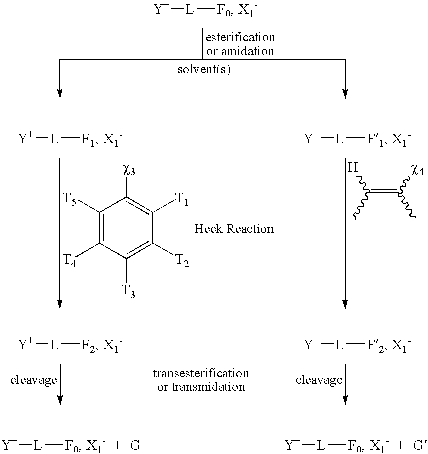

Y⁺— representing an onium cation as defined above, and preferably being a trimethylalkylammonium, triethylalkylammonium, tributylalkylphosphonium, tricyclohexylalkylphosphonium, N-methyl-N′-alkylimidazolium, N-alkylpyridinium, dimethylalkylsulphonium, diethyl-alkylsulphonium cation,

L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 2 to 10,

X₁⁻ being as defined above, and being in particular Cl⁻, Br⁻, F, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

the functions F₀, F₁, F′₁, F₂ and F′₂ being as defined below:
F₀ corresponds to a λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to one of the following formulae:

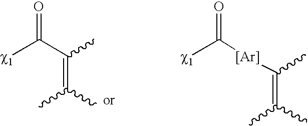

λ₁ being as defined above,

[Ar] representing an aromatic ring, optionally substituted by a linear or branched alkyl group, comprising from 1 to 20 carbon atoms or an aryl group comprising from 6 to 30 carbon atoms, or a functional group in particular chosen from NO₂, CN, COOR, OR, COR, NHCOR, NRR′, SO₂R, I, Br, R and R′ representing independently of one another an alkyl group comprising from 1 to 20 carbon atoms or an aryl group comprising from 6 to 30 carbon atoms, [Ar] preferably corresponding to the following formula: 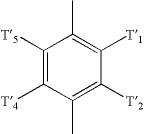
in which T′₁, T′₂, T′₄ and T′₅ represent independently of one another a hydrogen atom, a linear or branched alkyl group, comprising from 1 to 20 carbon atoms or an aryl group comprising from 6 to 30 carbon atoms, or a functional group in particular chosen from NO₂, CN, COOR, OR, COR, NHCOR, NRR′, SO₂R, I, Br, R and R′ representing independently of one another an alkyl group comprising from 1 to 20 carbon atoms or an aryl group comprising from 6 to 30 carbon atoms,
F₂ corresponds to one of the following formulae:

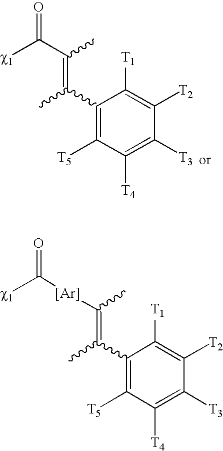

λ₁ and Ar being as defined above, T₄

T₁, T₂, T₃, T₄ and T₅ corresponding to the definition given above for T′₁, T′₂, T′₄ and T′₅

G corresponding to one of the following formulae: 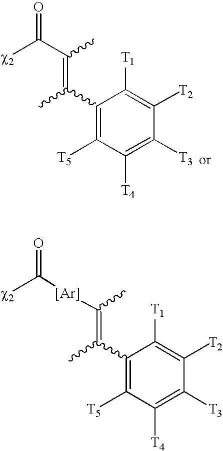
in which λ₂ represents either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms,

λ₃ representing a leaving group, in particular chosen from the I, Cl and Br halides, the mesylate, tosylate, triflate, sulphonate, sulphate or phosphate groups,

the entity 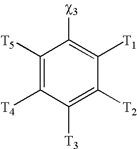
representing in particular the following groups: 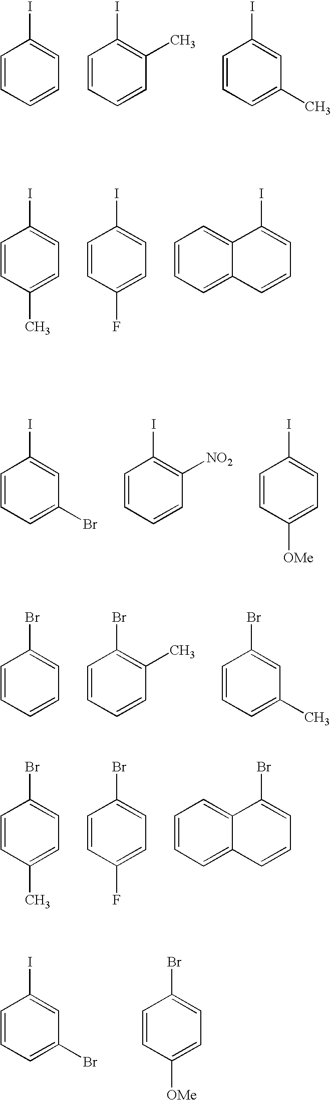
F′₁ corresponds to the following formula: 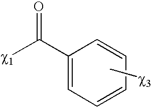
λ¹ and λ₃ being as defined above,
F′₂ corresponds to the following formula: 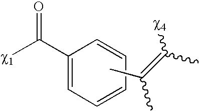
λ₁ being as defined above,
λ₄ representing a functional group of ester, amide, sulphone, phosphonate, silane, borane type, or a functional or non-functional alkyl group, comprising from 1 to 20 carbon atoms, or a functional or non-functional aryl group, comprising from 6 to 30 carbon atoms.

G′ corresponding to the following formula: 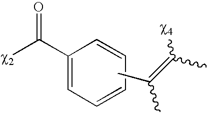
λ₂ and λ₄ being as defined above.

The left-hand part of the above reaction diagram corresponds to the binding of the acrylic radical to the support and the right-hand part of the above diagram corresponds to the binding of the arylic radical to the support.

The passage from F₀ to F₁ is carried out by the esterification of the carboxylic acid of formula

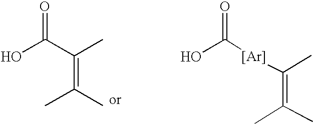

The passage from F′₀ to F′₁ is carried out by the esterification of the carboxylic acid of formula 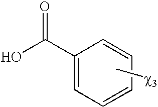
λ₃ being as defined above.

The Heck reaction can be carried out in three different fashions:
by supporting the acrylic part as follows:

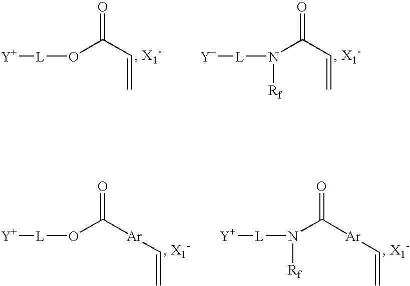

Y⁺—, X₁⁻, L, Ar and R_{f} being as defined above,
by supporting the arylic part as follows:

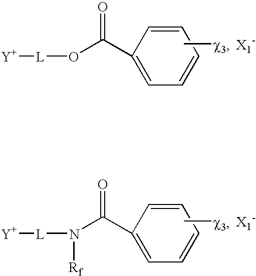

Y⁺—, X₁⁻, L, R_{f} and λ₃ being as defined above,
by supporting the acrylic and arylic parts as follows: 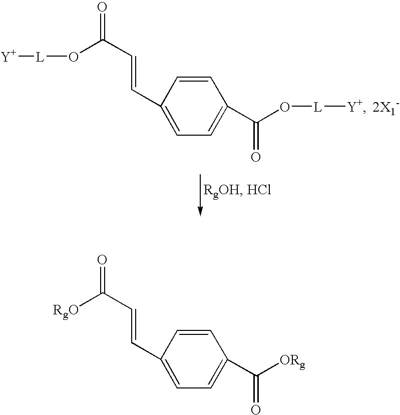
   2 X₁⁻

Y⁺—, X₁⁻, L and R_{g} being as defined above.

The present invention also relates to the use as defined above for the implementation of Suzuki coupling, according to one of the following reaction diagrams:

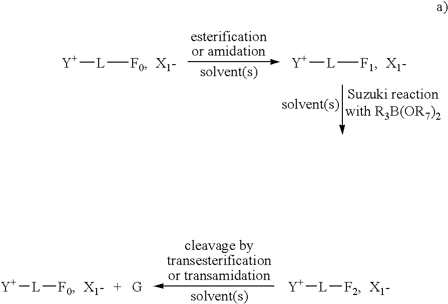

R₃ being chosen from the aryl, heteroaryl, ethenyl, dienyl, allyl, ethynyl groups, substituted or non-substituted, comprising from 2 to 30 carbon atoms,

R₇ representing a hydrogen atom or a branched or linear alkyl group, or a cycloalkyl group comprising from 1 to 12 carbon atoms,

Y⁺— representing an onium cation as defined above, and preferably being a trimethylalkylammonium, triethylalkylammonium, tributylalkylphosphonium, N-methylimidazolium or pyridinium cation,

L representing an arm, in particular a linear or branched alkyl group comprising from 1 to 20 carbon atoms, or an optionally functional aralkyl group comprising from 6 to 30 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

the functions F₀, F₁, and F₂ being as defined below:
F₀ is in the form −λ₁H, λ₁ representing an oxygen atom or an —NR_{f} group, R_{f} corresponding to a linear or branched alkyl group, comprising from 1 to 20 carbon atoms, or an aryl group comprising from 6 to 30 carbon atoms,
F₁ is in the form —Rₑ−λ, Rₑ representing an aromatic or heteroaromatic group comprising from 6 to 30 carbon atoms, λ representing a leaving group preferably chosen from Cl, Br, I, OTf, O—CO₂R⁵ or OSO₃—R⁵, R⁵ representing an alkyl group comprising from 1 to 10 carbon atoms or an aralkyl group comprising from 6 to 30 carbon atoms, F₁ preferably corresponding to the following formula: 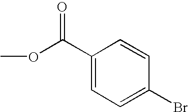
F₂ is in the form —Rₑ—R₂, Rₑ being as defined above and R₂ being chosen from the aryl, heteroaryl, ethenyl, dienyl, allyl, ethynyl groups, substituted or non-substituted, comprising from 2 to 30 carbon atoms, F₂ preferably corresponding to the following formula:

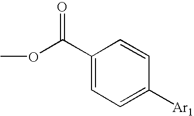

Ar₁ representing an aromatic group preferably chosen from:

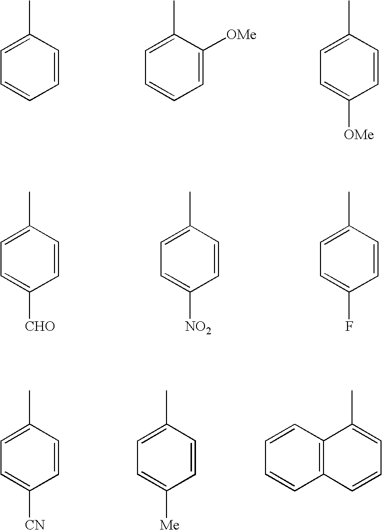

the molecule G being in the form R₂—R₃, R₂ and R₃ being as defined above, and corresponding in particular to the following formula:

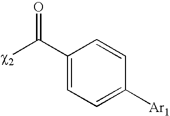

in which λ₂ represents either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms,

Ar₁ is as defined above.

When F₀ represents an —OH group, the function F₁ is obtained by esterification in particular with the carboxylic acid of formula

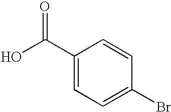

When F₀ represents an —NR_{f}H group, the function F₁ is obtained by amidation in particular with the carboxylic acid of formula

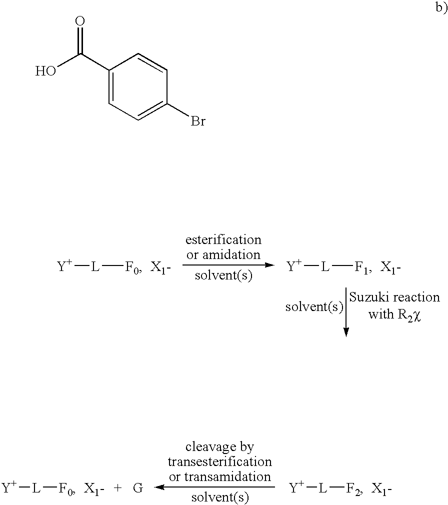

Y⁺— representing an onium cation as defined above, and preferably being a trimethylalkylammonium, triethylalkylammonium, tributylalkylphosphonium, N-methylimidazolium or pyridinium cation,

L representing an arm, in particular a linear or branched alkyl group comprising from 1 to 20 carbon atoms, or an optionally functional aralkyl group comprising from 6 to 30 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

R₂ being chosen from the aryl, heteroaryl, ethenyl, dienyl, allyl, ethynyl groups, substituted or non-substituted, comprising from 2 to 30 carbon atoms,

the functions F₀, F₁, and F₂ being as defined below:
F₀ is in the form −λ₁H, λ₁ being as defined above,
F₁ is in the form —R_{q}—B(OR₇)₂, R₇ being as defined above, and R_{q} corresponding to an aryl group comprising from 6 to 30 carbon atoms, heteroaryl comprising from 4 to 20 carbon atoms, ethenyl comprising from 2 to 20 carbon atoms, dienyl comprising from 3 to 20 carbon atoms, allyl comprising from 3 to 20 carbon atoms, ethynyl comprising from 2 to 20 carbon atoms, substituted or non-substituted, F₁ preferably corresponding to the following formula:

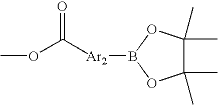

Ar₂ corresponding to an aryl group, substituted or non-substituted, comprising from 6 to 30 carbon atoms,
F₂ is in the form —R_{q}—Rₑ, R_{q} and Rₑ being as defined above, F₂ preferably corresponding to the following formula:

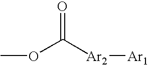

Ar₁ representing an aromatic group preferably chosen from:

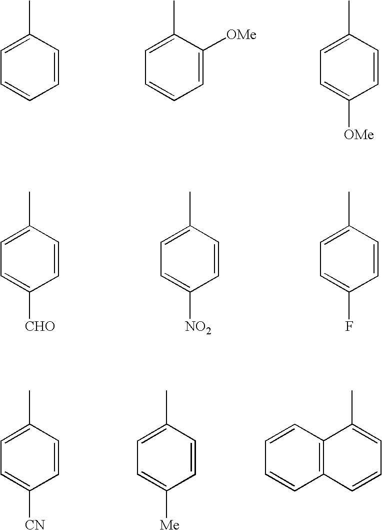

the molecule G being in the form R₂—R₃, R₂ and R₃ being as defined above, and corresponding in particular to the following formula:

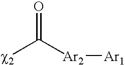

in which λ₂, Ar₁ and Ar₂ are as defined above,

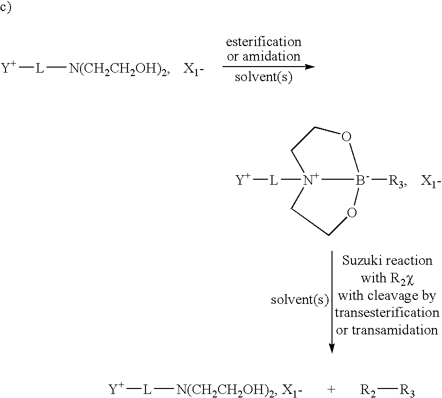

Y⁺—, L, X₁⁻, R₂ and R₃ being as defined above,

R₃ preferably being a phenyl group,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents.

Embodiment a) corresponds to the case where the aryl halide is supported and where the boronic acid is free.

Embodiment b) corresponds to the case where the boronic acid is supported and where the aryl halide is free.

Embodiments a), b) and c) make it possible to easily purify the coupling products in the form of salts. In particular, it is easy to eliminate the homocoupling products which are not salts by simple washing before transesterification.

The advantages of these different embodiments are the following:
reactions on soluble support lend themselves to the techniques of combinatorial chemistry and parallel synthesis;
these supports are easy to purify as they are salts which are insoluble in a certain number of solvents; they can therefore be washed and/or recrystallized; in particular, in the case of the Suzuki reaction, the homocoupling product can be easily eliminated by simple washing of the salt before transesterification.

The present invention also relates to the use as defined above, for the implementation of Sonogashira coupling, according to one of the following reaction diagrams:

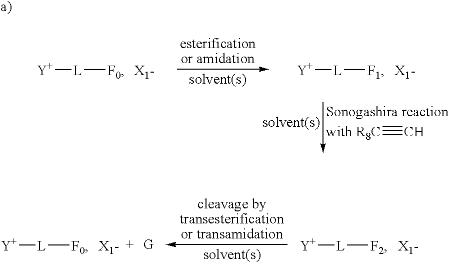

Y⁺— representing an onium cation as defined above, and preferably being a trimethylalkylammonium, triethylalkylammonium, tributylalkylphosphonium, N-methylimidazolium or pyridinium cation,

L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃₋, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

R₈ representing an ORₕ, NRₕRᵤ, CORₕ, CN, SO₂Rₕ, SRₕ group, an alkenyl, ethynyl, dienyl group, Rₕ and Rᵤ representing, independently of one another, a hydrogen atom, an alkyl group comprising from 1 to 20 carbon atoms or an aryl group comprising from 6 to 30 carbon atoms,

or R₈ representing an alkyl group, branched or linear, optionally functional, comprising from 1 to 20 carbon atoms, or an aryl group, or an alkaryl or aralkyl group, comprising from 6 to 30 carbon atoms, substituted or non-substituted, said alkyl or aryl groups being able to be substituted by one of the following functional groups: a halogen atom, in particular Cl, an ORₕ, NRₕRₕ, CORₕ, CN, SO₂Rₕ, SRₕ group, an alkenyl, ethynyl, dienyl, vinyl, alkynyl group, Rₕ and Rᵤ being as defined previously,

R₈ being in particular one of the following groups:
—(CH₂)ₛ—CH₃, —(CH₂)ₛ—CH₂OH, —(CH₂), —CH₂OMe,

s representing an integer comprised between 0 and 10, 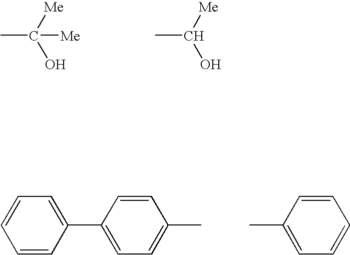
Me₃Si—

the functions F₀, F₁, and F₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 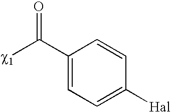
λ₁ being as defined above, and Hal representing a halogen, and preferably being iodine,
F₂ corresponds to the following formula: 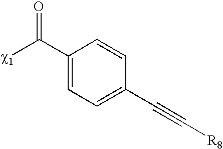
λ₁ and R₈ being as defined above,

G corresponding to the following formula:

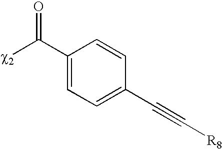

in which λ₂ represents either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms, λ₂ representing in particular an OMe, OEt, OPr or OBu group.

The conversion of the function F₀ to F₁ is carried out by an esterification or amidation reaction with the carboxylic acid of formula:

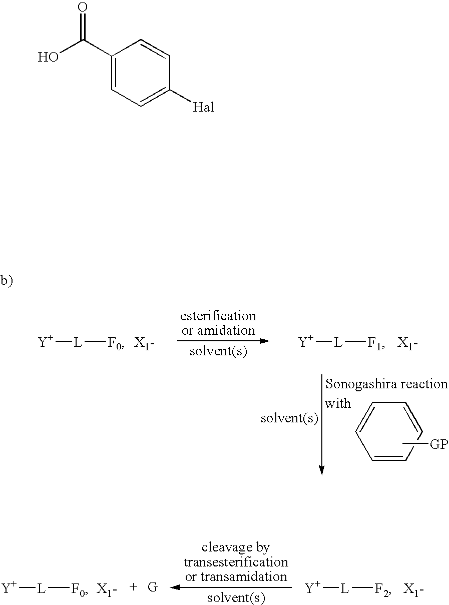

Y⁺— representing an onium cation as defined above, and preferably being a trimethylalkylammonium, triethylalkylammonium, tributylalkylphosphonium, N-methylimidazolium, alkylpyridinium, dimethylalkylsulphonium or diethylalkylsulphonium cation,

L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

GP representing a leaving group, and being in particular Cl, Br, I or OTf,

the functions F₀, F₁, and F₂ being as defined below:
F₀ corresponds to a —COOH group.
F₁ corresponds to the following formula:

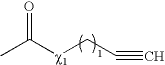

in which l represents an integer varying from 1 to 20, and λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₂ corresponds to the following formula: 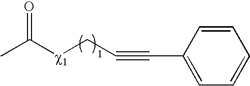
λ₁ and l being as defined above,

G corresponding to the following formula:

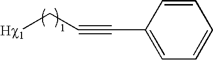

in which λ₁ and l are as defined above.

Embodiment a) corresponds to the case where the aromatic is supported and where the acetylenic is free.

Embodiment b) corresponds to the case where the acetylenic is supported and where the aromatic is free.

The present invention also relates to the use as defined above, for the implementation of the Baylis-Hilman reaction, according to one of the following reaction diagrams:

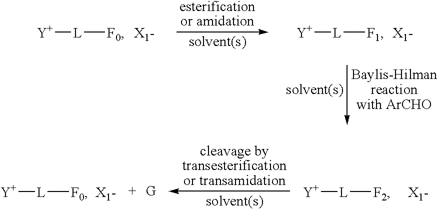

Y⁺— representing an onium cation as defined above, and preferably being a trim ethylalkylammonium, triethylalkylammonium, tributylalkylphosphonium, N-methylimidazolium or pyridinium cation,

L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

the functions F₀, F₁, and F₂ being as defined below:
F₀ represents an —OH group,
F₁ corresponds to the following formula: 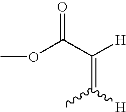
F₂ corresponds to the following formula:

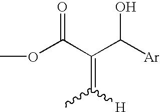

G corresponding to the following formula: 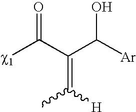
λ₁ representing an —OH group, or an —OR_{g} group, R_{g} representing a linear or branched alkyl group, comprising from 1 to 20 carbon atoms,

Ar representing an aromatic or heteroaromatic group, substituted or non-substituted,

ArCHO being in particular chosen from:

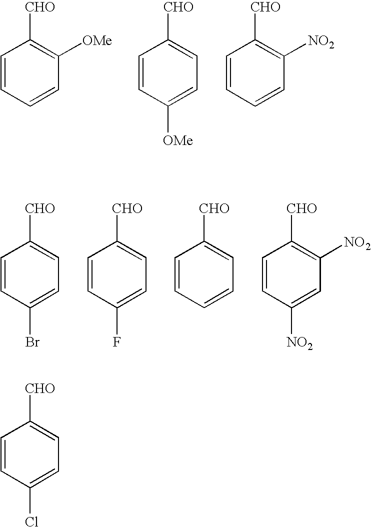

The conversion of the function F₀ to F₁ is carried out by an esterification or amidation reaction with the carboxylic acid of formula:

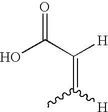

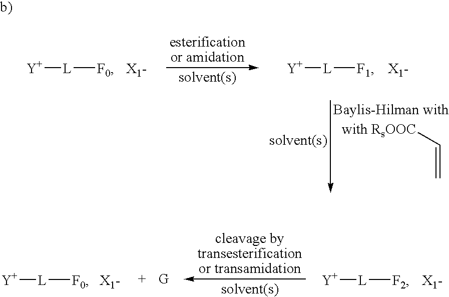

Y⁺— representing an onium cation as defined above, and preferably being a trimethylalkylammonium, triethylalkylammonium, tributylalkylphosphonium, N-methylimidazolium, alkylpyridinium, dimethylalkylsulphonium or diethylalkylsulphonium cation,

L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents.

Rₛ representing a hydrogen atom or an alkyl group comprising from 1 to 20 carbon atoms or aralkyl or alkaryl comprising from 7 to 30 carbon atoms,

the functions F₀, F₁, and F₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 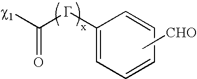
λ₁ being as defined above,
x being equal to 0 or 1,
Γ representing an alkyl chain comprising O— from 1 to 20 carbon atoms, alkaryl, aralkyl comprising from 6 to 30 carbon atoms,
F₂ corresponds to the following formula: 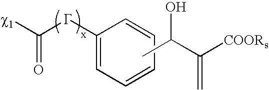
λ₁, x, Rₛ and Γ being as defined above
G corresponding to the following formula: 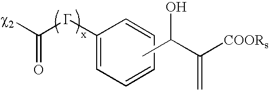
λ₂, x, Rₛ and Γ being as defined above

in which λ₂ represents either an —OR_{g} group, R_{g} representing a hydrogen atom or an alkyl group comprising from 1 to 20 carbon atoms, or an —NRₕRᵤ, group, Rₕ and Rᵤ representing independently of one another a hydrogen atom, an alkyl group comprising from 1 to 20 carbon atoms or an aryl group comprising from 6 to 30 carbon atoms, λ₂ representing in particular an OMe, OEt, OPr or OBu group.

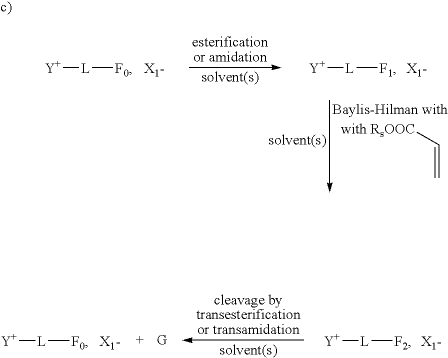

Y⁺— representing an onium cation as defined above, and preferably being a trimethylalkylammonium, triethylalkylammonium, tributylalkylphosphonium, N-methylimidazolium or pyridinium cation,

L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

Rₛ representing a hydrogen atom or an alkyl group comprising from 1 to 20 carbon atoms or aralkyl or alkaryl comprising from 7 to 30 carbon atoms,

the functions F₀, F₁, and F₂ being as defined below:
F₀ corresponds to a —COλ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 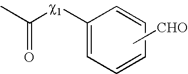
F₂ corresponds to the following formula: 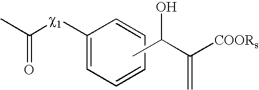
G corresponding to the following formula:

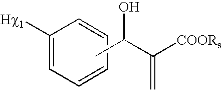

The present invention also relates to the use as defined above, for the synthesis, optionally asymmetrical, of α-amino acids, according to the following reaction diagram:

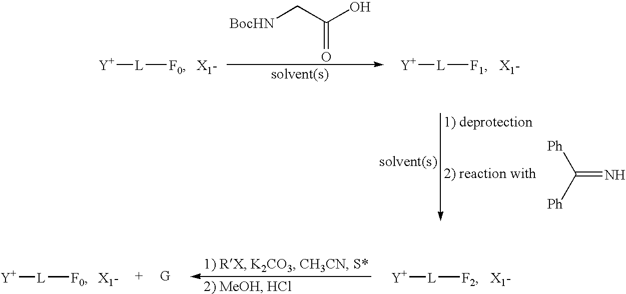

Y⁺— representing an onium cation as defined above, and preferably being a trimethylalkylammonium, triethylalkylammonium or tributylalkylphosphonium cation,

L representing an arm, in particular a linear or branched alkyl group comprising from 1 to 20 carbon atoms, or an optionally functional aralkyl group comprising from 1 to 20 carbon atoms, and preferably being a linear alkyl group, preferably a linear alkyl group of type (CH₂)ᵣ, r varying from 1 to 20, and preferably from 3 to 6,

X₁⁻ being as defined above, and being in particular Cl⁻, Br⁻, I⁻, N(SO₂CF₃)₂, BF₄⁻, PF₆⁻,

the solvent or solvents being chosen from: acetonitrile, dichloromethane, tetrahydrofuran, dioxane, toluene, chlorobenzene or a mixture of these solvents,

R′ representing a linear or branched alkyl group, comprising from 1 to 30 carbon atoms, optionally functional,

S* representing a chiral phase transfer agent such as O(9)-allyl-N-9-anthracenyl-methylcinchonidinium bromide (see Corey et al., 1998),

the functions F₀, F₁ and F₂ being as defined below:
F₀ corresponds to —OH,
F, corresponds to the following formula: 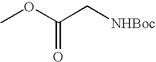
F₂ corresponds to the following formula:

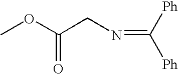

G corresponding to the following formula:

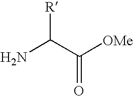

The present invention also relates to the use as defined above, for the implementation of multi-component reactions.

Multi-component reactions (MCRs) simultaneously bring together at least three partners under experimental conditions which do not vary over time and allow the creation of several covalent bonds in cascade in a single reactor, unlike standard reactions where two reagents lead to a product by the creation of a new bond. Thus it is possible in a single stage to access a highly functionalized molecule from relatively simple entities. Moreover the MCRs combine convergence and economy of atoms, two essential principles in organic synthesis and also in combinatorial chemistry. Finally, these reactions generally take place with a high yield, since they avoid the succession of stages of linear or multi-stage syntheses which, at each step, cause a drop in yield.

The best-known and most highly developed MCRs are those of Passerini and Ugi (Ugi et al., 1999; Ugi et al., 2001; Domling et al., 2000; Ugi, 2001; Bienayme et al., 2000; Vanden Eynde et al., 2000; Domling, 2002).

The present invention also relates to the use as defined above, for the implementation of UGI-type multi-component reactions, in particular for the Grieco-type reaction according to one of the following reaction diagrams:

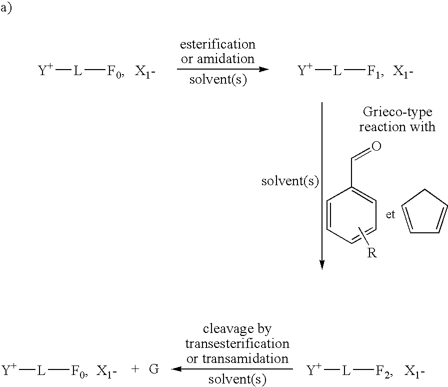

Y⁺— representing an onium cation as defined above, and preferably being a trimethylalkylammonium, triethylalkylammonium, tributylalkylphosphonium, N-methyl-N′-alkylimidazolium, N-alkylpyridinium, dimethylalkylsulphonium or diethylalkylsulphonium cation,

L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

R representing a hydrogen atom, a nitro group, preferably in para position, a chlorine atom, preferably in para position or a methoxy group, preferably in para position,

the functions F₀, F₁ and F₂ being as defined below:
F₀ represents an —OH group,
F₁ corresponds to the following formula: 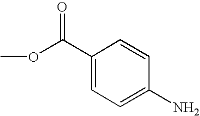
F₂ corresponds to the following formula:

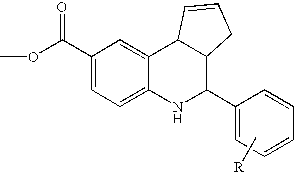

G corresponding to the following formula: 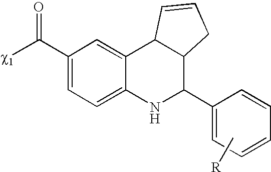
λ₁ representing an —OH group, or an —OR_{g} group, R_{g} representing a linear or branched alkyl group, comprising from 1 to 20 carbon atoms,

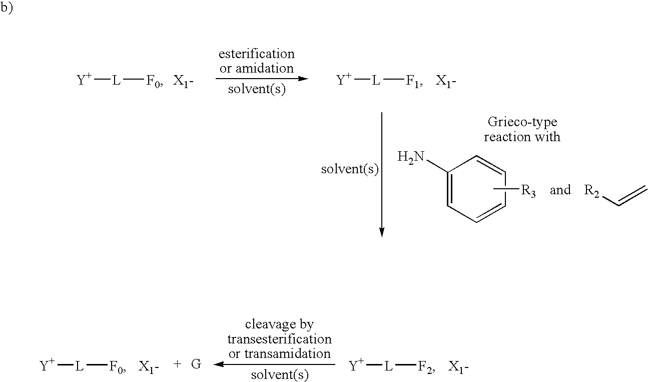

Y⁺— representing an onium cation as defined above, and preferably being a trimethylalkylammonium, triethylalkylammonium, tributylalkylphosphonium, N-methyl-N′-alkylimidazolium, N-alkylpyridinium, dimethylalkylsulphonium or diethylalkylsulphonium cation,

L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

R₂ representing a functional or non-functional alkyl group, comprising from 1 to 20 carbon atoms, or a functional or non-functional aryl group, comprising from 6 to 30 carbon atoms, or an aralkyl or alkaryl group, functional or non-functional, comprising from 7 to 50 carbon atoms,

R₃ representing a hydrogen atom, a linear or branched alkyl group, comprising from 1 to 20 carbon atoms or an aryl group comprising from 6 to 30 carbon atoms, or an aralkyl or alkaryl group, functional or non-functional, comprising from 7 to 50 carbon atoms, or a functional group in particular chosen from NO₂, CN, COOR, OR, COR, NHCOR, NRR′, SO₂R, I, Br, R and R′ representing independently of one another an alkyl group comprising from 1 to 20 carbon atoms or an aryl group comprising from 6 to 30 carbon atoms,

the functions F₀, F₁, and F₂ being as defined below:
F₀ represents an —OH group,
F₁ corresponds to the following formula: 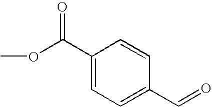
F₂ corresponds to the following formula:

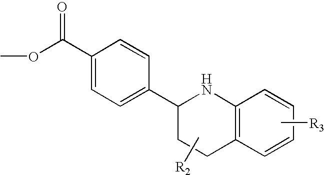

G corresponding to the following formula: 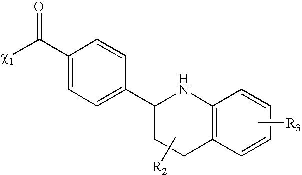
λ₁ representing an —OH group, or an —OR_{g} group, R_{g} representing a linear or branched alkyl group, comprising from 1 to 20 carbon atoms.

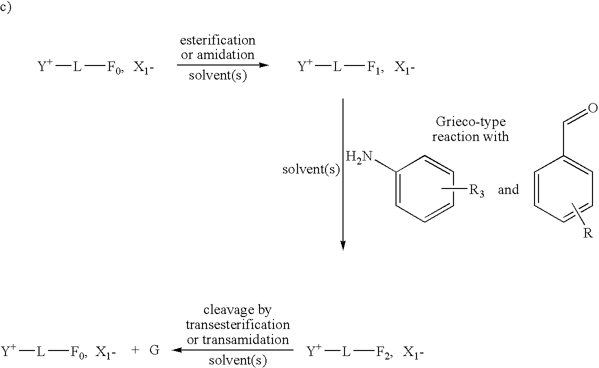

Y⁺— representing an onium cation as defined above, and preferably being a trimethylalkylammonium, triethylalkylammonium, tributylalkylphosphonium, N-methyl-N′-alkylimidazolium, N-alkylpyridinium, dimethylalkylsulphonium or diethylalkylsulphonium cation,

L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

R representing a hydrogen atom or a functional group such as a nitro group in para position, a chlorine atom in para position or a methoxy group in ortho position, or a functional or non-functional alkyl group, comprising from 1 to 20 carbon atoms, or a functional or non-functional aryl group, comprising from 6 to 30 carbon atoms, or an aralkyl or alkaryl group, functional or non-functional, comprising from 7 to 50 carbon atoms,

R₃ representing a hydrogen atom, a linear or branched alkyl group, comprising from 1 to 20 carbon atoms or an aryl group comprising from 6 to 30 carbon atoms, or an aralkyl or alkaryl group, functional or non-functional, comprising from 7 to 50 carbon atoms, or a functional group in particular chosen from NO₂, CN, COOR, OR, COR, NHCOR, NRR′, SO₂R, I, Br, R and R′ representing independently of one another an alkyl group comprising from 1 to 20 carbon atoms or an aryl group comprising from 6 to 30 carbon atoms,

the functions F₀, F₁ and F₂ being as defined below:
F₀ represents any function making it possible to attach and release a radical carrying an olefin, preferably an ester, or an amide.
F₁ corresponds to one of the following general formulae: 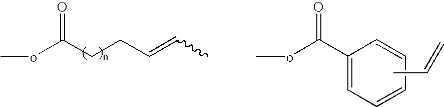
n representing an integer varying from 1 to 10
F₂ corresponds to one of the following general formulae:

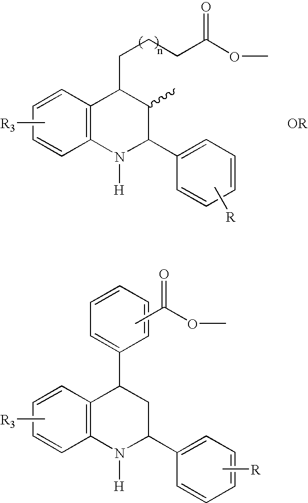

G corresponding to one of the following general formulae:

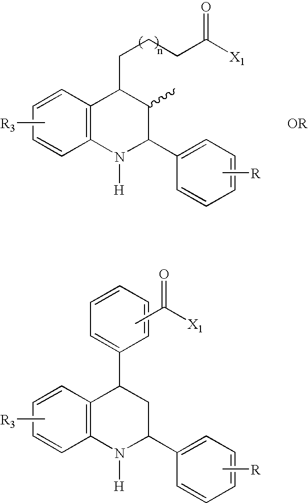

n, R and R₃ being as defined above, and

λ₁ representing an —OH group, or an —OR_{g} group, R_{g} representing a linear or branched alkyl group, comprising from 1 to 20 carbon atoms.

The conversion of the function F₀ to F₁, in the first case in point, is carried out by an esterification reaction with the carboxylic acid of formula:

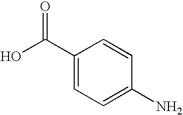

The present invention also relates to the use as defined above, for the implementation of multi-component reactions, in particular for the synthesis of tetrasubstituted olefins according to R. C. Larock et al. (2003), according to the following reaction diagram:

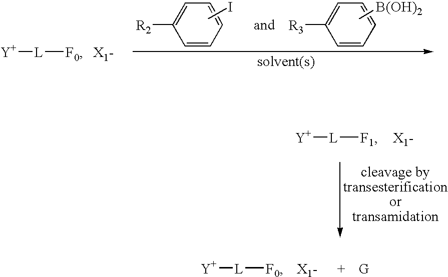

Y⁺— representing an onium cation as defined above, and preferably being a trimethylalkylammonium, triethylalkylammonium, tributylalkylphosphonium, N-methyl-N′-alkylimidazolium, N-alkylpyridinium, dimethylalkylsulphonium or diethylalkylsulphonium cation,

L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrolidinone, propionitrile, acetone, toluene, chlorobenzene, nitrobenzene, dichlorobenzene, nitromethane, nitroethane, or a mixture of these solvents,

R₂ and R₃, preferably in para position, representing a hydrogen atom, a linear or branched, optionally functional alkyl group comprising from 1 to 30 carbon atoms, an optionally substituted and/or functional aryl group, comprising from 6 to 30 carbon atoms, a functional group, preferably a methoxy, mono-alkylamino, dialkylamino, arylamino, cyano, ester, nitro, ketone, sulphonyl, alkylthio, sulphoxide group,

the functions F₀ and F₁ being as defined below:
F₀ corresponds to the following formula: 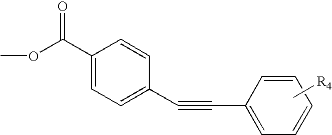
R₄ representing a group as defined for R₂ and R₃ above,
F₁ corresponds to one of the following formulae:

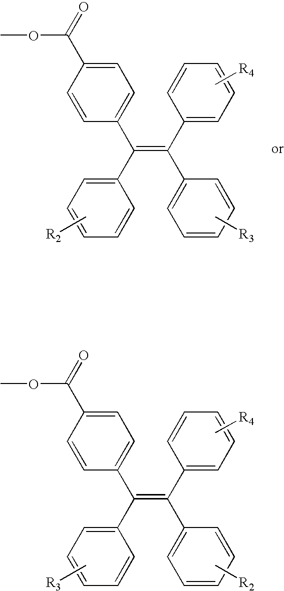

R₂, R₃ and R₄ being as defined above,

G corresponds to one of the following formulae:

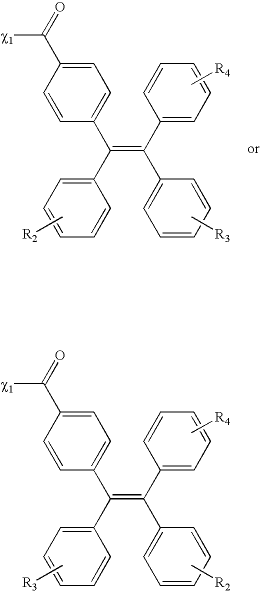

λ₁ representing an —OH group, or an —OR_{g} group, R_{g} representing a linear or branched alkyl group, comprising from 1 to 20 carbon atoms.

The conversion of F₀ to F₁ is carried out by a cis-addition of the aryl group originating from the aryl halide of the least hindered side to the end of the starting alkyne which is richest in electrons, whilst the acyl group originating from the arylboronic acid is added to the other end.

Within the scope of the present invention, it is also possible to use polyfunctional cations, which are defined as being cations carrying several functions, said functions being identical or different.

The present invention also relates to the use as defined above, for the implementation of cycloaddition reactions, preferably for the implementation of the Diels-Alder reaction, according to the following reaction diagram: 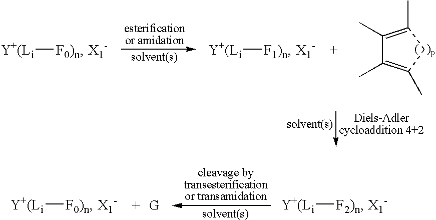
n being an integer varying from 2 to 4, as defined below,

i being an integer varying from 1 to n,

p being an integer varying from 0 to 2,

Y⁺ representing an onium cation as defined above, of formula (R_{b})ₓ₋ₙΛ⁺ in which x represents an integer equal to 3 or 4, n being equal to 2, 3 or 4 when x is equal to 4 and n being equal to 2 or 3 when x is equal to 3, R_{b} represents an alkyl group comprising from 1 to 20 carbon atoms, an aryl group comprising from 6 to 30 carbon atoms or an aralkyl or alkaryl group comprising from 6 to 30 carbon atoms, said abovementioned alkyl, aryl, aralkyl or alkaryl groups being non-functional, and in which Λ⁺ represents an ammonium, imidazolium, phosphonium or sulphonium cation, Y⁺ representing in particular an alkylammonium, alkylphosphonium or alkylsulphonium cation, and preferably being a tetraalkylammonium, tetraalkylphosphonium, dialkylimidazolium, trialkylsulphonium cation,

Lᵢ representing an arm, in particular a linear or branched alkyl group comprising from 1 to 20 carbon atoms, or an optionally functional aralkyl or alkaryl group, comprising from 6 to 30 carbon atoms, and preferably being a linear alkyl group, preferably a linear alkyl group of type (CH₂)ᵣ, r varying from 1 to 20, and preferably from 2 to 10, the arms Lᵢ being able to be identical or different,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

the functions F₀, F₁, and F₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 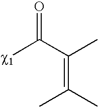
λ₁ being as defined above,
F₂ corresponds to the following formula: 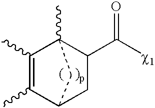
λ₁ being as defined above,

G corresponding to the following formula:

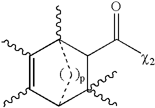

in which λ₂ represents either an OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms.

The notation Y⁺(Lᵢ−F₀)ₙ means that the entity Y⁺ is substituted by n Lᵢ−F₀ entities linked by a covalent bond.

The use of a plurifunctional salt within the framework of the Diels-Alder reaction makes it possible to increase the productivity of the solutions used. Moreover, the arm can be functionalized differently and allow either intramolecular reactions, or cascade reactions, or multicomponent reactions.

The present invention relates to the use as defined above, for the implementation of the Heck reaction, according to the following reaction diagram: 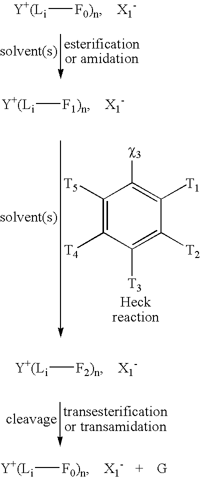
n being an integer varying from 2 to 4, as defined below,

i being an integer varying from 1 to n,

Y⁺ representing an onium cation as defined above, of formula (R_{b})ₓ₋ₙΛ⁺ in which x represents an integer equal to 3 or 4, n being equal to 2, 3 or 4 when x is equal to 4 and n being equal to 2 or 3 when x is equal to 3, R_{b} represents an alkyl group comprising from 1 to 20 carbon atoms, an aryl group comprising from 6 to 30 carbon atoms or an aralkyl or alkaryl group comprising from 6 to 30 carbon atoms, said abovementioned alkyl, aryl, aralkyl or alkaryl groups being non-functional, and in which Λ⁺ represents an ammonium, imidazolium, phosphonium or sulphonium cation, Y⁺ representing in particular an alkylammonium, alkylphosphonium or alkylsulphonium cation, and preferably being a tetraalkylammonium, tetraalkylphosphonium, dialkylimidazolium, trialkylsulphonium cation,

Lᵢ representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 2 to 10, the arm Lᵢ being able to be identical or different,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

the functions F₀, F₁, and F₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 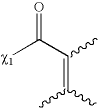
λ₁ being as defined above,
F₂ corresponds to the following formula: 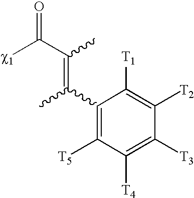
λ₁ being as defined above,

G corresponding to the following formula:

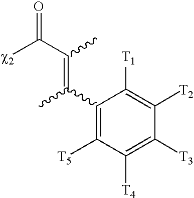

in which λ₂ represents either an —OR_{g} group, R_{g} representing a hydrogen atom or an alkyl group comprising from 1 to 20 carbon atoms, or an —NRₕR_{g} group, Rₕ and R_{g} representing independently of one another a hydrogen atom, an alkyl group comprising from 1 to 20 carbon atoms or an aryl group comprising from 6 to 30 carbon atoms,

λ₃ representing a leaving group, in particular chosen from the I, Cl and Br halides, the mesylate, tosylate, triflate, sulphonate, sulphate or phosphate groups,

T₁, T₂, T₃, T₄ and T₅ representing independently of one another a hydrogen atom, a linear or branched alkyl group, comprising from 1 to 20 carbon atoms or arm aryl group comprising from 6 to 30 carbon atoms, or a functional group in particular chosen from NO₂, CN, COOR, OR, COR, NHCOR, NRR″, SO₂R, I, Br, R and R″ representing independently of one another an alkyl group comprising from 1 to 20 carbon atoms or an aryl group comprising from 6 to 30 carbon atoms,

the entity 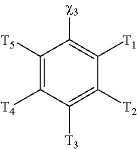
representing in particular the following groups:

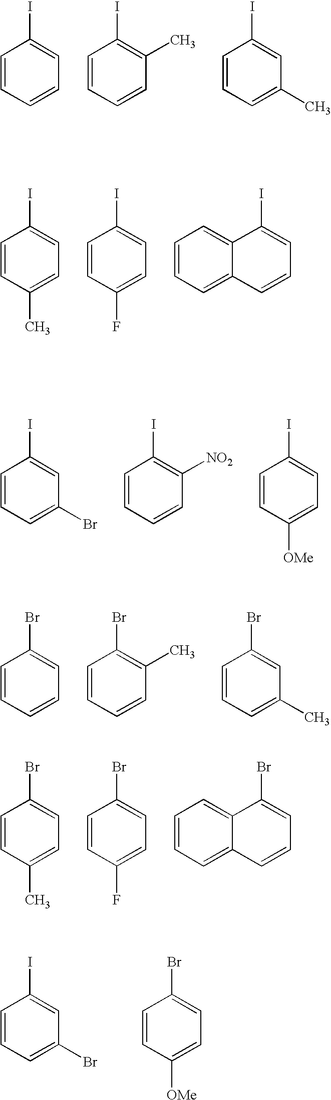

The use of a plurifunctional salt within the framework of the Heck reaction makes it possible to increase the productivity of the solutions used. Moreover, the arm can be functionalized differently and allow either intramolecular reactions, or cascade reactions or multicomponent reactions.

The present invention also relates to the use as defined above, for the implementation of Suzuki coupling according to the following reaction diagram:

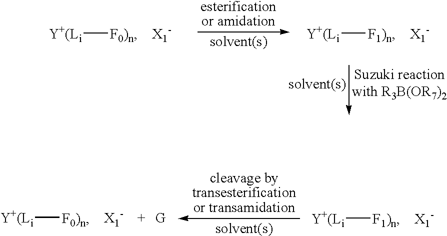

R₃ being chosen from the substituted or non-substituted aryl, heteroaryl, ethenyl, dienyl, allyl, ethynyl groups, comprising from 2 to 30 carbon atoms,

R₇ representing a hydrogen atom or a branched or linear alkyl group, or a cycloalkyl group comprising from 1 to 12 carbon atoms,

n being an integer varying from 2 to 4, as defined below,

i being an integer varying from 1 to n,

Y⁺ representing an onium cation as defined above, of formula (R_{b})ₓ₋ₙΛ⁺ in which x represents an integer equal to 3 or 4, n being equal to 2, 3 or 4 when x is equal to 4 and n being equal to 2 or 3 when x is equal to 3, R_{b} represents an alkyl group comprising from 1 to 20 carbon atoms, an aryl group comprising from 6 to 30 carbon atoms or an aralkyl or alkaryl group comprising from 6 to 30 carbon atoms, said abovementioned alkyl, aryl, aralkyl or alkaryl groups being non-functional, and in which Λ⁺ represents an ammonium, imidazolium, phosphonium or sulphonium cation. Y⁺ representing in particular an alkylammonium, alkylphosphonium or alkylsulphonium cation, and preferably being a tetraalkylammonium, tetraalkylphosphonium, dialkylimidazolium, trialkylsulphonium cation,

Lᵢ representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 2 to 10, the arms Lᵢ being able to be identical or different,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, —N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

the functions F₀, F₁, and F₂ being as defined below:
F₀ is in the form −λ₁H, λ₁ representing an oxygen atom or an —NR_{f} group, R_{f} corresponding to a linear or branched alkyl group, comprising from 1 to 20 carbon atoms, or an aryl group comprising from 6 to 30 carbon atoms,

F₁ is in the form —Rₑ−λ, Rₑ representing an aromatic or heteroaromatic group comprising from 6 to 30 carbon atoms, λ representing a leaving group preferably chosen from Cl, Br, I, OTf, O—CO₂R⁵ or OSO₃—R⁵, R⁵ representing an alkyl group comprising from 1 to 10 carbon atoms or an aralkyl group comprising from 6 to 30 carbon atoms, F₁ preferably corresponding to the following formula: 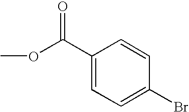
F₂ is in the form —Rₑ—R₂, Rₑ being as defined above and R₂ being chosen from the aryl, heteroaryl, ethenyl, dienyl, allyl, ethynyl groups, substituted or non-substituted, comprising from 2 to 30 carbon atoms, F₂ preferably corresponding to the following formula:

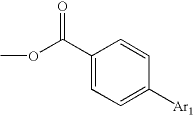

Ar₁ representing an aromatic group preferably chosen from:

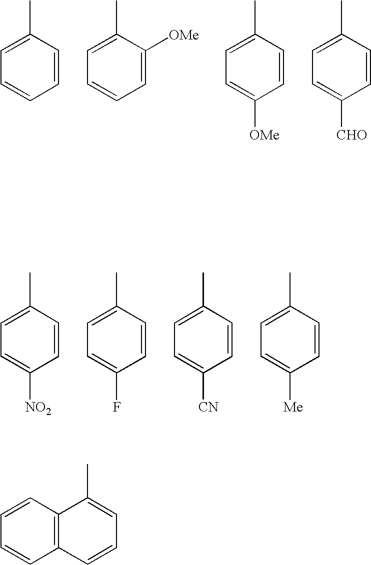

the molecule G being in the form R₂—R₃, R₂ and R₃ being as defined above, and corresponding in particular to the following formula:

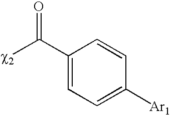

in which λ₂ represents either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms,

Ar₁ is as defined above.

The present invention also relates to the use as defined above, for the implementation of Suzuki coupling, according to the following reaction diagram:

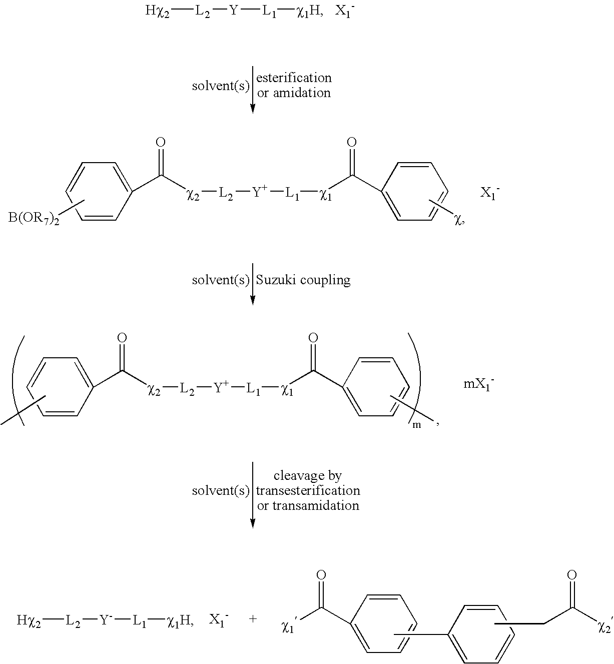

m representing an integer comprised between 1 and 50,

Y⁺ representing an onium cation as defined above, of formula (R_{b})ₓ₋₂Λ⁺ in which x represents an integer equal to 3 or 4 according to the nature of Λ⁺, namely an ammonium, phosphonium or sulphonium cation respectively, R_{b} represents an alkyl group comprising from 1 to 20 carbon atoms, an aryl group comprising from 6 to 30 carbon atoms or an aralkyl or alkaryl group comprising from 6 to 30 carbon atoms, said abovementioned alkyl, aryl, aralkyl or alkaryl groups being non-functional, and in which Λ⁺ represents an ammonium, imidazolium, phosphonium or sulphonium cation, Y⁺ representing in particular an alkylammonium, alkylphosphonium or alkylsulphonium cation, and preferably being a tetraalkylammonium, tetraalkylphosphonium, dialkylimidazolium, trialkylsulphonium cation,

L₁ and L₂ representing an arm, identical or different, in particular a linear or branched alkyl group comprising from 1 to 20 carbon atoms, or an optionally functional aralkyl group comprising from 6 to 30 carbon atoms, and preferably being a linear alkyl group, preferably a linear alkyl group of type (CH₂)ᵣ, r varying from 1 to 20, and preferably from 1 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

λ₁ and λ₂, identical or different, representing an oxygen atom or an —NR_{f} group, R_{f} corresponding to a linear or branched alkyl group, comprising from 1 to 20 carbon atoms, or an aryl group comprising from 6 to 30 carbon atoms,

λ representing a leaving group preferably chosen from Cl, Br, I, OTf, O—CO₂R⁵ or OSO₃—R⁵, R⁵ representing an alkyl group comprising from 1 to 10 carbon atoms or an aralkyl group comprising from 6 to 30 carbon atoms,

R₇ representing a hydrogen atom, a branched or non-branched alkyl, or cycloalkyl group, comprising from 1 to 12 carbon atoms, or an aryl group, comprising from 6 to 30 carbon atoms,

λ′₁ and λ′₂, identical or different, representing either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms.

The use of a plurifunctional salt within the framework of the Suzuki reaction makes it possible to increase the productivity of the solutions used. Moreover, the arms can be functionalized differently and allow either intramolecular reactions, or cascade reactions, or multicomponent reactions.

The present invention relates to the use as defined above, for the implementation of the Heck reaction, according to the following reaction diagram:

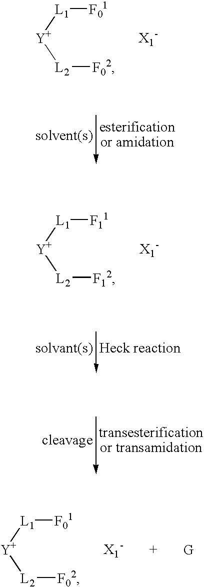

Y⁺ representing an onium cation as defined above, of formula (R_{b})ₓ₋₂Λ⁺ in which x represents an integer equal to 3 or 4, R_{b} represents an alkyl group comprising from 1 to 20 carbon atoms, an aryl group comprising from 6 to 30 carbon atoms or an aralkyl or alkaryl group comprising from 6 to 30 carbon atoms, said abovementioned alkyl, aryl, aralkyl or alkaryl groups being non-functional, and in which Λ⁺ represents an ammonium, imidazolium, phosphonium or sulphonium cation, Y⁺ representing in particular an alkylammonium, alkylphosphonium or alkylsulphonium cation, and preferably being a tetraalkylammonium, tetraalkylphosphonium, dialkylimidazolium, trialkylsulphonium cation, Λ⁺ representing an ammonium or phosphonium cation when x=4 and a sulphonium cation when x=3.

L₁ and L₂, identical or different, representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 2 to 10,

X₁⁻ being as defined above, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,

the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,

the functions F₀¹, F₁¹, F₀² and F₁² being as defined below:
F₀¹ corresponds to a −λ¹₁H group, in which λ¹₁ represents an oxygen atom or an —NR_{f} group, R_{f} corresponding to a linear or branched alkyl group, comprising from 1 to 20 carbon atoms, or an aryl group comprising from 6 to 30 carbon atoms,

F₀² corresponds to a −λ²₁H group, in which λ²₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁¹ corresponds to the following formula: 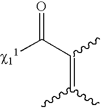
λ¹₁ being as defined above,
F₁² corresponds to the following formula: 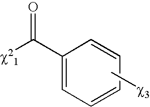
λ²₁ representing an oxygen atom or an —NR_{f} group, R_{f} corresponding to a linear or branched alkyl group, comprising from 1 to 20 carbon atoms, or an aryl group comprising from 6 to 30 carbon atoms, and
λ₃ representing a leaving group, in particular chosen from the I, Cl and Br halides, the mesylate, tosylate, triflate, sulphonate, sulphate or phosphate groups,

G corresponding to the following formula:

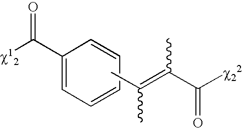

in which λ₂¹ and λ₂², identical or different, represent either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms.

The use of a plurifunctional salt within the framework of the Heck reaction makes it possible to increase the productivity of the solutions used. Moreover, the arm can be functionalized differently and allow either intramolecular reactions, or cascade reactions, or multicomponent reactions.

### DESCRIPTION OF THE FIGURES

FIG. 1 represents proton NMR spectra recorded at 200 MHz in acetone D6, corresponding to the monitoring of the Heck coupling reaction between salt 5 (Y═(Me)₃N, n=0) and iodobenzene. The spectrum at the bottom corresponds to the starting product 5d in acetone D6 and the spectrum at the top to the incoming crude product 24d in the acetone D6.

FIG. 2 represents a chromatogram corresponding to the mixture of the three methyl esters 27a to 27c the mass spectra of which are described in Table 7.

FIG. 3 represents a chromatogram corresponding to the mixture of the seven biaryl methyl esters 29a to 29g the mass spectra of which are described in Table 8.

FIG. 4 represents a chromatogram corresponding to the mixture of the nine biaryl methyl esters 31a to 31i the mass spectra of which are described in Table 10.

FIG. 5 represents a chromatogram corresponding to the mixture of the nine biaryl ethyl esters 32a to 32i the mass spectra of which are described in Table 11.

FIG. 6 represents a chromatogram corresponding to the mixture of the nine biaryl propyl esters 33a to 33i the mass spectra of which are described in Table 12.

FIG. 7 represents of the proton NMR spectra recorded at 200 MHz in acetone D6, corresponding to the monitoring of the Sonogashira reaction starting with salt 6b. The spectrum at the bottom corresponds to the coupling product of 6b with heptynol in acetone D6 and the spectrum at the top to the starting product 6b in acetone D6.

FIG. 8 represents a chromatogram corresponding to the mixture of the five acetylenic methyl esters 35a to 35e the mass spectra of which are described in Table 17.

FIG. 9 represents a chromatogram corresponding to the mixture of the five acetylenic ethyl esters 36a to 36e the mass spectra of which are described in Table 18.

FIG. 10 represents a chromatogram corresponding to the mixture of the five acetylenic propyl esters 37a to 37e the mass spectra of which are described in Table 19.

FIG. 11 represents a chromatogram corresponding to the mixture of the five acetylenic butyl esters 38a to 38e the mass spectra of which are described in Table 20.

FIG. 12 represents a chromatogram corresponding to the mixture of the six alcohols 40a to 40f the mass spectra of which are described in Table 22.

FIG. 13 represents proton NMR spectra recorded at 200 MHz in acetone D6, corresponding to the monitoring of the Grieco reaction carried out on an onium salt. The spectrum at the top corresponds to the starting product 7g and the spectrum at the bottom corresponds to the incoming product 42.

FIG. 14 represents the HPLC chromatogram of the products 47a to 47e (Sonogashira coupling products).

FIG. 15 represents the GC/MS chromatogram of the mixture of tetrasubstituted olefins 49a to 49e (Table 26).

FIG. 16 represents a chromatogram of the Suzuki coupling product 14a (X═Cl) with phenylboronic acid after transesterification by methanol.

FIG. 17 represents proton NMR spectra recorded at 200 MHz in acetone D6, corresponding to the monitoring of the cycloaddition reaction between acryloyl bis-ester 13 and cyclopentadiene. The spectrum at the top corresponds to the starting product 13 and the spectrum at the bottom corresponds to the cycloaddition product obtained after reaction with cyclopentadiene.

### EXPERIMENTAL PART—PREPARATION OF THE COMPOUNDS

I) Synthesis of the Functionalized Salts:

1/Ammonium salt 1:

| 1 | 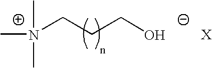 |
|---|---|
| 1a | n = 0; X = NTf₂ |
| 1b | n = 1; X = Cl |
| 1c | n = 1; X = PF₆ |
| 1d | n = 1; X = BF₄ |
| 1e | n = 1; X = NTf₂ |
| 1f | n = 1; X = Cl |
| 1g | n = 2; X = NTf₂ |
| 1h | n = 2; X = OTf |
| 1i | n = 3; X = Cl |
| 1j | n = 3; X = NTf₂ |

1a:

A solution of 2 g (0.01 mmol) of trimethyl-2-hydroxyethylammonium in 1 ml of water is added to a solution of 1 g (0.018 mmol) of lithium his-trifluoromethanesulphonamidide. The mixture is stirred for 2 hours. The two phases obtained are separated, and the aqueous phase is extracted twice with 15 ml of methylene chloride. The solvent is then evaporated off and the product is dried under vacuum.

Colourless viscous oil Yield=90%

¹H NMR (200 MHz, Acetone D₆): 3.35 (s, 9H); 4.14-4.40 (m, 2H); 4.05-4.63(m, 2H).

¹³C NMR (50 MHz, Acetone D₆): 55.02 (t; J_{C-N}=4.03 Hz); 57.23; 68.91; 121.05 (q, J=321.2 Hz).

1b:

25 g (0.1 mol) of 3-chloropropanol, 30 ml of a ⁴⁵% solution of trimethylamine in water (0.2 mol) and 100 ml of acetonitrile are taken to reflux for 36 hours. The solvent is then evaporated off under vacuum and the white solid obtained is washed twice with 30 ml of ether.

White solid Yield=82% Mp=158-160° C.

¹H NMR (200 MHz, D₂O): 1.80-2.05 (m, 2H); 3.00 (s, 9H); 3.20-3.41 (m, 2H); 3.60(t, 2H, J=7.1 Hz)

¹³C NMR (50 MHz, D2O): 25.68; 53.31 (t, J_{C-N}=4.1 Hz); 58.52; 64.52.

Mass Spectrometry (FAB) for C₁₂H₃₂N₂O₂Cl

Theoretical mass calculated for (2C⁺, Cl⁻)⁺ 271.2152

Mass found 271.2149

1c:

A mixture of a solution of 10 g (65.3 mol) of N,N′,N″-trimethyl-3-hydroxypropylammonium chloride (1b) in 15 ml of water and 13.23 ml (0.15 mol) of hexafluorophosphoric acid in solution at 60% in water is stirred at ambient temperature for 2 hours. The medium immediately becomes heterogeneous and the precipitate formed is filtered and washed with ether. The white solid obtained is dried under vacuum.

White solid Yield=67% Mp=124-126° C.

¹H NMR (200 MHz, CD₃CN): 1.70 (m, 2H); 2.82 (s, 9H); 3.15 (m, 2H); 3.40 (t, 2H, J=6.1 Hz).

¹³C NMR (50 MHz, CD₃CN): 25.44; 52.59 (t; J=4.2 Hz); 57.67; 64.26 (t, J=3.8 Hz).

Mass spectrometry (FAB) for C₁₂H₃₂N₂O₂F₆P

Theoretical mass calculated for (2C⁺, PF₆⁻)⁺ 381.2106

Mass found 381.2098

1d:

A mixture of a solution of 10 g (65 mmol) of N,N′,N″-trimethyl-3-hydroxypropylammonium chloride (1b) in 15 ml of water and 9.1 ml (0.15 mol) of 50% tetrafluoroboric acid in water is stirred at ambient temperature. The medium remains homogeneous. After 12 hours, the water is evaporated to dryness and the white solid obtained is washed twice with 15 ml of anhydrous ether.

White solid Yield=82% Mp=110-112° C.

¹H NMR (200 MHz, Acetone D₆): 2.10-2.241 (m, 2H); 3.05 (s, 9H); 3.24-3.45 (m, 2H); 3.61 (t, J=7.1 Hz, 2H).

¹³C NMR (50 MHz, Acetone D₆): 27.52; 53.35 (t; J_{C-N}=4.1 Hz); 58.25; 64.58.

1e:

10 g of ammonium salt (1b) (65.3 mmol) is dissolved in 10 ml water. This solution is added to 20 g of lithium bis-trifluoromethanesulphonamide (71.9 mmol) in 10 ml of water. The mixture is stirred for 2 hours at ambient temperature. The two phases obtained are separated, and the aqueous phase is extracted twice with 15 ml of methylene chloride. Finally the solvent is evaporated off and the product is dried under vacuum.

Colourless viscous oil Yield=86%

¹H NMR (200 MHz, Acetone D₆): 2.00-2.21 (m, 2H); 3.25 (s, 9H); 3.50-3.80 (m, 4H).

¹³C NMR (50 MHz, Acetone D₆): 29.14; 54.27 (t; J_{C-N}=4.1 Hz); 60.05; 66.09; 121.05 (q, J=321.2 Hz).

1f:

2 ml (23.90 mmol) of 3-chloropropanol and 4 ml of a 45% solution of trimethylamine in water (40 mmol) are placed in a 250 ml flask. The mixture is then taken to reflux for 24 hours. The solvents are then evaporated under vacuum. The white solid obtained is washed twice with 30 ml of ether.

White solid Yield=94% Mp=118-120° C.

¹H NMR (200 MHz, D₂O): 1.6-1.78 (m, 2H); 1.85-2.05 (m, 2H); 3.25 (s, 9H); 3.4-3.5 (m, 2H); 3.60 (t, 2H, J=7.2 Hz)

¹³C NMR (50 MHz, D2O): 19.50; 28.43; 53.18 (t, J_{C-N}=4.1 Hz); 61.11; 66.66.

1g:

A solution of 1 g (0.01 mole) of ammonium salt (1f) in 1 ml of water is prepared in a beaker. In another beaker, 2 g (0.018 mmol) of lithium bis-trifluoromethanesulphonamide is dissolved in the same way. The two solutions are mixed together and stirred for 2 hours at ambient temperature to ensure total exchange. The two phases obtained are separated in a separatory funnel, and the aqueous phase is extracted twice with 15 ml of methylene chloride. Finally the solvent is evaporated off and the product is dried under vacuum.

Colourless viscous oil Yield=86%

¹H NMR (200 MHz, Acetone D₆): 1.5-1.65 (m, 2H); 1.9-2.2 (m, 2H); 3.3 (s, 9H); 3.50-3.65 (m, 5H).

¹³C NMR (50 MHz, Acetone D₆): 20.91; 30.47; 53.99 (t; J_{C-N}=4.03 Hz); 61.88; 67.90; 121.05 (q, J=321.2 Hz)

1h:

4.71 g (37.4 mmol) of methyltriflate at 0° C. is added to a solution of 4 g (34 mmol) of N,N′-dimethylamino-1-butanol in 10 ml of acetonitrile. It is allowed to reach ambient temperature under stirring and is then stirred for 2 hours. After this, the solvent is evaporated to dryness and the colourless oil obtained is washed with 3×10 ml of ether and dried under vacuum.

Colourless oil Yield=97%

¹H NMR (200 MHz, Acetone D₆): 1.65-1.80 (m, 2H); 1.90-2.00 (m, 2H); 3.12 (s, 9H); 3.3-3.5 (m, 2H); 3.68 (t, 2H, J=6.13 Hz)

¹³C NMR (50 MHz, Acetone D₆): 28.36; 28.99; 51.93 (t; J_{C-N}=4.03 Hz); 60.47; 68.75 (t; J_{C-N}=4.03 Hz); 121.05 (q, J=321.2 Hz)

1i:

5 g (36 mmol) of 6-chlorohexanol, 10 ml of a 45% solution of trimethylamine in water (0.1 mol) and 100 ml of acetonitrile to homogenize the medium are placed in a 250 ml flask. The mixture is then taken to reflux for 36 hours. The water/acetonitrile mixture is evaporated under vacuum and the white solid obtained is washed twice with 30 ml of ether.

White solid Yield=62% Mp=178-180° C.

¹H NMR (200 MHz, MeOH): 1.30-1.65 (m, 6H); 1.80-1.95 (m, 2H); 3.18 (s, 9H); 3.4-3.6 (m, 2H); 3.55 (t, 2H, J=6.1 Hz).

¹³C NMR (50 MHz, MeOH): 22.93; 25.48; 26.15; 32.35; 52.60 (t; J=4.1 Hz); 61.67; 66.76.

1i

A mixture of a solution of 10 g (51.2 mmol) of N,N′,N″-trimethyl-6-hydroxybutylammonium chloride (1i) in 15 ml of water and 18.7 g (6.66 mmol) of lithium bis-trifluoromethanesulphonamide is stirred at ambient temperature. The medium immediately becomes heterogeneous, and the two phases are separated in a separatory funnel. The colourless oil obtained is then washed twice with 3 ml of water and dried at 50° C. under high vacuum.

Colourless oil Yield=93%

¹H NMR (200 MHz, Acetone, D6): 1.41-1.60 (m, 6H); 1.88-2.01 (m, 2H); 3.30 (s, 9H); 3.50-3.65 (m, 4H); 3.55 (t 2H, J=6.1 Hz).

¹³C NMR (50 MHz, Acetone, D6): 23.02; 25.60; 26.22; 53.01 (t; J=4.1 Hz); 61.73; 66.99; 121.05 (q, J=324.2 Hz).

2/Phosphonium salts 2:

| 2 | 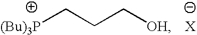 |
|---|---|
| 2a | X = Cl |
| 2b | X = NTf₂ |

2a:

2 ml (23.90 mmol) of 3-chloropropanol and 7.2 ml (28.68 mmol) of tributylphosphine are taken to reflux for 14 h. The excess of tributylphosphine is then eliminated by washing in ether (3×10 ml).

Colourless oil Yield=72%

¹H NMR (200 MHz, D₂O): 0.90 (t; 9H; J=5.57 Hz); 1.30-1.60 (m, 12H); 1.65-1.85 (m, 2H); 2.05-2.30 (m, 8H); 3.55-3.70(m, 2H).

¹³C NMR (50 MHz, D₂O): 13.15; 14.91; 15.90; 17.57; 18.53; 23.10, 23.59; 23.89; 34.62; 42.52; 58.77; 61.32, 61.64.

2b:

2 g (6.97 mmol) of lithium bis-trifluoromethanesulphonamide and 1 g (3.36 mmol) of tributyl-3-hydroxypropyl phosphonium chloride (2a) are dissolved in 3 ml of water. The two solutions are then mixed and stirred for 2 h at ambient temperature.

The aqueous phase is extracted twice with 15 ml of methylene chloride and the organic phases are re-assembled and dried over MgSO₄. The solvent is then evaporated to dryness and the product obtained is dried under vacuum.

Colourless oil Yield=90%

¹H NMR (200 MHz, Acetone D₆): 0.75 (t; 9H; J=7.13); 1.22-1.60 (m, 12H); 1.61-1.82 (m, 2H); 2.12-2.34 (m, 8H); 3.45-3.60 (m, 2H); 3.8 (t, 1H, J=5 Hz)

¹³C NMR (50 MHz, Acetone D₆): 13.99; 16.06; 17.05; 18.90; 19.86; 24.29; 24.38; 24.81; 25.12; 25.61; 25.70; 62.05; 62.35; 121.05 (q, J_{CF}=374.2 Hz)

3/Pyridinium salts 3:

| 3 | 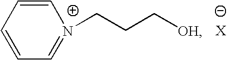 |
|---|---|
| 3a | X = Cl |
| 3b | X = NTf₂ |

3a:

2 ml (23.9 mmol) of 3-chloropropanol and 6 ml of pyridine are introduced into a 100 ml flask. The reaction mixture is heated to 80° C. overnight. The excess pyridine is eliminated by washing with 3×10 ml of ether. Finally, the product is crystallized from acetone.

White solid Yield=73% Mp=68-70° C.

¹H NMR (200 MHz, D₂O): 2.1-2.3 (m, 2H); 3.6 (t, J=5.99 Hz, 2H); 3.75 (t, J=7.19 Hz, 2H); 8.01 (t, J=7.04 Hz, 2H); 8.55 (t, J=9.97 Hz, 1H); 8.83 (d, J=6.04 Hz, 2H)

¹³C NMR (50 MHz, D₂O): 33.14; 58.22; 59.51; 128.72; 144.89; 146.12

3b:

2 g (6.97 mmol) of lithium bis-trifluoromethane-sulphonamide are dissolved in 3 ml of water in a beaker. In the same way, approximately 1 g (5.76 mmol) of 3-hydroxypropylpyridinium chloride (3a) is dissolved in water in another beaker, then the two solutions are mixed and stirred for two hours.

The content of the beaker is poured into a separatory funnel. The aqueous phase is extracted twice with 15 ml of methylene chloride. The organic phases are collected and dried over MgSO₄. The solvent is then evaporated to dryness and the product is dried under vacuum.

Colourless oil Yield=90%

¹H NMR (200 MHz, Acetone): 2.03-2.21 (m, 2H); 3.5 (t, J=6.1 Hz, 2H); 3.8 (t, J=6.9 Hz, 1H); 4.73 (t, J=7 Hz, 2H); 8.1 (t, J=7 Hz, 2H); 8.52 (t, J=9.8 Hz, 1H); 8.98(d, J=6.1 Hz, 2H),

¹³C NMR (50 MHz, Acetone): 34.57; 58.95; 60.95; 121.37 (q, J_{C-F}=320.9 Hz); 129.67; 146.46; 147.11

4 Imidazolium salts 4:

| 4 | 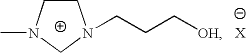 |
|---|---|
| 4a | X = Cl |
| 4b | X = NTf₂ |

4a:

2 ml (23.90 mmol) of 3-chloropropanol and 2.87 g (35 mmol) of N-methylimidazole are introduced into a 100 ml flask. The reaction mixture is heated to 80° C. overnight. The excess of the N-methylimidazole is eliminated by washing with ether (3×10 ml) and the white solid obtained is dried under vacuum.

White solid Yield=80%

¹H NMR (200 MHz, D₂O): 1.96-2.25 (m, 2H); 3.55 (t, 2H, J=6.11 Hz); 3.85 (s, 3H); 4.15 (t, 2H, J=7.12 Hz); 7.43 (apparent t, 1H, J=1.73 Hz); 7.48 (apparent t, 1H, J=1.74 Hz); 8.75 (s, 1H)

¹³C NMR (50 MHz, D₂O): 32.87; 35.40; 47.23; 58.29; 123.03; 124.26; 137.06

4b:

2 g (6.97 mmol) of LiNTf₂ is dissolved in 3 ml of water in a beaker. In the same way, approximately 1 g of imidazolium chloride 4a is dissolved in water in another beaker. The two solutions are mixed, and stirred for two hours.

The content of the beaker is poured into to a separatory funnel. The aqueous phase is extracted twice with 15 ml of methylene chloride. The organic phases are collected and dried over MgSO₄. The solvent is then evaporated to dryness and the product is dried under vacuum.

colourless oil Yield=90%

¹H NMR (200 MHz, Acetone): 2.15-2.21 (m, 2H); 3.65 (t, 2H, J=6.11 Hz); 4.05 (s, 3H); 4.15 (t, 2H, J=7.12 Hz); 7.68 (apparent t, 1H, J=1.73 Hz); 7.73 (apparent t, 1H, J=1.74 Hz); 8.95 (s, 1H)

¹³C NMR (50 MHz, Acetone): 32.32; 35.92; 47.01; 58.35; 121.37 (q, J_{C-F}=320.9 Hz); 123.25; 124.01; 136.50

II) Functionalization of the Previous Salts:

1/Acrylic ester 5:
General procedure for esterification with acrylic acid:

| | |
|---|---|
| 5 | 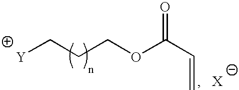 |

| 5 | Y | n | X |
|---|---|---|---|
| 5a | N(Me)₃ | 0 | NTf₂ |
| 5b | N(Me)₃ | 1 | Cl |
| 5c | N(Me)₃ | 1 | BF₄ |
| 5d | N(Me)₃ | 1 | NTf₂ |
| 5e | N(Me)₃ | 2 | NTf₂ |
| 5f | P(Bu)₃ | 1 | NTf₂ |
| 5g | Py | 1 | NTf₂ |
| 5h | Im | 1 | NTf₂ |

A solution of the onium salt and 3 equivalents of acryloyl chloride in acetonitrile is heated to 80° C. for 2 hours in the presence of 5 equivalents of solid K₂CO₃. The reaction mixture is then placed under vacuum at 40° C. in order to eliminate the solvent and the excess of the reagent. The onium acrylate is then extracted with methylene chloride.

5a:

pink oil Yield=90%

¹H NMR (200 MHz, Acetone D₆): 3.5 (s, 9H); 4.03-4.40 (m, 2H); 4.73-4.85 (m, 2H); 6.05 (dd, 1H, J=1.92 Hz, J₂=10.5 Hz); 6.25 (dd, 1H, J₁=10.5 Hz, J₂=17.3 Hz); 6.45 (dd, 1H, J=1.9 Hz, J₂=17.3 Hz)

¹³C NMR (50 MHz, Acetone D₆): 54.01 (t, J=4.2 Hz); 58.25; 65.23; 121.05 (q, J_{CF}=374.2 Hz); 128.80; 132.24; 165.46

5b:

White solid Yield=100% Mp=175-177° C.

¹H NMR (200 MHz, Acetone D₆): 2.15-2.20 (m, 2H); 3.15 (s, 9H); 3.48-3.52 (m, 2H); 4.18 (t, 2H, J=6.0 Hz); 5.75 (dd, 1H, J=1.92 Hz, J₂=10.5 Hz); 6.15 (dd, 1H, J₁=10.5 Hz, J₂=17.3 Hz); 6.15 (dd, 1H, J=1.9 Hz, J₂=17.3 Hz)

¹³C NMR (50 MHz, Acetone D₆): 21.74; 52.23 (t, J=4.2 Hz); 60.44 (t, J=3.02); 62.6; 127.41; 130.65; 165.04

5c:

Colourless oil Yield=93%

1H NMR (200 MHz, Acetone D₆): 2.28-3.31 (m, 2H); 3.32 (s, 9H); 3.06-3.15 (m, 2H); 4.52 (t, 2H, J=6.6 Hz); 5.80 (dd, 1H, J=1.9 Hz, J₂=10.0 Hz); 6.05 (dd, 1H, J₁=18.3 Hz, J₂=10.0 Hz); 6.15 (dd, 1H, J₁=1.9 Hz, J₂=18.3 Hz)

¹³C NMR (50 MHz, Acetone D₆): 22.81; 53.28; 61.46; 63.83; 128.51; 131.72; 167.31

5d:

Colourless oil Yield=100%.

¹H NMR (200 MHz, Acetone D₆): 2.22-2.25 (m, 2H); 3.25 (s, 9H); 3.60-3.75 (m, 2H); 4.15 (t, 2H, J=6.0 Hz); 5.80 (dd, 1H, J₁=1.92 Hz; J₂=10.68 Hz); 6.05 (dd, 1H, J₁=17.2; J₂=10.7); 6.15 (dd, 1H, J=1.9 Hz; J₂=17.2 Hz)

¹³C NMR (50 MHz, Acetone D₆): 29.17; 54.16 (t, J=4.0); 65.16; 65.23; 121.05 (q, J_{CF}=374.2 Hz); 129.40; 132.15; 165.61

¹⁹F NMR (282 MHz, Acetone D₆): −79.8

Mass spectrometry (FAB) for C₉H₁₈NO₂

Theoretical mass calculated for (C⁺) 172.1338

Mass found 172.1346

5e:

Colourless oil Yield=77%

¹H NMR (200 MHz, Acetone D₆): 1.7-1.9 (m, 2H); 2.00-2.20 (m, 2H); 3.40 (s, 9H); 3.58-3.72 (m, 2H); 4.25 (t, 2H, J=6.0 Hz); 5.80 (dd, 1H, J₁=1.92 Hz; J₂=10.68 Hz); 6.05 (dd, 1H, J₁=17.2; J₂=10.7); 6.15 (dd, 1H, J₁=1.9 Hz; J₂=17.2 Hz)

¹³C NMR (50 MHz, Acetone D₆): 20.86; 26.44; 53.99; 64.52; 67.37: 122.19 (q, J_{CF}=374.2 Hz); 129.69; 131.83; 166.99

5f:

Colourless oil Yield=77%

¹H NMR (200 MHz, Acetone D₆): 1 (t, 9H, J=7.2 Hz); 1.45-1.85 (n, 12H); 2.10-2.28 (m, 2H); 2.48-2.7 (m, 8H); 4.3 (t, 2H, J=6.27 Hz); 5.58 (dd, 1H, J₁=0.3 Hz; J₂=1.96 Hz); 6.18 (dd, 1H, J₁=17.16 Hz; J₂=0.3 Hz); 6.4 (dd, 1H, J₁=17.16 Hz; J₂=1.97 Hz)

¹³C NMR (50 MHz, Acetone D₆): 13.09; 15.10; 16.09; 17.84; 18.80; 21.15; 21.22; 23.38; 23.47; 23.86; 24.18; 63.77; 64.11; 121.05 (q, J_{CF}=374.2 Hz); 128.63; 131.12; 165.74

5g

Colourless oil Yield=80%

¹H NMR (200 MHz, Acetone D₆): 2.15-2.27 (m, 2H); 3.8 (t, J=6.1 Hz, 2H); 4.96 (t, J=6.8 Hz, 2H); 5.54 (dd, 1H, J₁=0.5 Hz; J₂=2 Hz); 6.18 (dd, 1H, J=17.2 Hz; J₂=0.3 Hz); 6.4 (dd, 1H, J₁=17.2 Hz; J₂=2 Hz); 8.1 (t, J=7 Hz, 2H); 8.52 (t, J=9.8 Hz, 1H); 8.98 (d, J=6.2 Hz, 2H)

¹³C NMR (50 MHz, Acetone D₆): 30.39; 59.98; 61.42; 121.05 (q, J_{CF}=374.2 Hz); 128.75; 128.98; 131.38; 145.48; 146.50; 165.78

5h:

Colourless oil Yield=85%

¹H NMR (200 MHz, Acetone D₆): 2.3-2.5 (m, 2H); 4.15 (s, 3H); 4.28 (t, 2H, J=6.03 Hz); 4.63 (t, 2H, J=6.99 Hz); 5.95 (dd, 1H, J₁=1.92; J₂=10.68); 6.18 (dd, 1H, J, =17.2 Hz; J₂=10.7 Hz); 6.4 (dd, 1H, J=1.9 Hz; J₂=17.2 Hz); 7.8 (apparent t, 1H, J=1.70 Hz); 7.95 (apparent t, 1H, J=1.82 Hz); 9.2 (s, 1H)

¹³C NMR (50 MHz, Acetone D₆): 29.32; 36.17; 47.38; 61.36; 121.05 (q, J_{CF}=374.2 Hz); 122.97; 124.30; 128.44; 131.31; 136.948; 166.07

2/4-iodobenzoic esters 6:

| 6 | 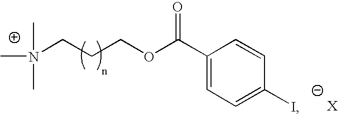 | |
|---|---|---|
| 6 | n | X |
| 6a | 2 | I |
| 6b | 2 | NTf₂ |
| 6c | 2 | PF₆ |
| 6d | 2 | BF₄ |
| 6e | 2 | OTf |
| 6f | 0 | BF₄ |
| 6g | 1 | NTF₂ |

6a:

1.1 ml (13.15 mmol) of methyl iodide is added dropwise at 0° C. to a solution of 4g (10.96 mmol) of 3-dimethyl-aminopropyl para-iodobenzoate in 10 ml of acetonitrile. The white solid thus formed is filtered then washed with 3×10 ml of ether.

White solid Yield=99% Mp=248-250° C.

¹H NMR (200 MHz, Acetone D₆): 1.9-2.05 (m, 4H); 3.20 (s, 9H); 3.42-3.55 (m, 2H); 4.45 (t, 2H, J=6.05 Hz); 7.8 (d, 2H, J=8.73 Hz); 7.95 (d, 2H, J₁=8.76 Hz)

¹³C NMR (50 MHz, Acetone D₆): 19.89; 25.45; 53.37 (t, J_{C-N}=4.1 Hz); 65.13; 66.42; 101.57; 131.19; 131.45; 138.38; 166.78

Mass spectrometry (FAB) for C₂₈H₄₂N₂O₄I₃

Theoretical mass calculated for (2C⁺, I⁻)⁺ 851.03

Mass found 851.10

6b:

A 2.65 mmol of LiNTf₂ in solution in water is added to a solution of 1 g (2.04 mmol) of 6a in 30 ml of the water/acetone mixture. After stirring at ambient temperature for 2 hours, the solvent is evaporated off and the salt extracted with 3×10 ml of methylene chloride. After evaporation of the latter, a white solid is obtained.

White solid Yield=90% Mp=48-50° C.

¹H NMR (200 MHz, Acetone D₆): 1.82-2 (m, 2H); 2.1-2.22 (m, 2H); 3.38 (s, 9H); 3.6-3.72 (m, 2H); 4.4 (t, 2H, J=6.24 Hz); 7.8 (d, 2H, J=8.73 Hz); 7.95 (d, 2H, J₁=8.36 Hz)

¹³C NMR (50 MHz, Acetone D₆): 26.66; 29.12; 54.12 (t. J_{C-N}=4.1 Hz); 65.28; 67.40; 101.59; 121.17 (q, J_{C-F}=320.9 Hz); 131.17; 132.28; 139.23; 166.74

Mass spectrometry (FAB) for C₃₀H₄₂N₃O₈F₆I₂S₂

Theoretical mass calculated for (2C⁺, NTf₂⁻)⁺ 1004.0407

Mass found 1004.0427

6c:

2.65 mmol of (60%) HPf₆ in solution in water is added to a solution of 1 g (2.04 mmol) of ammonium 6a in 30 ml of the water/acetone mixture. After 2 h of stirring at ambient temperature the solvent is evaporated off and the solid obtained is washed with ether (3×10 ml).

White solid Yield=96% Mp=204-206° C.

¹H NMR (200 MHz, Acetone D₆): 2.05-2.2 (m, 2H); 2.28-2.47 (m, 2H); 3.6 (s, 9H); 3.8-3.97 (m, 2H); 4.6 (t, 2H, J=6.3 Hz); 8 (d, 2H, J=8.58 Hz); 8.15 (d, 2H, J₁=8.58 Hz)

¹³C NMR (50 MHz, Acetone D₆): 20.97; 26.65; 54.06 (t; J=4.03 Hz); 65.31; 67.4 (t; J=3.17 Hz); 101.57; 131.19; 132.32; 139.23; 166.75

Mass spectrometry (FAB) for C₂₈H₄₂N₂O₄F₆I₂P

Theoretical mass calculated for (2C⁺, PF₆⁻)⁺ 869.0876

Mass found 869.0879

6d:

2.65 mmol of 40% HBF₄ in solution in water is added to a solution of 1 g (2.04 mmol) of 6a in 3 ml of water. After the former has been added, the formation of a white solid is noted. The reaction mixture is stirred for two hours at ambient temperature. The white solid obtained after filtration is washed with water (in order to eliminate the excess of HBF₄) then twice with 30 ml of ether and finally dried under vacuum.

White solid Yield=86% Mp=184-186° C.

¹H NMR (200 MHz, Acetone D₆): 1.90-2.00 (m, 2H); 2.15-2.28 (m, 2H); 3.4 (s, 9H); 3.65-3.80 (m, 2H); 4.42 (t, 2H, J=6.3 Hz); 7.85 (d, 2H, J=8.58 Hz); 8.15 (d, 2H, J₁=8.58 Hz)

¹³C NMR (50 MHz, Acetone D₆): 20.96; 26.62; 53.97 (t; J=4.03 Hz); 65.34; 101.53; 131.22; 132.34; 139.23; 166.73

Mass spectrometry (FAB) for C₂₈H₄₂N₂O₄F₄I₂B

Theoretical mass calculated for (2C⁺, BF₄⁻)⁺ 811.1263

Mass found 811.1259

6e:

1.1 ml (13.15 mmol) of methyl triflate is added dropwise at 0° C. to a solution of 1 g (10.96 mmol) of 3-dimethylamino-propyl para-iodobenzoate in 10 ml of acetonitrile. The white solid thus formed is filtered then washed with 3×10 ml of ether.

White solid Yield=96% Mp=176-178° C.

¹H NMR (200 MHz, CD₃CN): 1.8-2.1 (m, 4H); 3.06 (s, 9H); 3.35-3.45 (m, 2H); 4.4 (t, 2H, J=6.05 Hz); 7.85 (d, 2H, J=8.58 Hz); 8 (d, 2H, J₁=8.58 Hz)

¹³C NMR (50 MHz, CD₃CN): 19.16; 24.66; 52.50 (t; J=4.03 Hz); 63.66; 65.62 (t; J=3.17 Hz); 99.89, 121.17 (q, J_{C-F}=320.9 Hz); 129.58; 130.59; 137.57; 165.39

Mass spectrometry (FAB) for C₂₉H₄₂N₂O₇F₃I₂S

Theoretical mass calculated for (2C⁺, OTf)⁺ 873.1

Mass found 873.1

6f:

1.5 eq of DCC, 1.5 eq of 4-iodobenzoic acid and 0.2 eq of DMAP is added to a mixture of commercial (2-hydroxy-ethyl)-trimethylammonium chloride in 100 ml of CH₃CN. The reaction mixture is stirred for 4 hours at ambient temperature then evaporated to dryness. The ester formed is extracted with 3×30 ml of water. 1.5 eq of 50% HBF₄ in solution in water is added to this solution. The reaction mixture is stirred for two hours at ambient temperature. The white solid obtained after filtration is washed with water (in order to eliminate the excess of HBF₄) then twice with 30 ml of ether and finally dried under vacuum.

Appearance of the product: White solid Yield=90% Mp=200-202° C.

¹H NMR (CD3CN, 300 Mhz): 3.18 (s, 9H); 3.68-3.80 (m, 2H); 4.50-4.73 (m, 2H); 7.78 (dd, J₁=1.9 Hz, J₂=6.7 Hz; 2H); 7.90 (dd, J₁=1.8 Hz, J₂=6.6 Hz, 2H).

¹³C NMR (CD3CN, 75 Mhz): 53.40 (t, J=3.8 Hz); 58.27; 64.38 (t, J=3.8 Hz); 100.57; 128.65; 130.68; 137.76; 164.73.

Mass spectrometry (APCI) for [C₁₂H₁₇INO₂][BF₄]:

Theoretical mass calculated for (C⁺) 334.2

Mass found 334.0

6g

1.5 eq of DCC, 1.1 eq of 4-iodobenzoic acid and 0.2 eq of DMAP are added to a solution of 12.6 mmol of alcohol 1e in 60 ml of CH₃CN. The reaction mixture is stirred for 4 hours at ambient temperature; filtered and then evaporated to dryness. The white solid obtained is washed several times with ether and finally dried under vacuum.

Appearance of the product: white solid Yield=95% Mp=48-50° C.

¹H NMR (300 MHz, Acetone D₆): 2.40-2.60 (m, 2H); 3.47 (S, 9H); 3.80-4.00 (m, 2H); 4.53 (t, 2H, J=5.9 Hz); 7.83 (d, 2H, J=8.3 Hz); 7.97 (d, 2H, J=8.3 Hz).

¹³C NMR (50 MHz, Acetone D₆): 23.07; 53.37 (t, J=3.8 Hz); 62.19; 64.46; 100.91; 120.50 (q, J_{CF}=321.2 Hz); 129.97; 131.51; 138.33; 165.75.

Mass spectrometry (APCI) for [C₁₃H₁₉INO2][C₂NS₂O₄F₆]:

Theoretical mass calculated for (C⁺) 348.2

Mass found 348.3

3/4-substituted benzoic esters 7:

| 7 | 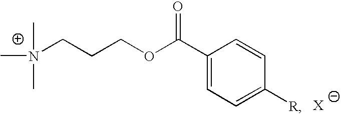 | |
|---|---|---|
| N^{o} | X | R |
| 7a | Cl | Br |
| 7b | NTf₂ | Br |
| 7c | PF₆ | Br |
| 7d | BF₄ | Br |
| 7e | BF₄ | CH₂═CH— |
| 7f | Cl | NH₂ |
| 7g | NTf₂ | NH₂ |
| 7h | BF₄ | O═CH— |

7a:

2 g (13.1 mmol) of N,N′,N″-trimethyl-3-hydroxypropylammonium chloride, 25 ml of acetonitrile, 20 g of K₂CO₃ in powder and 4 g (17.5 mmol) of 4-bromobenzoic acid chloride are introduced into a 250 ml flask. After stirring overnight at ambient temperature, K₂CO₃ is filtered and washed with 3 times 15 ml of methylene chloride and finally evaporated to dryness. It is taken up with water and the excess of 4-bromobenzoic acid, which crystallizes by filtration, is eliminated. The product is then crystallized from acetone after evaporation of water.

White solid Yield=60% Mp=164-166° C.

¹H NMR (200 MHz, D₂O): 2.21-2.34 (m, 2H); 3.12 (s, 9H); 3.30-3.58 (m, 2H); 4.35 (t, 2H, J=6.8 Hz); 7.57 (d, 2H, J=7.4 Hz); 7.80 (d, 2H, J=7.4 Hz)

¹³C NMR (50 MHz, D₂O): 22.55; 30.61; 53.34 (t, J_{C-N}=4.2 Hz); 62.69; 64.41 (t, J_{C-N}=4.09 Hz); 128.34; 128.66; 131.37; 132.20; 167.84

Mass spectrometry (FAB) for C₁₃H₁₉NO₂Br

Theoretical mass calculated for (C⁺) 300.0599

Mass found 302.0607

7b:

In this case, synthesis of the substrate has been envisaged according to two approaches: by direct esterification of the N,N,N-trimethyl-3-hydroxypropylammonium bis-trifluoromethanesulphonamide or by metathesis from the corresponding chloride.

Esterification:

4 g (10.5 mmol) of alcohol, 20 ml of acetonitrile, 2 ml of a saturated solution of Na₂CO₃ in water and 4 g (17.5 mmol) of 4-bromobenzoic acid chloride are introduced into a 250 ml flask. The reaction mixture is heated to 60° C. overnight. It is then evaporated to dryness, and the residue obtained is dissolved in methylene chloride. This solution is successively washed twice with 20 ml of water, twice with 20 ml of a soda solution (1 N) and finally twice with 20 ml of water. The solution is dried over magnesium sulphate and the solvent is evaporated to dryness. It is taken up in acetone and the traces of acids are eliminated by precipitation at 4° C. After drying under vacuum, a pure white solid is obtained.

Yield=90%.

Metathesis

1 g (2.98 mmol) of 1b is dissolved in 5 ml water in a 100 ml flask. 1.1 g (3.19 mmol) of lithium bis-trifluoromethanesulphonamide (LiNTf₂) in solution in 3 ml of water is added to this solution. The reaction mixture is stirred for 2 hours at ambient temperature before extracting the product with 20 ml of methylene chloride. After evaporation of the latter, a white solid is obtained, which is dried wider vacuum.

White solid Yield=90% Mp=86-88° C.

¹H NMR (200 MHz, Acetone D₆): 2.64-2.83 (m, 2H); 3.59 (s, 9H); 3.96-4.06 (m, 2H); 4.71 (t, 2H, J=6.76 Hz); 7.90 (d, 2H, J=8.9 Hz); 8.19 (d, 2H, J=8.9 Hz)

¹³C NMR (50 MHz, Acetone D₆): 23.96; 54.24 (t, J_{C-N}=4.2 Hz); 63.09; 65.35 (t, J_{C-N}=4.0 Hz); 121.46 (q, J_{C-F}=322.0 Hz); 128.95; 130.42; 132.58; 133.12; 166.34

Mass spectrometry (FAB) for C₂₈H₃₈F₆N₃O₈S₂Br₂

Theoretical mass calculated for (2C⁺, NTf₂⁻) 880.0371

Mass found 880.0375

7c:

0.5 ml (5.7 mmol) of HPF₆ at 60% in water is added to a solution of 1 g (2.98 mmol) of 1b in 3 ml of water. The reaction mixture is stirred for two hours at ambient temperature. The white solid obtained after filtration is washed with water, then twice with 30 ml of ether, and finally dried under vacuum.

White solid Yield=96% Mp=154-156° C.

¹H NMR (200 MHz, Acetone D₆): 2.45-2.59 (m, 2H); 3.40 (s, 9H); 3.79-3.85 (m, 2H); 4.50 (t, 2H, j=6.0 Hz); 7.55 (dd, 2H, J₁=1.9 Hz; J₂=7.7 Hz); 8.00 (dd, 2H, J₁=1.9 Hz; J₂=7.7 Hz)

¹³C NMR (50 MHz, Acetone D₆): 22.96; 53.23 (t, J=4.0 Hz); 62.31; 64.34; 128.06; 129.48; 131.79; 132.25; 165.63

¹⁹F NMR (282 MHz, Acetone D₆): -71.6 (d; J=707.3 Hz; P—F)

³¹P NMR (Acetone, 129.5 MHz) δ: −142 (m, J=0.7 Hz, P—F₆)

Mass spectrometry (FAB) for C₂₆H₃₈F₆N₂Br₂O₄P

Theoretical mass calculated for (2C⁺, PF₆⁻) 745.0840

Mass found 745.0824

7d:

1 ml of 40% HBF₄ in solution in water is added to a solution of 1 g (2.98 mmol) of 1b in 3 ml of water. After the former has been added, formation of a white solid is noted. The reaction mixture is stirred for two hours at ambient temperature. The white solid obtained after filtration is washed with water (in order to eliminate the excess of HBF₄) then twice with 30 ml of ether and finally dried under vacuum.

White solid Yield=98% Mp=154-156° C.

¹H NMR (200 MHz, Acetone D6): 2.39-2.57 (m, 2H); 3.35 (s, 9H); 3.70-3.87 (m, 2H); 4.50 (t, 2H, J=5.91 Hz), 7.73 (dd, 2H, J₁=1.97 Hz; J₂=6.77 Hz); 8.02 (dd, 2H, J₁=1.77 Hz; J₂=6.47 Hz)

¹³C NMR (50 MHz, Acetone D₆): 22.96; 53.14 (4.1 Hz); 62.35; 64.29; 128.01; 129.52; 131.85; 132.24; 165.61

¹⁹F NMR (282 MHz, Acetone D₆): −150.16(s, B—F)

Mass spectrometry (FAB) for C₂₆H₃₈F₄N₂O₄Br₂B

Theoretical mass calculated for (2C⁺, BF4⁻) 689.1228

Mass found 689.1234

7e:

1.5 eq of DCC, 1.5 eq of 4-vinylbenzoic acid are added to a mixture of the alcohol 1b in 100 ml of CH₃CN, in the presence of 0.02 eq of DMAP. The reaction mixture is stirred for 4 hours at ambient temperature then evaporated to dryness. The ester formed is extracted with 3×30 ml of water. 1.5 eq of NaBF₄ in solution in water is added to this solution. The reaction mixture is stirred for two hours at ambient temperature. The white solid obtained after filtration is washed with water (in order to eliminate the excess of NaBF₄) then twice with 30 ml of ether and finally dried under vacuum.

Appearance of the product: white solid Yield=75% Mp=138-140° C.

¹H NMR (300 MHz, Acetone D₆): 2.30-2.48 (m, 2H); 3.38 (S, 9H); 3.69-3.82 (m, 2H); 4.36 (t, 2H, J=6.0 Hz), 6.58 (d, 1H, J=16.1 Hz); 7.40-7.50 (m, 3H); 7.63-7.78 (m, 3H).

¹³C NMR (75 MHz, Acetone D₆): 22.68, 52.79 (t, J=3.8 Hz); 60.88; 63.86 (t, J=3.32 Hz); 117.76; 128.20; 128.95; 130.43; 134.42; 144.86; 165.99.

Mass spectrometry (APCI) for [C₁₅H₂₂NO₂][BF₄]

Theoretical mass calculated for (C⁺) 248.3

Mass found 248.2

7f:

Method 1

5 ml of thionyl chloride (68.54 mmol) is added, dropwise and at 0° C., to a solution of 5 g (36.46 mmol) 4-aminobenzoic acid in 30 ml of 3-chloropropanol. The reaction mixture is then taken to 100° C. for 3 hours. 50 ml of ether is then added and the white solid thus formed is filtered then washed with 3×10 ml of ether. The solid is then dissolved in 30 ml of water and the ester is then extracted with 3×20 ml of ethyl acetate. The organic phase is finally washed with 20 ml of a saturated solution of K₂CO₃ and evaporated.

The mixture constituted by the white solid obtained, 5 ml of a solution of trimethylamine at 45% in water and 0.5 g of NaI are dissolved in 20 ml of acetonitrile. They are then taken to reflux for 16 hours. After this the solvent is evaporated off and the product is crystallized from acetone.

White solid Yield (in two stages)=58% Pf=120-122° C.

Method 2

1.5 eq of DCC 1.5 eq of 4-nitrobenzoic acid in the presence of 0.02 eq of DMAP is added to the alcohol mixture 1b in 100 ml of CH₃CN. The reaction mixture is stirred for 4 hours at ambient temperature then evaporated to dryness and the ester formed is extracted with 3×30 ml of water. Reduction of the nitro group is carried out by adding to this solution 0.01 eq of Pd/C₅% under stirring at ambient temperature under a pressure of 5 bar hydrogen for 8 hours. After filtration and evaporation of the water the product is recrystallized from acetone.

Yield=90%

¹H NMR (200 MHz, D₂O): 2.1-2.25 (m, 2H); 3.09 (s, 9H); 3.32-3.45 (m, 2H); 4.48 (t, 2H, J=6.15 Hz); 6.75 (d, 2H, J=7.78 Hz); 7.72 (d, 2H, J=7.78 Hz).

¹³C NMR (50 MHz, D₂O): 22.61; 30.63; 53.37 (t, J_{C-N}=4.1 Hz); 61.88; 64.23; 114.91; 118.20; 132.02; 153.03; 168.80

7g:

4.77 mmol of LiNTf₂ in solution in water is added to a solution of 1 g (3.67 mmol) of 7f in 10 ml of water. After stirring at ambient temperature for 2 hours, the white solid obtained is filtered then dried.

White solid Yield=93% Mp=109-110° C.

¹H NMR (200 MHz, Acetone D₆): 2.35-2.51 (m, 2H); 3.41 (s, 9H); 3.78-3.92 (m, 2H); 4.5 (t, 2H, J=6.1 Hz); 5.51 (signal large, 2H); 6.58 (d, 2H, J=7.9 Hz); 7.84 (d, 2H, J₁=7.7 Hz)

¹³C NMR (50 MHz, Acetone D₆): 24.17; 29.12; 54.12 (t, J_{C-N}=4.1 Hz); 61.72; 65.60; 114.25; 118.33; 121.17 (q, J_{CF}=320.9 Hz); 132.72; 154.74; 167.08

7h:

1.5 eq of DCC, 1.5 eq of 4-carboxybenzaldehyde and 0.2 eq of DMAP is added to a mixture of the alcohol 1b in 100 ml of CH₃CN. The reaction mixture is stirred for 4 hours at ambient temperature then evaporated to dryness. The ester formed is extracted with 3×30 ml of water. 1.5 eq of 50% HBF₄ in solution in water is added to this solution of the ester in water. The reaction mixture is stirred for two hours at ambient temperature. The yellow solid obtained after filtration is washed with water (in order to eliminate the excess of HBF₄) then twice with 30 ml of ether and finally dried under vacuum.

Appearance of the product: yellow solid Yield=90% Mp=146-148° C.

¹H NMR (200 MHz, CD₃CN): 2.10-2.33 (m, 2H); 3.05 (s, 9H); 3.36-3.55 (m, 2H); 4.45 (t, 2H, J=5.8 Hz), 8.00 (dd, 2H, J₁=1.6 Hz, J₂=6.6 Hz); 8.13 (dd, 2H, J₁=1.4 Hz, J₂=8.3 Hz); 10.10 (s, 1H).

¹³C NMR (50 MHz, CD₃CN): 22.08; 52.66 (t, J=3.8 Hz); 61.53; 63.52 (t, J=3.02 Hz); 129.10; 129.80; 134.39; 139.27; 164.89; 192.04.

Mass spectrometry (APCI) for [C₁₄H₂₀NO₃][BF₄]^{:}

| | |
|---|---|
| Theoretical mass calculated for (C⁺) | 250.3 |
| Mass found | 250.2 |

4/Supported Alkyne:

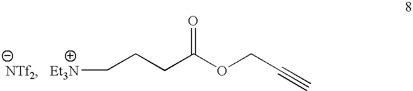

0.9 eq of 4-chlorobutyryl chloride at 0° C. are added dropwise to a solution of 25 mmol of propargylic alcohol in 25 ml of anhydrous methylene chloride and 5 eq of Et₃N. The reaction mixture is stirred for 3 hours at temperature, evaporated to dryness and the ester formed is isolated after extraction with 3×10 ml of ether followed by distillation in a ball oven (60° C., 0.2 mmHg). The salt obtained after the quaternization reaction at 80° C. in the presence of triethylamine, acetonitrile and NaI is used in the metathesis reaction in water in the presence of LiNTf₂, to produce the product 8.

Appearance of the product: orange oil Yield=85%

¹H NMR (200 MHz, Acetone D₆): 1.36-1.55 (1n, 9H); 2.05-2.30 (m, 2H); 2.65 (t, J=6.7 Hz, 2H); 3.05-3.15 (m, 1H); 3.39-3.68 (m, 8H); 4.76 (d, J=2.5 Hz, 2H).

¹³C NMR (50 MHz, Acetone D₆): 7.13; 17.20; 52.19; 53.19 (t, J=2.8 Hz); 56.07; 120.46 (q, J_{CF}=321.4 Hz); 171.68.

Mass spectrometry (APCI) for [C₁₃H₂₄NO₂][C₂NS₂O₄F₆]

Theoretical mass calculated for (C⁺) 226.3

Mass found 226.4
III) Onium Salts with Functionalized Anion:

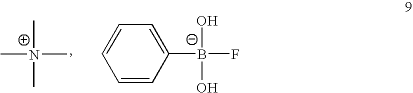

0.1 g (2.1 mmol) of anhydrous tetramethylammonium fluoride is introduced into a 10 mL single-necked flask. Then 1 mL of anhydrous THF is added and the solution is homogenized while heating if necessary. Finally, 0.13 g of phenylboronic acid (2.1 mmol) is introduced. Stirring is continued for approximately 2 hours at ambient temperature.

After stirring for 2 hours, anhydrous ether is added, then the solid is filtered on sintered glass. The solid is washed 2 or 3 times with 20 ml of ether and finally, it is placed under vacuum to dry.

White solid Yield=82% Mp=162-164° C.

¹H NMR (200 MHz, Acetone D₆): 3.15 (s, 12H); 6.8-7.4 (m, 3H); 7.50-7.70 (m, 2H)

¹³C NMR (50 MHz, Acetone. D₆): 56.19 (t, J_{C-N}=3.97 Hz); 127.47; 128.36; 130.91; 132.98; 135.96

¹⁹F NMR spectrum (300 MHz, Acetone. D₆): -136.40 (multiplet)

¹¹B NMR spectrum (300 MHz, Acetone. D₆): 4.66 (D, J_{B-F}=27.4 Hz) (56%); 28.5 (44%)
IV) Glycine Derived Esters:

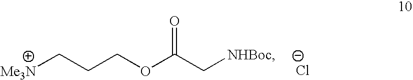

2.0 g (11.3 mmol) of N-Boc-glycine and 1.6 g of 1b (11.2 mmol) are dissolved in 15 ml of methylene chloride and 11.2 mmol of DCC and 5 molar % DMAP are added. The mixture is stirred at ambient temperature for 18 hours. After filtration of the precipitate formed during the course of the reaction, the filtrate is evaporated to dryness and the product obtained is washed with 5×20 ml of ether then dried under vacuum.

Colourless oil Yield=92%

¹H NMR (200 MHz, D₂O): 1.39 (s, 9H); 2.4-2.5 (m, 2H); 3.08 (s, 9H); 3.35-3.45 (m, 2H); 3.75 (s, 2H); 3.32 (t, 2H, J=6.9 Hz)

¹³C NMR (50 MHz, D₂O): 23.82; 39.07; 47.31; 53.69 (t, J_{C-N}=4.0 Hz); 61.62; 65.33; 166.92; 178.06

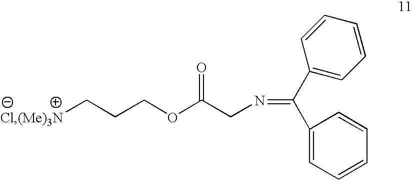

Hydrochloric acid is bubbled through a solution of the ester 10 in 15 ml of methylene chloride for 6 hours. The white precipitate which forms after stirring at ambient temperature for 24 hours is washed twice with ether. The product thus obtained is added to a solution of diphenylmethylene imine (2.0 g; 11 mmol) in 15 ml of methylene chloride. The reaction mixture is then stirred at ambient temperature for 24 hours. The precipitate formed is filtered, the solvent evaporated off, followed by washing with 3×10 ml of ether.

Yield in 2 stages: 62%

¹H NMR (200 MHz, D₂O): 2.49-2.52 (m, 2H); 3.18 (s, 9H); 3.43-3.49 (m, 2H); 4.19 (s, 2H); 4.31 (t, 2H, J=6.9 Hz); 7.18-7.67 (m, 8H); 7.82 (m, 2H)

¹³C AMR (50 MHz, D₂O): 23.89; 54.03; 55.14 (t, J_{C-N}=4.0 Hz): 61.98; 65.74; 127.98; 128.33; 128.94; 129.19; 130.67; 130.93; 140.03; 167.68; 177.38

V) Bifunctional Onium Salts:

1/Synthesis of the salts 12:

| 12 | 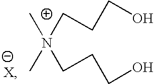 |
|---|---|
| 12a | X = Cl |
| 12b | X = NTf₂ |

12a

30 ml of acetonitrile is mixed with a 45% solution of 4.5 g of dimethylamine (0.1 mole) in water. 17 g of K₂CO₃, 150 mg of NaI and 25 ml (0.3 mol) of chloropropanol are added. The reaction mixture is heated to 70° C. overnight. After evaporation of the acetonitrile the salt is extracted with 3×10 ml of methanol and it is then crystallized from acetone.

White solid Yield=87% Mp=112-114° C.

¹H NMR (200 MHz, D₂O): 1.7-1.85 (m, 4H); 2.85 (s, 6H); 3.05-3.2 (m, 4H); 3.4 (t, 4H, J=6.1 Hz)

¹³C NMR (50 MHz, D₂O): 25.25; 51.10 (t, J_{C-N}=4.1 Hz); 58.94; 62.01 (t, J_{C-N}=4.0 Hz)

Mass spectrometry (FAB) for C₁₆H₄₀N₂O₄Cl

Theoretical mass calculated for (2C⁺, Cl⁻) 359.2677

Mass found 359.2675

12b:

A solution of 5.0 g (25.30 mmol) of 12a in 10 ml of distilled water is introduced into a 100 ml flask. A solution of 10 g (32.89 mmol) of LiNTf₂ in water is added to this solution.

After stirring for 2 hours at ambient temperature the water is evaporated and the product is extracted with 3×10 ml of acetone.

Colourless oil Yield=90%

¹H NMR (200 MHz, D₂O): 1.82-2.05 (m, 4H); 3 (s, 6H); 3.25-3.40 (m, 4H); 3.46(t, 4H, J=6.9 Hz)

¹³C NMR (50MHz, D₂O): 25.34; 51.09; 58.53; 62.13; 121.05 (q, J=321.2 Hz)

2/Diester Synthesis 13:

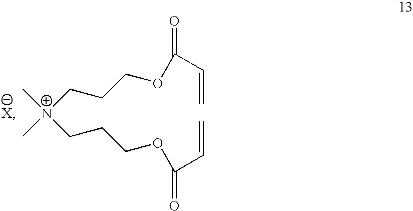

X=NTf₂

A solution of 2.7 g (6.02 mmol) of 12b and 6 equivalents of acryloyl chloride in acetonitrile is heated to 80° C. in the presence of 10 equivalents of solid K₂CO₃ for 2 hours. The mixture is then placed under vacuum at 40° C. in order to eliminate the solvent and the excess of the reagent. The ammonium acrylate thus obtained by dichloromethane extraction is stable at 4° C. and can be stored for several months.

Pale yellow oil Yield=87%

¹H NMR (200 MHz, Acetone D₆): 2.3-2.5 (m, 4H); 3.42 (s, 6H); 3.72-3.82 (m, 4H); 4.32 (t, 2H, J=5.8 Hz); 5.95 (dd, 2H, J₁=1.8; J₂=10.1); 6.18 (dd, 2H, J₁=10.1 Hz; J₂=17.1 Hz); 6.4 (dd, 2H, J₁=2.1 Hz; J₂=17.1 Hz)

¹³C NMR (50 MHz, Acetone D₆): 22.52; 51.14; 61.89; 61.95; 121.05 (q, J=321.2 Hz); 128.78; 131.02; 165.81

Mass spectrometry (FAB) for C₁₄H₂₄O₄N

Theoretical mass calculated for (C⁺) 270.1750

Mass found 270.1703

2/Diester synthesis 14:

| 14 | 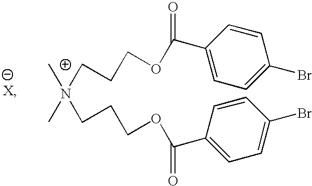 |
|---|---|
| 14a | X = Cl |
| 14b | X = BF₄ |

14a:

1 g (5.06 mmol) of 12a chloride, 10 ml of acetonitrile, 4.3 g of K₂CO₃ in powder form and 4.2 g (19.14 mmol) of 4-bromobenzoic acid chloride are introduced into a 100 ml flask. After stirring overnight at ambient temperature, the K₂CO₃ is filtered and washed with 3 times 15 ml of methylene chloride and finally evaporated to dryness. This is taken up in water and the excess of the 4-bromobenzoic acid, which crystallizes by filtration, is eliminated. The product is then crystallized from acetone after evaporation of the water.

White solid Yield=60% Mp=112-114° C.

¹H NMR (200 MHz, MeOH-d₄): 2.05-2.25 (m, 4H); 3.1 (s, 6H); 3.35-3.53 (m, 4H); 4.21 (t, 4H, J=5.8 Hz); 7.1 (d, 4H, J=8.6 Hz); 7.35 (d, 4H, J₁=8.6 Hz).

¹³C NMR (50 MHz, MeOH-d₄): 23.87; 52.50; 62.50; 63.64; 130.08; 130.16; 132.78; 133.63; 168.22

Mass spectrometry (FAB) for C₂₂H₂₆NO₄Br₂

Theoretical mass calculated for (C⁺) 526.0229

Mass found 526.0221

14b:

0.2 ml of 40% HBF₄ in solution in water is added to a solution of 100 mg (0.18 mmol) of 14a in 5 ml of water. After the former has been added, formation of a white solid is noted. The reaction mixture is stirred for two hours at ambient temperature. The white solid obtained after filtration is washed with water (in order to eliminate the excess of HBF₄) then twice with 30 ml of ether and finally dried under vacuum.

White solid Yield=80% Mp=172-174° C.

¹H NMR (200 MHz, Acetone D₆): 2.4-2.57 (m, 4H); 3.4 (s, 6H); 3.8-3.94 (m, 4H); 4.45 (t, 4H, J=5.8 Hz); 7.67 (d, 4H, J=8.6 Hz); 7.95 (d, 4H, J₁=8.6 Hz)

¹³C NMR (50 MHz, Acetone D₆): 23.55; 51.99 (t, J=4.1 Hz); 62.81; 63.12; 128.92; 130.41; 132.65; 133.14; 166.36

Mass spectrometry (FAB) for C₂₂H₂₆NO₄Br₂

Theoretical mass calculated for (C⁺) 526.0229

Mass found 526.0216

VI) Tri- and Tetrafunctional Onium Salts Having Identical Functions:

1/Trifunctional salts 15:

| 15 | 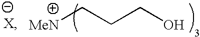 |
|---|---|
| 15a | X = Cl |
| 15b | X = NTf₂ |

15a:

3 ml (87.15 mmol) of methylamine, 20 ml of acetonitrile, 12 g of K₂CO₃, 53 mg of NaI and 12 ml of 3-chloropropanol are introduced into a Schlenk tube. The reaction mixture is heated to 80° C. for 48 hours. After evaporation of the solvent the salt is extracted with 3×10 ml of methanol. It is then crystallized from acetone after evaporation of the solvent.

White solid Yield=75% Mp>260° C.

¹H NMR (200 MHz, D₂O): 1.8-2.03 (m, 6H); 3.1 (s, 3H); 3.25-3.4 (m, 6H); 3.4 (t, 6H, J=5.8 Hz)

¹³C NMR (50 MHz, D₂O): 24.89; 48.6; 58.47; 59.60

15b:

A solution of 0.4 g (1.65 mmol) of 15a in 1 ml of distilled water is introduced into a 100 ml flask. A solution of 0.7 g (2.14 mmol) of LiNTf₂ in water is added to this solution. After stirring at ambient temperature for 2 hours, the water is evaporated and extracted 14b with 3×10 ml of acetone. After evaporation of the solvent and drying under vacuum, 0.64 g of a colourless oil is obtained, i.e. a yield of 80%.

¹H NMR (200 MHz, MeOH-d₄): 1.92-2.01 (m, 6H); 3.1 (s, 3H); 3.38-3.52 (m, 6H); 3.7 (t, 6H, J=5.5 Hz)

¹³C NMR (50 MHz, MeOH-d₆): 25.25; 29.92; 58.35; 59.80; 121.05 (q, J=321.2 Hz)

2/ Tetrafunctional salts 16:

| 16 | 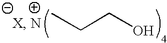 |
|---|---|
| 16a | X = Cl |
| 16b | X = NTf₂ |

16a:

1 g (5.23 mmol) of propanolamine and 2 ml (23.90 mmol) of 3-chloro-1-propanol are introduced into a 100 ml flask. After heating the reaction mixture overnight at 150° C., the excess of chloropropanol is eliminated by washing with ether (3×10 ml). The product is thus isolated by filtration after crystallization from acetone.

White solid Yield=58%

¹H NMR (200 MHz, D₂O): 2-2.2 (m, 8H); 3.4-3.6 (m, 8H); 3.8(t, 8H, J=5.7 Hz)

¹³C NMR (50 MHz, D₂O): 24.49; 56.56; 58.40

16b:

A solution of 1 g (3.5 mmol) of 16a in 5 ml of distilled water is introduced into a 100 ml flask. A solution of 2 g (4.55 mmol) of LiNTf₂ in water is added to this solution. After stirring at ambient temperature for 2 hours the water is evaporated and 15b is extracted with 3×5 ml of methanol. After evaporation of the solvent and drying under vacuum, a colourless oil is obtained.

Colourless oil Yield=85%,

NMR ¹H (200 MHz, D₂O): 1.7-1.93 (m, 8H); 3.15-3.30 (m, 8H); 3.58 (t, 8H, J=5.8 Hz)

NMR ¹³C (50 MHz, D₂O): 24.56; 56.67; 58.38; 121.05 (q, J=321.2 Hz)

VII) Synthesis of the Multifunctional Onium Salts Having Different Functions:

1/ Preparation of the precursor tertiary amines 17:

| 17 | 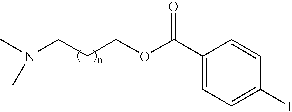 |
|---|---|
| 17a | n = 1 |
| 17b | n = 2 |

17a:

1 g (9.7 mmol) of 1-dimethylamino-3-propanol, 10 ml of anhydrous methylene chloride, 3 g of K₂CO₃ and 2.84 (10.66 mmol) of chloride derived from 4-iodobenzoic acid are introduced into a 100 ml flask. After stirring at ambient temperature for 3 hours the reaction is complete. The reaction mixture is then filtered and evaporated to dryness. A white solid is obtained with a yield of 90% (Mp=48-50° C.).

¹H NMR (200 MHz, CDCl₃): 1.87-2.03 (m, 2H); 2.3(s, 6H); 2.45 (t, 2H, J=7.0 Hz); 4 (t, 2H, J=6.5 Hz); 7.3-7.5 (m, 4H)

¹³C NMR (50 MHz CDCl₃): 27.36; 45.85; 56.58; 63.96; 101.15; 130.17; 131.37; 138.04; 166.34

17b:

2.8 g (23.93 mmol) of 1-N,N′-dimethylamino-4-butanol, 10 ml of anhydrous methylene chloride, 6.6 g of K₂CO₃ and 7.0 g (26.27 mmol) of acid chloride are introduced into a 100 ml flask. The reaction is exothermic. After stirring at ambient temperature for 3 hours the reaction is complete. The reaction mixture is then filtered and evaporated to dryness in order to produce a white solid, with a yield of 88%.

¹H NMR (200 MHz, CDCl₃): 1.78-1.9 (m, 4H); 2.5(s, 6H); 2.65 (t, 2H, J=5.3 Hz); 4.35 (t, 2H, J=6.0 Hz); 7.7-7.85 (m, 4H)

¹³C NMR (50 MHz CDCl₃): 20.25; 24.86; 43.51; 57.34; 63.47; 98.97; 128.39; 129.39; 136.16; 164.26

2/ Synthesis of the salts 18:

| 18 | 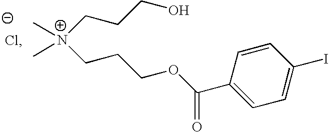 |
|---|---|
| 18a | X = Cl |
| 18b | X = NTf₂ |

18a:

1.0 g (3 mmol) of 17a and 0.5 ml of 3-chloro-1-propanol are introduced into a 50 ml flask. After 30 minutes of heating of the reaction mixture at 110° C., the formation of a white solid is observed. The latter is isolated by filtration after crystallization from acetone and washing with 3×10 ml of ether.

White solid Yield=94% Mp=180-182° C.

¹H NMR (200 MHz, D₂O): 1.8-2 (m, 2H); 2.10-2.30(m, 2H); 3.05 (s, 6H); 3.25-3.45(m, 4H); 3.6 (t, 1H, J=0.7 Hz); 4.35(t, 2H, J=0.7 Hz); 7.85 (d, 2H, J=8.1 Hz); 8 (d, 2H, J=8.1 Hz)
¹³C NMR (50 MHz, D₂O): 22.18; 25.29; 51.27 (t, J=4.3 Hz); 58.42; 62.00; 101.85; 199.94; 131.13; 138.26; 165.49

Mass spectrometry (FAB) for C₁₅H₂₃NO₃I

Theoretical mass calculated for (C⁺) 392.0723

Mass found 392.0720

18b:

A solution of 1.0 g (2.34 mmol) of 18a in 5 ml of distilled water is introduced into a 100 ml flask. A solution of 3.04 mmol of LiNTf₂ in water is added to this solution. After stirring at ambient temperature for 2 hours 18b is extracted with 3×5 ml of methylene chloride which is then driven off under vacuum in order to produce a white solid.

White solid Yield=91% Mp=90-92° C.

¹H NMR (200 MHz, Acetone D₆): 2.12-2.63 (m, 2H); 2.45-2.63(m, 2H) 3.4 (s, 6H); 3.7-3.93 (m, 6H); 4.1 (t, 1H, J=0.3 Hz), 4.55 (t, 2H, J=0.7 Hz); 7.85 (d, 2H, J=8.1 Hz); 8 (d, 2H, J=8.1 Hz)

¹³C NMR (50 MHz, Acetone D₆): 22.62; 26.03; 51.16 (t, J=4.3 Hz); 58.56; 62.21; 100.96; 121.01 (q; J_{CF3}=321.0 Hz); 129.94; 131.51; 138.33; 165.79.

Mass spectrometry (FAB) for C₃₂H₄₆N₃O₁₀F₆I₂S₂

Theoretical mass calculated for (2C⁺, NTf2⁻) 1064.0618

Mass found 1064.0607

3/ Synthesis of the salts with different functionalities 19:

| 19 | 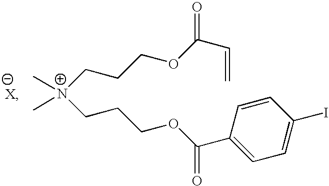 |
|---|---|
| 19a | X = Cl |
| 19b | X = NTf₂ |

A solution of 1 mmol of 18a or 18b and 3 equivalents of acryloyl chloride in acetonitrile is heated at 80° C. in the presence of 5 equivalents of solid K₂CO₃ for 2 hours. The mixture is then filtered and evaporated under vacuum at 40° C. The ammonium ester is then extracted with methylene chloride and stored at 4° C. after evaporation of the solvent.

19a: White solid Yield=75%.

¹H NMR (200 MHz, D₂O): 2.05-2.32 (m, 4H); 3.1 (s, 6H); 3.35-3.55 (m, 2H); 4.18 (t, 2H, J=5.5 Hz); 4.35 (t, 2H, J=5.8 Hz) 5.90 (dd, 1H, J₁=1.9 Hz; J₂=10.7); 6.05 (dd, 1H, J=17.2 Hz; J₂=10.7 Hz); 6.3 (dd, 1H, J₁=1.9 Hz; J₂=17.2 Hz); 7.62 (d, 2H, J=8.6 Hz); 7.82 (d, 2H, J=7.8 Hz)

¹³C NMR (50 MHz, D₂O): 22.09; 22.86; 51.39 (t, J=4.2 Hz); 62.13; 62.65; 63.03; 63.35; 101.78; 127.53; 128.92; 131.13; 133.05; 139.63; 168.07; 168.45

Mass spectrometry (FAB) for C₁₈H₂₅NO₄I

Theoretical mass calculated for (C⁺) 426.0828

Mass found 446.0821

19b:

A solution of 1.0 g (1.80 mmol) of 19a in 5 ml of distilled water is introduced into a 100 ml flask. A solution of 2 mmol of LiNTf₂ in solution in water is added to this solution. After stirring at ambient temperature for 2 hours 19b is extracted with 3×5 ml of methylene chloride. After elimination of the solvent under vacuum, a colourless oil is obtained. Yield=78%

¹H NMR (200 MHz, Acetone D₆): 2.31-2.65 (m, 4H); 3.5 (s, 6H); 3.75-3.93 (m, 4H); 4.32 (t, 2H, J=6.0 Hz), 4.55 (t, 2H, J=6.1 Hz); 5.95 (dd, 1H, J₁=1.9 Hz, J₂=10.3 Hz); 6.2 (dd; 1H; J₁=17.2 Hz; J₂=10.3 Hz); 6.43 (dd; 1H; J₁=1.9 Hz; J₂=17.2 Hz); 7.82 (d, 2H, J=8.1 Hz); 7.78(d, 2H, J=8.1 Hz)

¹³C NMR (50 MHz, Acetone D₆): 23.49; 23.54; 52.12 (t, J=4.31 Hz); 62.16; 62.89; 100.84; 121.09 (q, J_{CF3}=321 Hz); 124.56; 129.38; 130.82; 132.22; 132.38; 139.23; 166.66.

34i:

4 eq of phenylacetylene and 5 molar % CuI are added to a solution of 1 g (1.55 mmol) of 6b in 10 ml of the CH₃CN/NEt₃ mixture (2/1). The reaction mixture is stirred for 5 minutes at ambient temperature before adding 2.5% PdCl₂ (PPh₃)₂.

After 15 minutes of stirring at ambient temperature, the reaction mixture is evaporated to dryness and washed with ether in order to eliminate the excess of reagents. The oil thus obtained is dissolved in methylene chloride and then washed with a diluted solution of K₂CO₃ in water to release Et₃N from its hydrochloride formed during the reaction. After treatment with Na₂SO₄ and evaporation of the methylene chloride, the product is isolated by filtration after cystallization from ether and drying under vacuum.

Appearance of the product: white solid Yield=87% Mp=228-230° C.

¹H NMR (CD3CN, 300 Mhz): 1.72-1.93 (m, 4H); 3.05 (s, 9H); 3.23-3.40 (m, 2H); 4.38 (t, J=6.1 Hz, 2H); 7.38-7.45 (m, 3H); 7.55-7.64 (m, 2H); 7.70 (dd, J=8.5 Hz, 2H); 8.10 (dd, J=8.5 Hz, 2H).

¹³C NMR (CD3CAT, 75 Mhz): 19.17; 24.70; 52.61 (t, J=3.8 Hz); 63.86; 65.65 (t, J=3.0 Hz); 87.93; 91.93; 124.63 (q, J_{CF}=412 Hz); 128.42; 128.85; 129.24; 129.44; 131.20; 131.24; 165.63.

Mass spectrometry (APCI) for [C₂₂H₂₆NO₂][C₂NS₂O₄F₆]:

Theoretical mass calculated for (C⁺) 336.4

Mass found 336.0

### Uses in Synthesis—General Protocol of the Different Reactions

1/Diels-Alder Reaction:

a—For Cyclopentadiene:

A solution of the supported acrylic ester (from mono to tetra-functionalized) and 10 equivalents of cyclopentadiene in 2 ml of methylene chloride is stirred for two hours at ambient temperature. The excess of the reagent and the solvent are then eliminated under vacuum. The reaction product thus obtained is placed in solution in methanol in the presence of three drops of hydrochloric acid 12 N. After twelve hours at reflux, the transesterification is complete and the product is then extracted with pentane after evaporation of the alcohol under vacuum. The pentane is then eliminated under vacuum in order to produce pure methyl esters.

b—For the Various Other Dienes:

0.01 eq of hydroquinone and 5 eq of dienes are added to a solution of 5a in acetonitrile. The reaction mixture is heated to 120° C. in sealed tubes, evaporated to dryness then washed with ether. The reaction product thus obtained is placed in solution in methanol in the presence of a catalytic quantity of 12 N hydrochloric acid. After twelve hours at reflux, the product is then extracted with ether after evaporation of the alcohol under vacuum. The ether is then eliminated under vacuum in order to produce the pure methyl esters.

2/Heck Reaction:

a—With Supported Acrylic Ester 5:

1.5 mmol of supported substrate are dissolved in 2 ml of solvent. 5 equivalents of aryl halide, 1 equivalent of K₂CO₃ as base and 1 molar % palladium acetate are added to this solution. At the end of the reaction the solvent and the excess of the reagent are eliminated by washing with ether then methanol (2 ml) and 12 N hydrochloric acid (3 drops) are added and the solution is taken to reflux.

After 12 hours, the coupling product is extracted with ether after evaporation of the alcohol. The ether solution is then evaporated to dryness leading to the expected product.

b—With Supported Iodoaryl Ester 6g:

0.5 mmol of supported substrate X is dissolved in 1 ml of DMF. 5 eq of olefin (tertiobutyl acrylate, dimethylacrylamide or styrene), 1.5 eq of K₂CO₃ as base and 1 to 5 molar % palladium acetate are added to this solution. At the end of the reaction, the solvent and the excess of the reagent are eliminated by washing with ether then methanol (2 ml) and 12 N hydrochloric acid (3 drops) are added and the solution is taken to reflux.

After 12 hours, the coupling product is extracted with ether after evaporation of the alcohol and neutralization of the medium by the addition of a diluted solution of K₂CO₃ in water. The ether solution is then evaporated to dryness.

c—With Supported Styrene 7e:

1 ml of NEt₃ (3 eq), 27 mg of Pd(OAc)₂ (0.05 eq) and 0.125 eq of each iodide used are added to a solution of 800 mg (2.38 mmol) of 7e in 3 ml of DMF. After heating at 110° C. for two hours, the oil thus obtained after the addition of the ether is transesterified in the presence of methanol and a few drops of hydrochloric acid.

3/Suzuki Coupling Reaction:

General Procedure for the Mono and Bifunctionalized Salts:

0.95 equivalents of boronic acid (per function), 2 equivalents of K₂CO₃ and 1 molar % palladium acetate are added to a solution of 100 mg of supported aryl halide in 1 ml of DMF. The reaction mixture is heated for 5 hours at 80° C. After which, an alcohol is added and the mixture is taken to reflux for 12 hours, in the presence of 0.1 ml of concentrated hydrochloric acid (12 N). After transesterification and evaporation of the alcohol, the ester formed is extracted from the medium by washing with ether (3×10 ml).

4/Sonogashira Coupling Reaction:

a—For Supported Iodoaryl Ester:

4 equivalents of alkyne, 1 equivalent of K₂CO₃ and a mixture (1/2 catalyst/CuI) are added to a solution of 100 mg of supported aryl halide in 1 ml of solvent. The reaction mixture is heated for 1 hour at 40° C., after which an alcohol is added and the mixture is taken to reflux for 12 hours, in the presence of 0.1 ml of concentrated hydrochloric acid (12 N). After transesterification and evaporation of the alcohol, the ester formed is extracted from the medium by washing with ether (3×10 ml) and isolated after evaporation of the ether.

b—For the Supported Alkyne:

4 eq of aryl iodide and 0.2 eq of CuI are added to a solution of 100 mg of supported alkyne 8 in 1 ml of the CH₃CN/NEt₃ mixture (2/1). The reaction mixture is stirred for 5 minutes before addition of 0.1 eq of PdCl₂(PPh₃)₂. After reaction, the alcohols formed are extracted with ether after evaporation of the solvent and elimination of the excess of the reagents followed by a saponification reaction in the presence of 5 ml of NaOH(2N).

5/Alkylation of the Supported Schiff's Base:

The halogenated derivative RX (4 mmol) is added at ambient temperature to a mixture of the supported Schiff's base 11 (1 g; 2.6 mmol) and 2 equivalents of K₂CO₃ in acetonitrile (2 ml). The mixture is then taken to reflux under vigorous stirring. After 12 hours, the reaction medium is filtered then evaporated to dryness.

The transesterification and the hydrolysis of the imine are carried out at reflux of the methanol in the presence of concentrated hydrochloric acid for 12 hours. After evaporation of the solvent the mixture is dissolved in 1 ml of water. The free amino acid is extracted with methanylene chloride after neutralization of the medium.

6/Multi-Component Reaction of the Grieco Type:

100 mg of supported amine 34, 500 μl of a 1 M solution of aldehyde in acetonitrile, 500 μl of a 1 M solution of cyclopentadiene in acetonitrile and 50 μl of a 1% TFA solution in acetonitrile are mixed under a flow of argon. The reaction mixture is stirred overnight at ambient temperature. After evaporation to dryness and washing with ether, a solid is obtained.

7/Synthesis of the Tetrasubstituted Olefins:

2 eq of iodide, 3 eq of boronic acid and 1.2 mg of PdCl₂(PPh₃)₂ (0.01 eq) are added to a solution of 100 mg (0.16 mmol) of 34i in 0.5 ml of the DMF/H₂O mixture. After heating at 100° C. for three hours, the orange oil obtained after addition of ether is dissolved in 10 ml of methylene chloride and washed with 2×3 ml of H₂O. After treatment of the aqueous phase with MgSO₄ and evaporation to dryness, the tetrasubstituted olefins are isolated by filtration after crystallization from ether.

### EXAMPLES

In order to show the advantage of the ammonium salts as novel soluble supports, the reagents 5, 6, 7 and 11 allowing the use of several types of fundamental reactions in organic chemistry were chosen:
acryl esters 5 were used in cycloaddition and coupling reactions 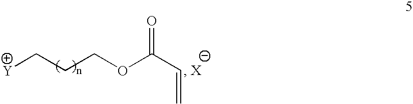
an aryl ester substituted by an R (Br, I, or CH2═CH) on the aromatic ring which was tested in three examples of coupling reactions. 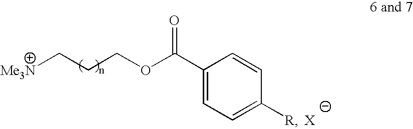
an aryl ester substituted by an R═NH₂ on the aromatic ring which was tested in the Grieco reaction. 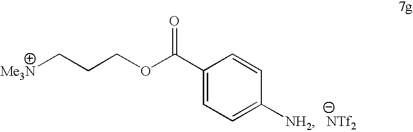
the Schiff's base derived from glycine which, after alkylation, will lead to higher amino acids 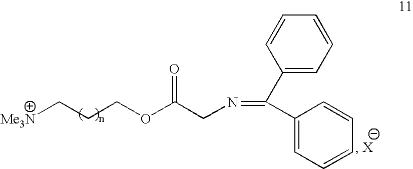
an aryl ester substituted by an R═PhC≡CH on the aromatic ring which was tested in the synthesis of the tetrasubstituted olefins.

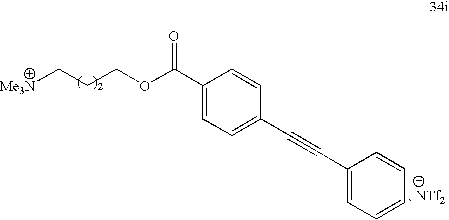

In order to increase the specific charge of the onium salts, the present inventors have also developed novel onium salts having more than one functionalized arm.

The synthesis of supports and supported reagents as well as their applications in a few examples is described in detail in the following experimental part.

### A—Example 1

### Diels-Alder Reaction

1) Reaction with Cyclopentadiene.

The richness and the synthetic potential of the Diels-Alder reaction have led chemists to research methods on the one hand allowing an increase of their speed and yield and on the other hand of their regio- and stereoselectivity. This reaction is the first example chosen to show the effectiveness of the synthesis supported on onium salts.

The Diels-Alder reaction between a dienophile supported on an onium salt 5 and cyclopentadiene in methylene chloride as solvent was therefore studied according to the following diagram: 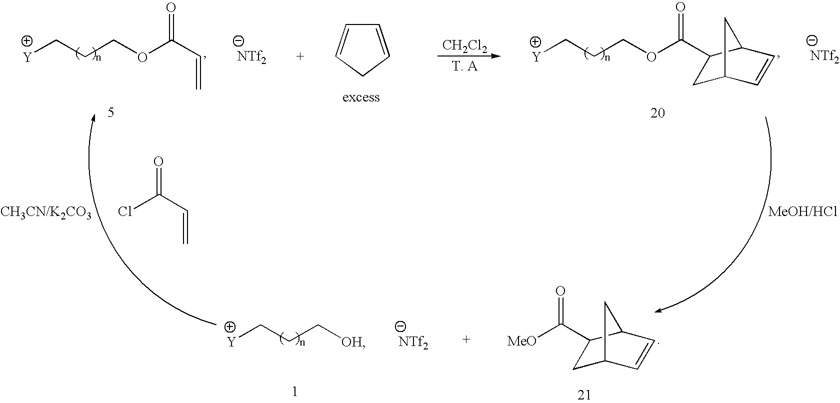
In this part of the work the inventors studied in a precise manner the influence of:

1) the length of carbon chain which separates the acryloyl function from the ammonium function

2) the nature of the cation and the anion on the reactivity

3) the recycling of the support

Procedure for the Diels-Alder Reaction:

The supported acrylate 5 and 10 equivalents of cyclopentadiene are dissolved in 2 ml of methylene chloride. The solution is then stirred for two hours at ambient temperature. The solvent and the excess of reagent are then eliminated under vacuum then the reaction product is dissolved in methanol in the presence of a few drops of 12 N hydrochloric acid. After twelve hours at reflux, the transesterification is complete and the product 21 is then extracted with pentane.

The results obtained are shown in Table 1:

TABLE 1
Influence of the length of the arm (n) and the nature of the onium
cation on the reactivity of acrylic ester

| test | Y | n | conv (%) |
|---|---|---|---|
| 1 | Me₃N | 0 | 85 |
| 2 | Me₃N | 1 | 78 |
| 3 | Me₃N | 4 | 41 |
| 4 | 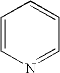 | 1 | 62 |
| 5 | P(Bu)₃ | 1 | 48 |

The results in the table show that the length of the alkyl chain of the graft arm influences the reactivity of the acrylic ester. Increasing the length of the alkyl chain separating the two ammonium and ester functions reduces the reaction rate. This suggests that an activation of acryloyl due to the electrophilic effect of the trimethylammonium function reduces the electrons of the acrylic double bond and makes it more reactive (compare with tests 1, 2 and 3). Similarly, the nature of the cation influences the reactivity (compare with tests 2, 4 and 5). It must also be noted that the endo/exo selectivity is the same whatever the nature and the composition of the support.

Finally, the possibility of recycling the support was tested in the case of the ammonium salts. The results obtained are shown in Table 2.

TABLE 2
Recycling of the support 5

| test | Yield of ester 21 (2 stages) |
|---|---|
| 1^{st} reaction | 78 |
| 1^{st} recycling | 75 |
| 2^{nd} recycling | 77 |
| 3^{rd} recycling | 81 |

During the recycling operations, a stability in the reactivity, the selectivity and the yield of the reactions was found.

2) Reaction of 5a with Various Other Dienes:

Acrylic acid 5a was used as dienophile in the Diels-Alder reaction with different dienes. For this, a solution of 0.85 mol/l of 5a in acetonitrile is heated at 120° C. in sealed tubes in the presence of 0.01% hydroquinone according to the diagram above. After reaction, the reaction mixture is evaporated to dryness then washed with ether. This allowed the isolation of the cycloadducts 22aa-ad with good yields (Table 3).

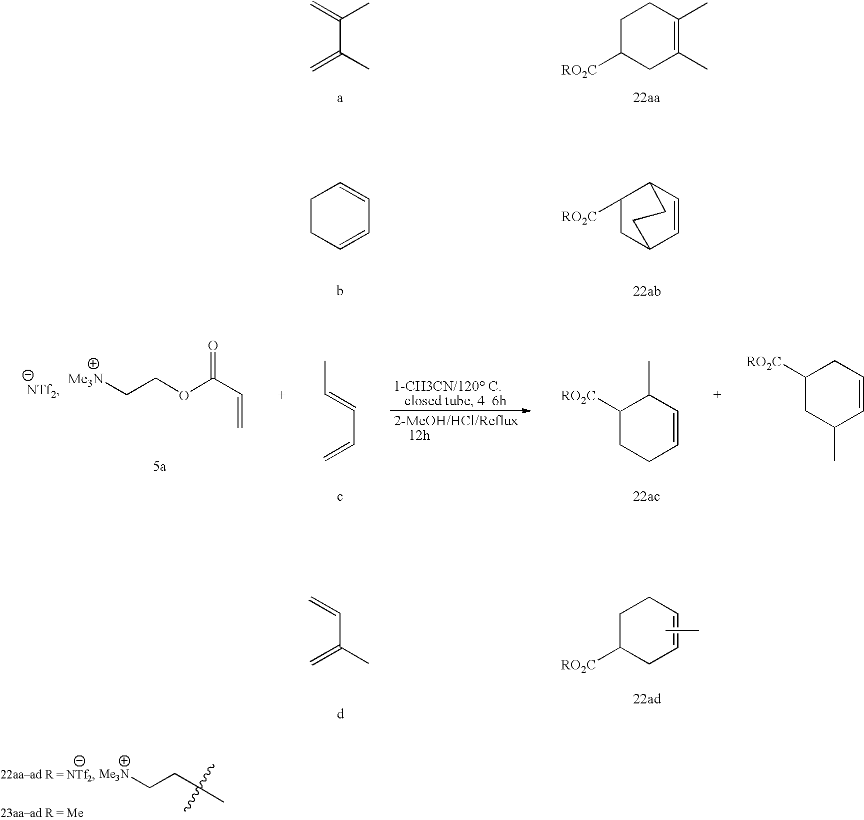

TABLE 3
Yield of cycloadducts 22aa-ad.

| Test | Dienes | Time (h) | Yield (%) |
|---|---|---|---|
| 1 | 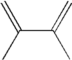 | 4 | 90 |
| 2 | 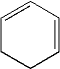 | 6 | 85 |
| 3 | 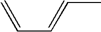 | 4 | 80 |
| 4 | 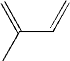 | 4 | 88 |

Methyl esters 23aa-ad are obtained by a transesterification reaction of the cycloadducts 22aa-ad after 12 hours at reflux of methanol in the presence of a catalytic quantity of hydrochloric acid. Table 4 shows the yields of isolated 23aa-ad.

TABLE 4
Yield of cycloadducts 23aa-ad.

| 23a | Dienes | Yield (%) |
|---|---|---|
| 23aa | 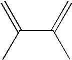 | 85 |
| 23ab | 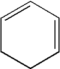 | 83 |
| 23ac | 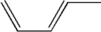 | 73 |
| 23ad | 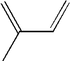 | 79 |

### B—Example 2

### Coupling Reactions

The formation of carbon-carbon bonds is a fundamental operation in organic chemistry. Among the many possible reactions, the catalytic methods using organometallic catalysts are extremely important. For our part, we have tested these novel supports in coupling reactions which were already the subject of numerous works on soluble resins and polymers (Franzen, 2000; Bertineina et al., 1998; Wendeborn et al., 1998).

The different coupling reactions studied are as follows:

1) Heck coupling

2) Suzuki coupling

3) Sonogashira coupling

In the different examples which follow, we supported acrylic esters, or arylic esters or also the two reagents:

1) Heck Coupling:

→With a Supported Acrylic Ester

In this example a supported acrylic ester is used in the Heck reaction in the presence of palladium acetate as catalyst, potassium bicarbonate as base and an aryl iodide in a large excess as reagent according to the following diagram:

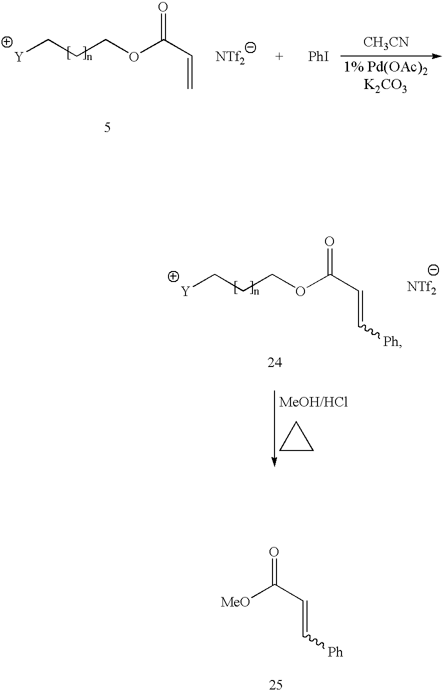

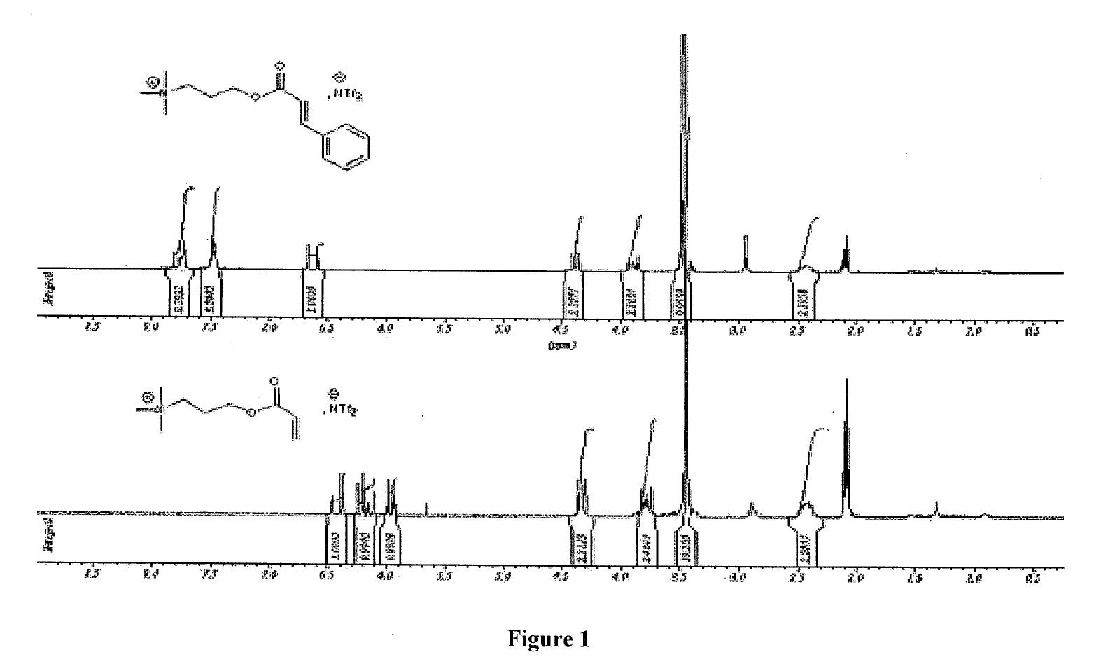

All the coupling reactions were carried out at 100° C. The reactions were monitored with proton NMR (FIG. 1) (test 3 of Table 5).

FIG. 1 illustrates the possibility of the monitoring of the reactions with ¹H NMR and its simplicity. The complete disappearance of the signals between 5.9 and 6.5 ppm corresponding to the three protons of the double bond of the substrate 5d, and the appearance of the signals of the double bond of the coupling product 24 are seen clearly.

The different parameters which influence this reaction were then studied to create the optimal conditions. The results obtained are shown in Table 5:

TABLE 5
Influence of the nature of the cation, the support and the spacer arm
on the Heck coupling reaction

| | | | Time | Concentration | Conversion | Yield of 25 | |
|---|---|---|---|---|---|---|---|
| test | A | n | (h) | (mol/l) | (%)ⁱ | isolated | E/Zⁱⁱ ratio |
| 1 | 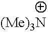 | 1 | 2 | 0.05 | 70 | — | 88/12 |
| 2 | 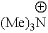 | 0 | 1 | 0.1 | 100 | 83 | >99/1 |
| 3 | 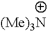 | 1 | 1 | 0.1 | 100 | 86 | >99/1 |
| 4 | 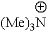 | 4 | 1 | 0.1 | 100 | 80 | >99/1 |
| 5 | 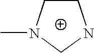 | 1 | 1 | 0.1 | 100 | 85 | >99/1 |
| 6 | 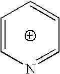 | 1 | 1 | 0.1 | 87 | 84 | >99/1 |
| 7 | 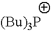 | 1 | 1 | 0.1 | 100 | 79 | >99/1 |

ⁱ: % of conversion from 5 to 24 determined by NMR.
ⁱⁱ: determined by NMR and confirmed by GC after transesterification.

Tests 1 and 2 show that the concentration of the reaction medium, besides reducing the quantity of the solvent, influences both the reactivity and the selectivity of the reaction. Thus by doubling the concentration, only the trans isomer is obtained.

A direct relationship between the reactivity and the nature of the cation of the supported substrate was noted. In the presence of the pyridinium cation, the reaction rate is reduced and only 87% of coupling product is formed under the standard conditions. However the length of the alkyl chain separating the acrylic ester and the ammonium function has no influence either on the reactivity, or on the selectivity (compare with tests 2, 3 and 4).

With Supported Iodoaryl Ester 6g

The iodoaryl ester supported on ammonium salt 6g was used in the Heck reaction.

A solution (0.85 mol/l) of the salt 6 in DMF is heated to 100° C., in the presence of palladium acetate as catalyst, potassium bicarbonate as base and a large excess of olefin. The yields of isolated products are shown in Table 6:

TABLE 6

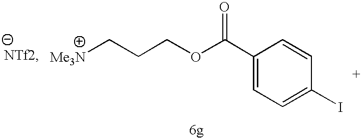

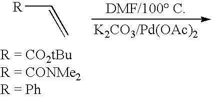

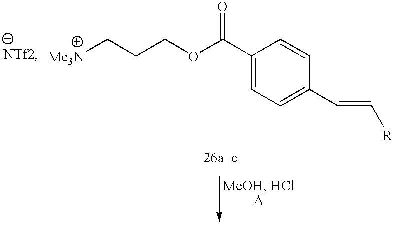

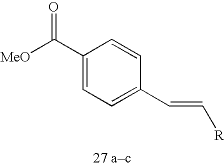

Yields of the coupling products 26

| N^{o} | R | Quantity of Pd(OAc)₂(%) | Yield(%)(Time h) |
|---|---|---|---|
| 26a | CO₂tBu | 1 | 84(1) |
| 26b | CONMe₂ | 5 | 80(3) |
| 26c | Ph | 5 | 80(3) |

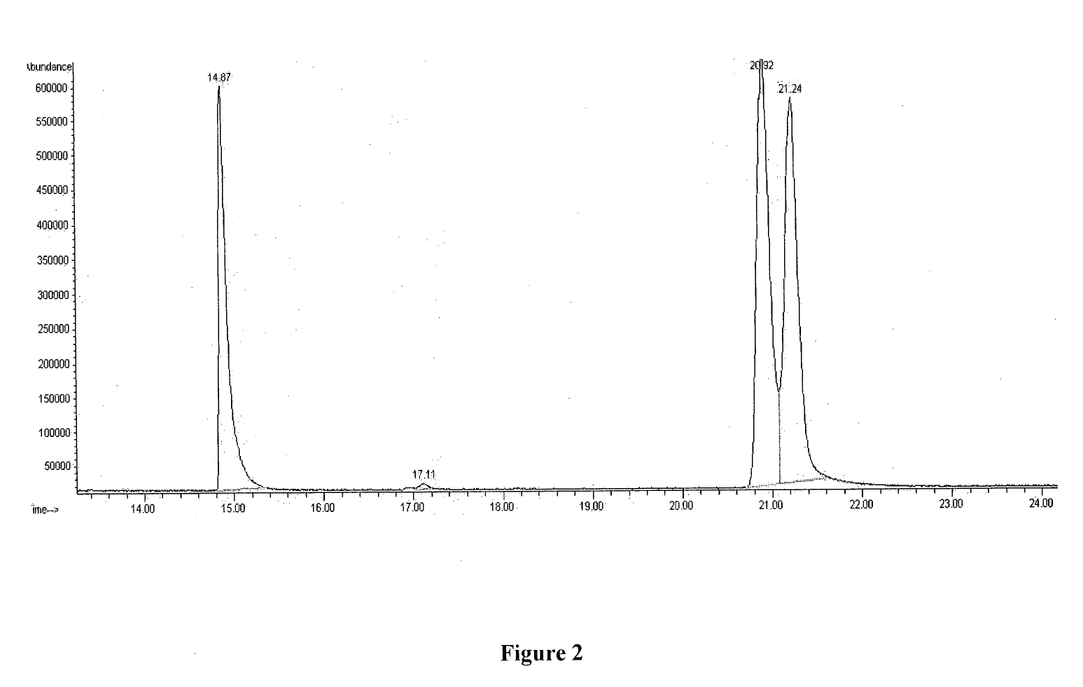

The cleavage of the coupling products is carried out by a transesterification reaction of a mixture of these three salts in the presence of methanol and a catalytic quantity of hydrochloric acid. The reaction is quantitative and the methyl esters obtained are extracted with ether after neutralization with a K₂CO₃ solution and then injected into the GC/MS. The following chromatogram shows the retention times of the different esters (FIG. 2 and Table 7).

TABLE 7
Characterization by GC/MS of the ester library 27

| No. | R | Retention time in minutes | Molecular mass |
|---|---|---|---|
| 27a | CO₂tBu | 14.87 | 220 |
| 27b | CONMe₂ | 20.92 | 233 |
| 27c | Ph | 21.24 | 238 |

With Supported Styrene 7e

In this example, the styrene 7e is reacted with an equimolecular mixture of 7 different aryl iodides thus leading, after reaction, to a small library of the 7 products 28 or 29. A solution of 0.85 mol/l of 7e in DMF, to which 3 equivalents of triethylamine, 5% palladium acetate and a mixture of the seven aryl iodides in a stoichiometric quantity, is thus introduced into the same well (diagram below).

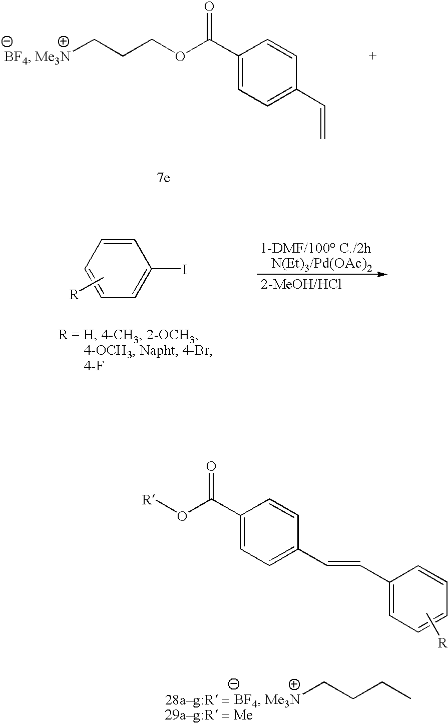

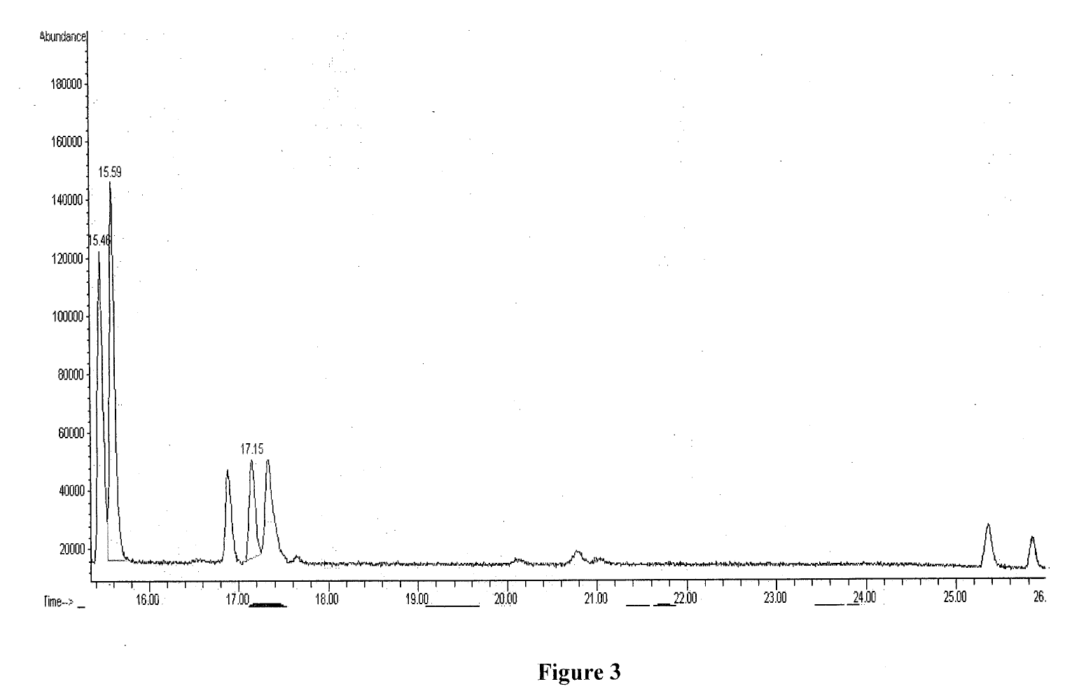

The progress of the reaction is monitored by HPLC by following the disappearance of the aryl iodides. The mixture of the salts 28a-g is then transesterified by addition of methanol and a catalytic quantity of hydrochloric acid. After evaporation of the solvent, the esters formed 29a-g are extracted with ether and injected into the GC/MS. (FIG. 3)

Table 8 shows the allocation of the esters 29 obtained.

TABLE 8
Characterization by GC/MS of the ester library.

| 29 | R | Retention time | Molecular mass |
|---|---|---|---|
| 29a | F | 15.46 | 256 |
| 29b | H | 15.59 | 238 |
| 29c | CH₃ | 16.89 and 17.15 | 252 |
| 29d and 29e | 2 and 4-MeO | 17.33 | 268 |
| | | 20.15 | |
| 29f | Br | 20.80 | 317 |
| 29g | Naphth | 25.36 and 26.00 | 290 |

2) Suzuki Coupling:

The second example of a coupling reaction where the onium supports were used is the Suzuki reaction which consists of a coupling of an aryl halide with a boronic aryl acid. This study was carried out according to two different approaches:

1) supporting an aryl halide

2) simultaneously supporting an aryl halide and a boronic acid.

Supported Aryl Halide.

In this study 3-iodobenzoic acid and 4-bromobenzoic acid supported on an onium salt were used, and DMF and dioxane were chosen to be used as solvents often used in this type of reaction on soluble resin or polymer. We therefore studied the effect of the temperature and the anion of the support.

These different studies were carried out using phenylboronic acid and palladium acetate as catalyst according to the following reaction diagram:

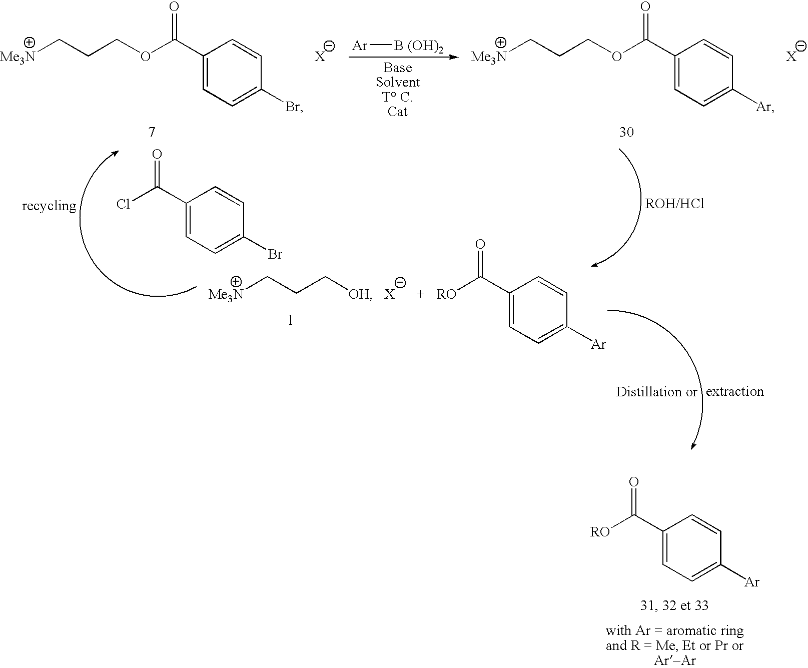

TABLE 9
Influence of the temperature and the solvent on
the Suzuki coupling reaction in the presence of
K₂CO₃ (2 equivalents) and Pd(OAc)₂ (1 molar %).

| | | | Temperature | Conversion | | |
|---|---|---|---|---|---|---|
| test | Solvent | X | (° C.) | rate | Ar—Ar′ | Ar—Ar |
| 1 | DMF | NTf₂ | 20 (18 h) | 99.1 | 98.7 | 0.4 |
| 2 | DMF | NTf₂ | 80 (5 h) | 100 | 96.4 | 3.2 |
| 3 | Dioxane | NTf₂ | 80 (5 h) | 70 | 40 | 30 |

Examination of Table 9 shows that in DMF after five hours at 80° C., the reaction is complete with an excellent selectivity. By contrast, in the case of dioxane, under the same conditions, 70% conversion was observed with 30% formation of homocoupling product (Ar—Ar). It is to be noted that the desired product is isolated after transesterification with a yield of 95% and 99.9% purity (test 2).

In light of the results obtained during this non-exhaustive study, it was chosen to work under the following conditions for the preparation of a biaryl ester library:

Solvent: DMF

Temperature: 80° C.

Base: solid K₂CO₃ for simplicity of the reaction treatment

Precatalyst: Pd(OAc)₂

For the preparation of this biaryl ester library, firstly a series of coupling reactions was carried out in parallel with 9 arylboronic acids and supported 4-bromobenzoic acid. Then, the 9 supported biaryl esters are mixed to form a homogeneous solution, which is then divided into three equal portions. After which, each of the solutions is dissolved in a different alcohol after evaporation of the DMF under vacuum. A few drops of concentrated hydrochloric acid (12 N) are then added then the mixture is taken to reflux for 18 hours. After evaporation to dryness, the biaryl ester mixture is extracted with ether. 3 series of 9 esters are therefore obtained and are analyzed by GC/MS. The different biarylesters expected are all obtained quantitatively (no trace of aryl esters corresponding to the starting product was detected by GC/MS) and identified with no ambiguity.

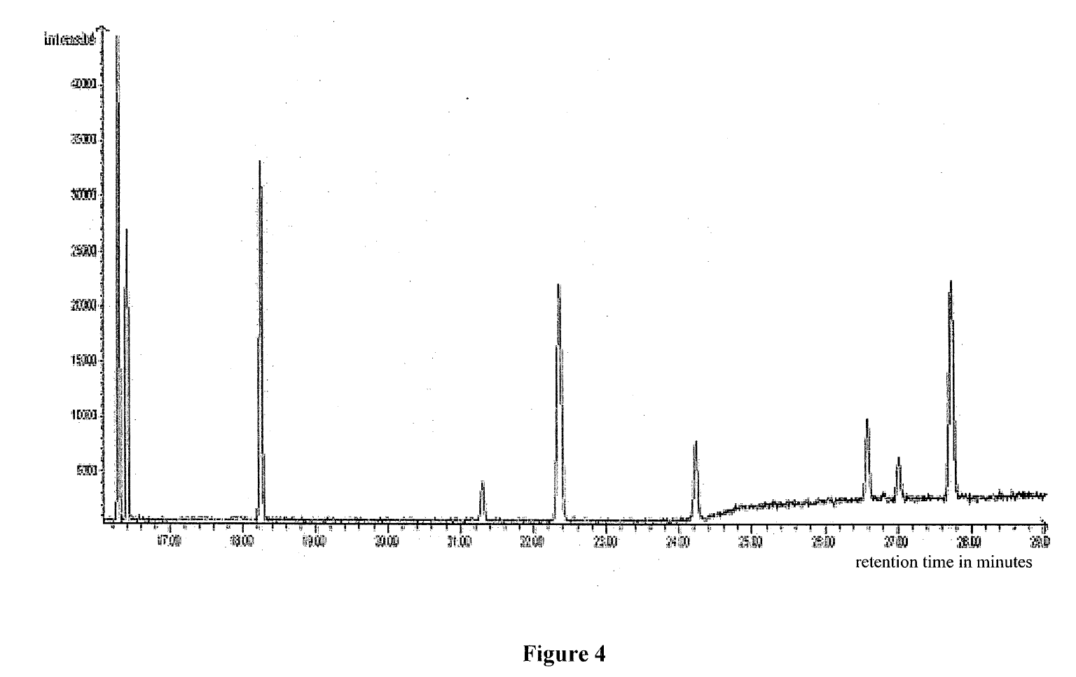

All the results are shown below in Tables 9 to 11 and the chromatograms corresponding to the biaryl ester mixtures represented in FIGS. 4 to 6.

a/Biaryl Methyl Esters 31a-i:

Table 10 below corresponds to the chromatogram of FIG. 4.

TABLE 1
GC/MS characteristics of the methyl ester library 31a-i

| 31 | Ar | Retention time | Molecular mass |
|---|---|---|---|
| 31a and 31b | 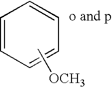 | 21.31; 22.35 | 242 |
| 31c | 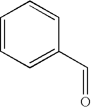 | 23.24 | 240 |
| 31d | 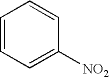 | 28.58 | 257 |
| 31e | 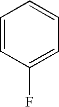 | 16.28 | 230 |
| 31f | 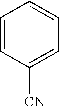 | 24.23 | 237 |
| 31g | 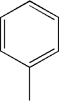 | 18.25 | 226 |
| 31h | 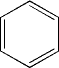 | 16.41 | 212 |
| 31i | 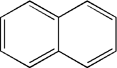 | 27.74 | 262 |

b/Biaryl Ethyl Esters 32a-i:

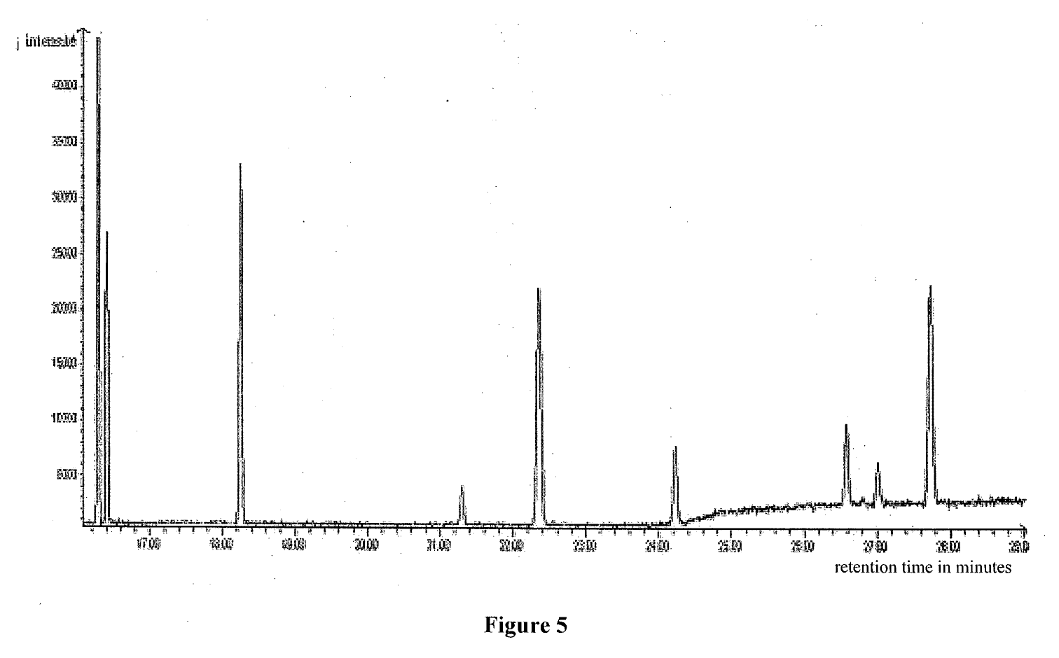

Table 11 below corresponds to the chromatogram of FIG. 5.

TABLE 11
GC/MS characteristics of the ethyl ester library 32a-i

| 32 | Ar | Retention time (mn) | Molecular mass |
|---|---|---|---|
| 32a and 32b | 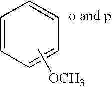 | 23.76; 24.73 | 256 |
| 32c | 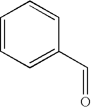 | 25.19 | 254 |
| 32d | 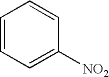 | 28.72 | 271 |
| 32e | 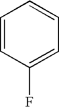 | 17.33 | 244 |
| 32f | 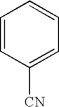 | 25.95 | 251 |
| 32g | 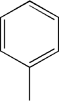 | 19.82 | 240 |
| 32h | 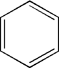 | 17.50 | 226 |
| 32i | 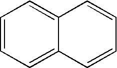 | 30.12 | 276 |

cl Biaryl Propyl Ester 33a-i

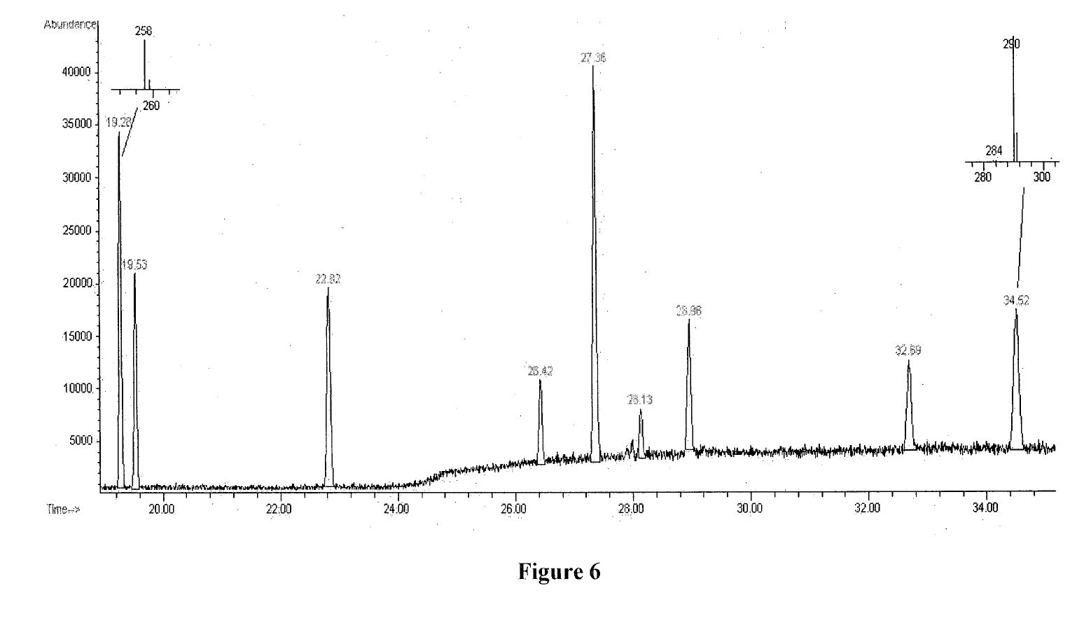

Table 12 below corresponds to the chromatogram of FIG. 6.

TABLE 12
GC/MS characteristics of the propyl ester library 33a-i

| | | Retention time | Molecular mass |
|---|---|---|---|
| 33 | Ar | in minutes | Determined by MS |
| 33a and 33b | 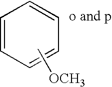 | 26.42, 27.36 | 270 |
| 33c | 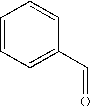 | 28.13 | 268 |
| 33d | 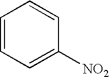 | 32.29 | 285 |
| 33e | 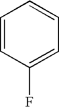 | 19.28 | 258 |
| 33f | 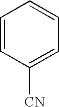 | 28.96 | 265 |
| 33g | 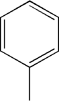 | 22.82 | 254 |
| 33h | 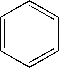 | 19.53 | 240 |
| 33i | 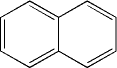 | 34.52 | 290 |

Simultaneously Supported Aryl Halide and Boronic Acid:

An arylboronic acid was grafted to an anion in order to then engage it in a releasing Suzuki coupling reaction.

Phenylboronic acid is grafted onto an onium support via the anion. If the anion X⁻ of the support salt is fairly nucleophilic, it will react with the phenylboronic acid quaternizing the boron atom in order to produce a borate. The nucleophile of choice is fluoride.

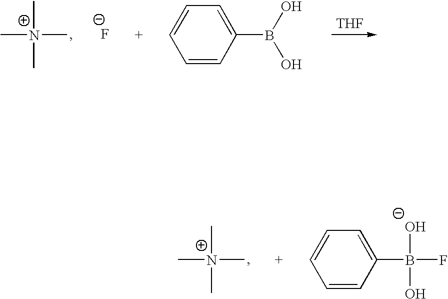

This quaternarization reaction was carried out by dissolving, at ambient temperature, tetramethylammonium fluoride in THF (anhydrous) then addition of phenylboronic acid. After stirring at ambient temperature for 18 hours, the precipitate which forms is filtered then washed with ether. The yield of isolated product is of the order of 80%. The monitoring of this reaction took place using boron and fluorine NMR.

The Suzuki coupling is carried out under the same conditions as those described in the first part, between supported 4-bromobenzoic acid and supported phenylboronic acid according to the following reaction diagram:

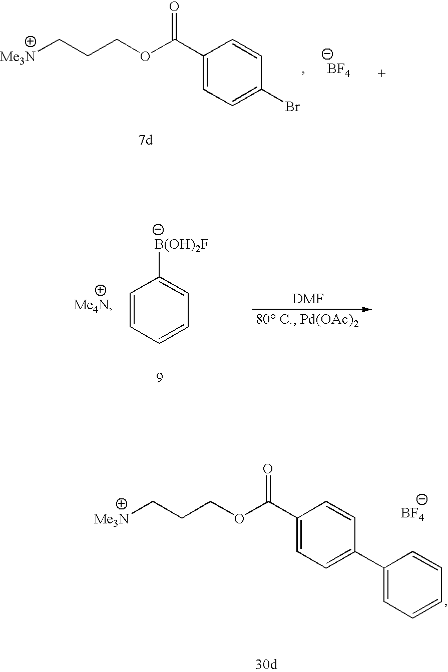

The reaction leads to the coupling product with an excellent yield (98% of pure isolated product after transesterification) and a reactivity greater than that observed in the case of phenylboronic acid. The support 1d is recovered quantitatively and can be reused.

3) Sonogashira Coupling:

Another example of coupling where this family of soluble supports was tested is that of Sonogashira which consists in a coupling of an aryl halide and a true alkyne. This study was carried out by supporting aryl halide or alkyne on an onium salt.

Supported Aryl Halide:

Firstly and in order to create the optimal conditions, the influence of the different parameters on the coupling reaction was studied. Therefore the effect of the temperature, of the nature of the solvent, of the catalyst, of the base and of the counter-ion of the ionic support were examined.

These different studies were carried out using 4-iodobenzoic acid according to the following reaction diagram:

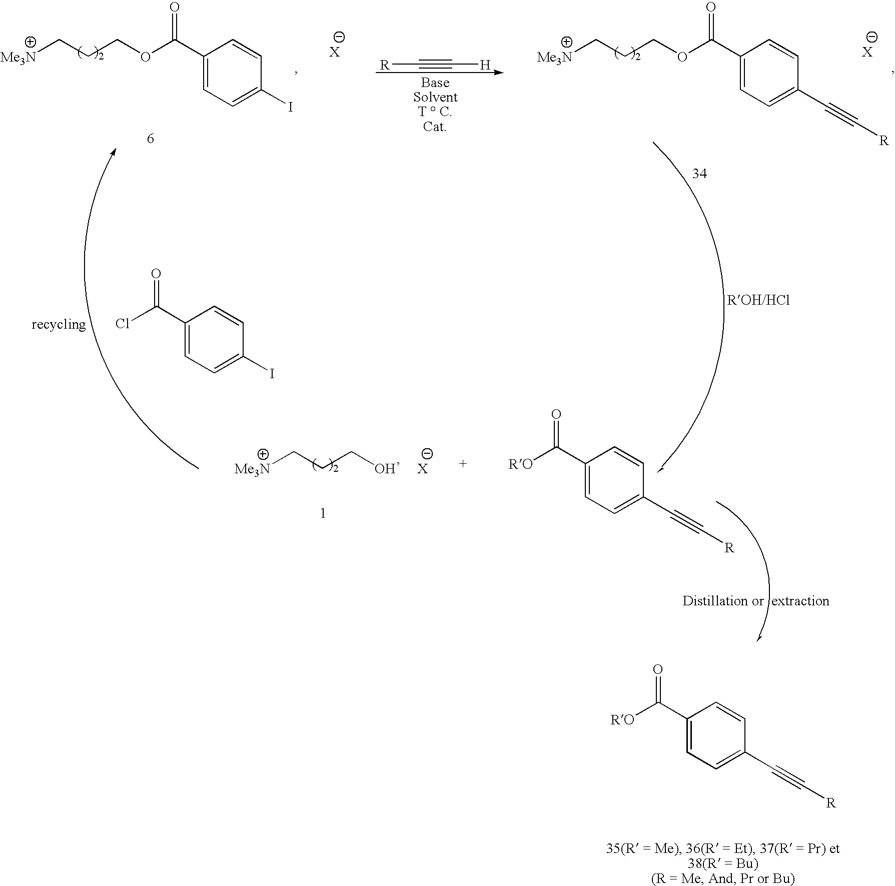

1—Effect of the Nature of the Solvent and the Base:

This study was carried out using 2.5% catalyst, 5% CuI and a temperature of 40° C. in order to determine the influence of the nature of the base and the solvent on the coupling reaction. The nature of the base or the solvent was therefore varied:

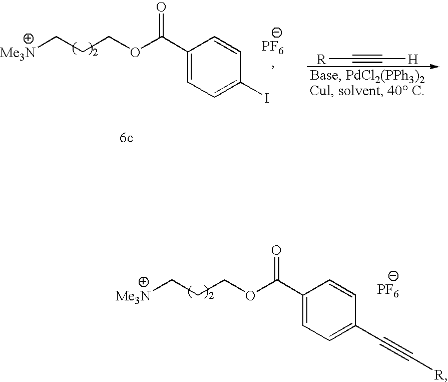

The different tests carried out at 40° C. after 1 hour of reaction are shown in Table 13:

TABLE 13
Sonogashira coupling at 40° C. for 1 hour
(influence of the base and the solvent)

| test | base | Solvent | Conv. rate (%) |
|---|---|---|---|
| 1 | K₂CO₃(s) | CH₃CN | 57ⁱ |
| 2 | N(Et)₃ | CH₃CN | 100ⁱ |
| 3 | N(Et)₃ | DMF | 100ⁱⁱ |
| 4 | N(Et)₃ | THF | 75ⁱⁱ |
| 5 | N(Et)₃ | Toluene | 65ⁱⁱ |
| 6 | N(Et)₃ | CH₂Cl₂ | 100ⁱⁱ |
| 7 | N(Et)₃ | Acetone | 100ⁱⁱ |
| 8 | N(Et)₃ | Dioxane | 100ⁱⁱ |
| 9 | N(Et)₃ | CH₃CN | 100ⁱⁱ |

ⁱX = PF₆; R = butyl
ⁱⁱX = NTf₂; R = pentyl

Examination of Table 13 shows that the use of triethylamine allows better reactivity to be observed compared with the use of solid potassium bicarbonate as base (compare tests 1 and 2).

Test 2 to 8 show that various conventional organic solvents can be used. However, a reduction of reactivity was observed in the cases of toluene and of tetrahydrofuran where the reaction medium is heterogeneous.

2—Effect of the Nature of the Anion of the Onium Salt:

The comparative study was carried out on the coupling reaction of 1-heptyne on N,N′,N″-trimethylbutylammonium 4-iodobenzoate, using acetonitrile as solvent, triethylamine as base and PdCl₂(PPh₃)₂ as catalyst, according to the following reaction diagram:

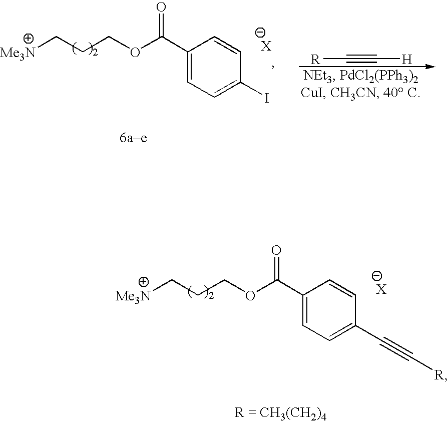

The results obtained after 15 minutes of stirring at 40° C. are shown in the following Table 14:

TABLE 14
Sonogashira coupling (15′ at 40° C.): influence of the anion.

| test | X | Conversion rate (%) |
|---|---|---|
| 1 | I | 50 |
| 2 | NTf₂ | 100 |
| 3 | BF₄ | 70 |
| 4 | PF₆ | 97 |
| 5 | CH₃SO₄ | 95 |
| 6 | CF₃SO₃ | 91 |

Examination of Table 14 shows that the coupling reaction takes place whatever the nature of the anion. On the other hand, a better reactivity is observed in the case of triflate, methylsulphate, hexafluorophosphate and bis-trifluoromethane sulphonamide (triflimide).

3—Effect of the Nature of Alkyne:

In order to generalize this methodology the coupling of the supported aryl halide 6b with various functionalized or non-functionalized alkynes was carried out.

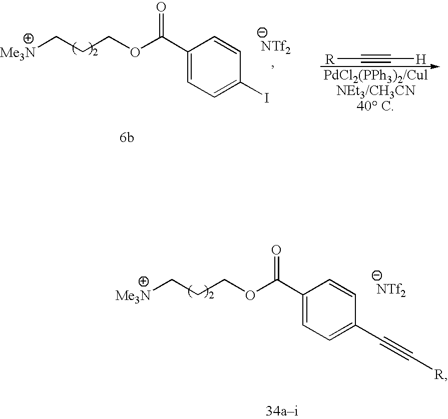

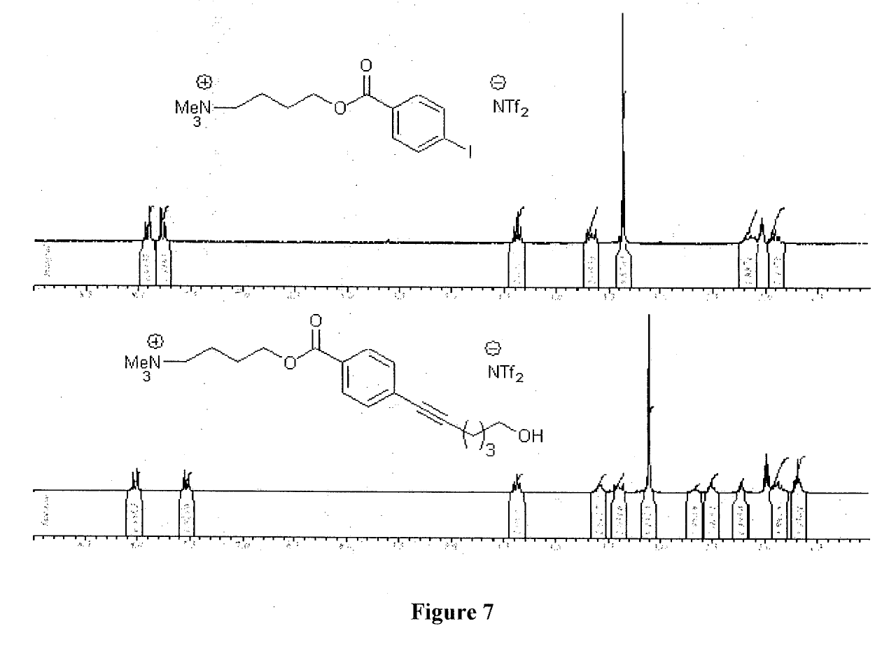

These different reactions were monitored with proton NMR. FIG. 7 shows the simplicity and the ease of interpretation of such spectra.

The results obtained by varying the alkynes are shown in Table 15.

TABLE 15
Sonogashira coupling of 6b with different alkynes.

| | | Reaction time | Conv. | Yieldⁱ |
|---|---|---|---|---|
| test | Alkyne | (h) | rate (%) | (%) |
| 1 | 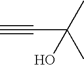 | 1 | 100 | 85 |
| 2 | 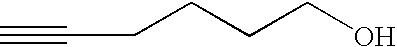 | 1 | 100 | 75 |
| 3 | 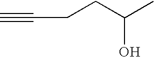 | 1 | 100 | 92 |
| 4 | 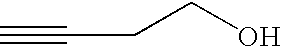 | 1 | 100 | 83ⁱⁱ |
| 5 | 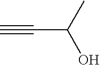 | 1 | 100 | 88 |
| 6 | 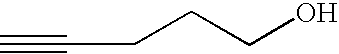 | 1 | 100 | 77 |
| 7 | 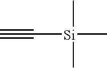 | 1 | 100 | 95 |
| 8 | 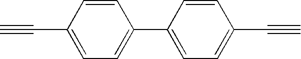 | 1 | 100 | 63ⁱⁱ |
| 9 | 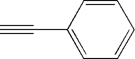 | 1 | 100 | 94 |

ⁱYield of pure isolated product.
ⁱⁱYield of product isolated after transesterification with methanol.

4—Effect of the Nature and the Quantity of the Catalyst:

The coupling reaction of N,N,N-trimethylbutylammonium 4-iodobenzoate and hexyne was carried out in the presence of triethylamine as base and acetonitrile as solvent according to the following reaction diagram:

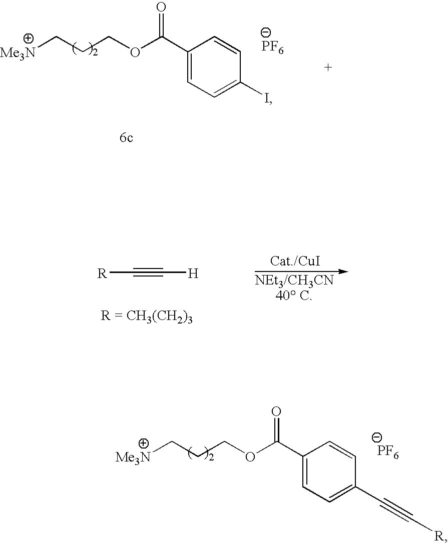

The results obtained are shown in the following Table 16:

TABLE 16
conditions for Sonogashira coupling in acetonitrile
of iodoaryl 6c with 1-hexyne.

| | | cata/CuI | Temperature | Reaction | Conversion |
|---|---|---|---|---|---|
| test | catalyst | (%/%) | (° C.) | time (h) | rate (%)ⁱ |
| 1 | PdCl₂(PPh₃)₂ | 10/20 | 20 | 0.2 | 100ⁱⁱ |
| 2 | PdCl₂(PPh₃)₂ | 10/20 | 40 | 0.2 | 100ⁱⁱ |
| 3 | PdCl₂(PPh₃)₂ | 5/10 | 20 | 0.2 | 100 |
| 4 | PdCl₂(PPh₃)₂ | 2.5/5 | 20 | 0.2 | 100 |
| 5 | PdCl₂(PPh₃)₂ | 1/2 | 20 | 1 | 70 |
| 6 | PdCl₂(PPh₃)₂ | 2.5/0 | 20 | 0.2 | <10% |
| 7 | PdCl₂(PPh₃)₂ | 2.5/5 | 40 | 0.2 | 100 |
| 8 | PdCl₂ | 2.5/5 | 40 | 0.2 | <10 |
| 9 | Pd(OAc)₂ | 2.5/5 | 40 | 0.2 | <10 |

ⁱyield determined by NMR.
ⁱⁱyield determined by GC/MS after transesterification.

The following points are noted:
the reaction takes place at ambient temperature with record times even in the presence of 2.5% catalyst. These results are very advantageous given that, in the case of the solid support the same reaction is complete only after 24 hours in the presence of 10% catalyst;
the presence of phosphorated ligand clearly accelerates the reaction, and the PdCl₂(PPh₃)₂ remains, by far the catalyst of choice for this reaction (compare with tests 7, 8 and 9);
the reactivity remains identical while reducing the percentage of catalyst from 10 to 2.5%. By contrast, reduction to 1% causes a fall in the reactivity (test 5). Similarly, Test 6 shows that the presence of CuI is not essential but it accelerates the reaction.

5—Application in Combinatorial Chemistry:

After analyzing the results obtained during this study, it was decided to work under the following conditions for the preparation of an aromatic alkyne library:

Solvent: CH₃CN

Temperature: 40° C.

Base: Triethylamine

For the preparation of this ester library the procedure was as follows:

Firstly, a series of coupling reactions in parallel with 5 alkynes and supported 4-iodobenzoic acid was carried out. Then, the 5 reaction media were mixed to form a homogeneous solution. After evaporation of the acetonitrile and washing with ether, the residue is then divided into four equal portions. Each part is dissolved in an alcohol in the presence of 3 drops of concentrated hydrochloric acid (12 N) then the mixture is taken to reflux for 18 hours. After evaporation to dryness of the alcohol, the mixture of the products is extracted with ether. The 4 series of 5 alkynes obtained are then analyzed in GC/MS. The different alkynes expected are all identified with no ambiguity.

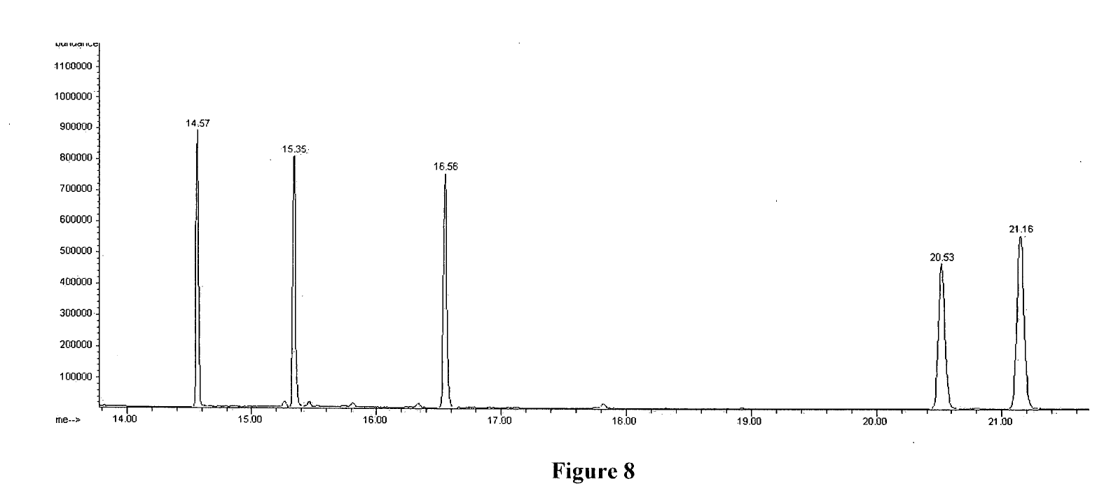

The results obtained are listed below in the form of tables. The chromatograms of the mixtures of alkynes are also given (FIGS. 8 to 11).

a/Acetylenic Methyl Esters 35a-e:

Table 17 below corresponds to the chromatogram of FIG. 8.

TABLE 17
Characterization by GC/MS of the methyl ester library

| | | Retention time | |
|---|---|---|---|
| 35 | R | in minutes | Molecular mass |
| 35a | 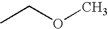 | 14.57 | 204 |
| 35b | 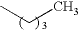 | 15.35 | 216 |
| 35c | 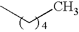 | 16.56 | 230 |
| 35d | 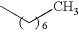 | 20.53 | 236 |
| 35e | 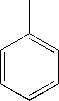 | 21.16 | 258 |

b/Ethyl Esters 36a-e:

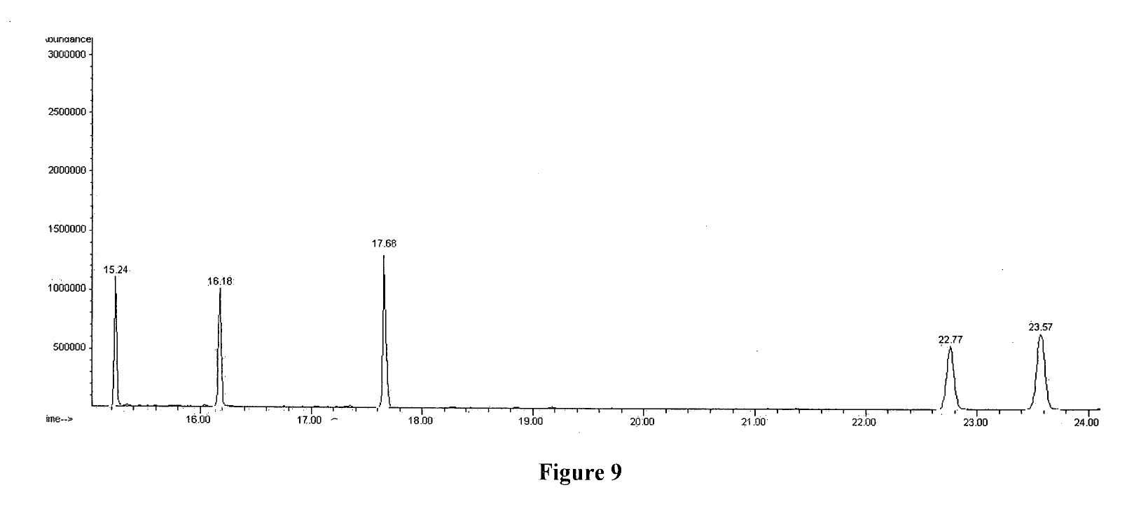

Table 18 below corresponds to the chromatogram of FIG. 9.

TABLE 18
Characterisation by GC/MS of the ethylic ester library

| 36 | R | Retention time | Molecular mass |
|---|---|---|---|
| 36a | 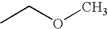 | 15.24 | 218 |
| 36b | 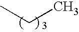 | 16.18 | 230 |
| 36c | 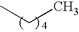 | 17.68 | 244 |
| 36d | 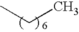 | 22.77 | 250 |
| 36e | 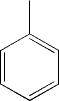 | 23.57 | 272 |

c/Propyl Esters 37a-e:

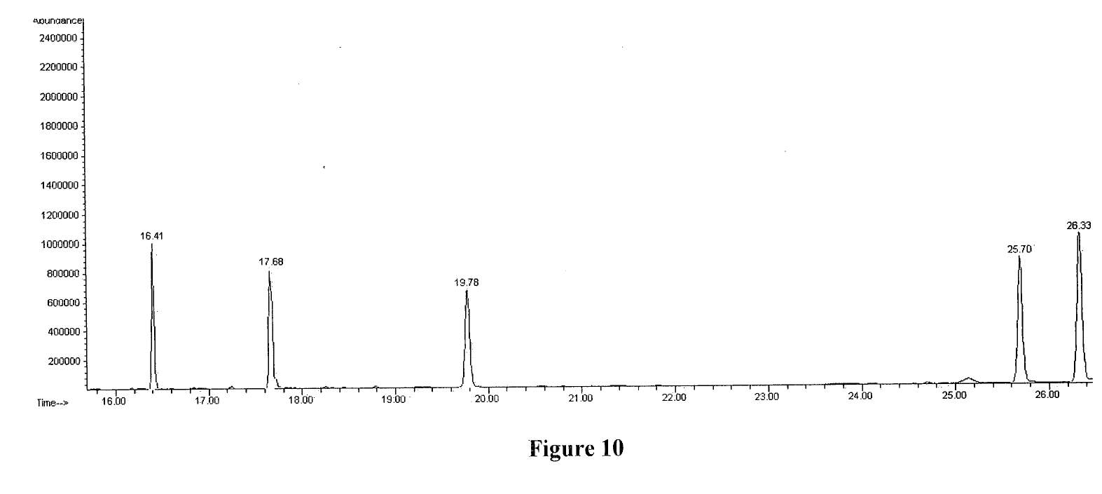

Table 19 below corresponds to the chromatogram of FIG. 10.

TABLE 19
Characterization by GC/MS of the propyl ester library

| 37 | R | Retention time | Molecular mass |
|---|---|---|---|
| 37a | 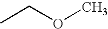 | 16.41 | 232 |
| 37b | 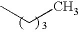 | 17.68 | 244 |
| 37c | 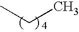 | 19.78 | 258 |
| 37d | 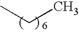 | 25.70 | 264 |
| 37e | 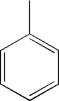 | 26.33 | 286 |

d/Butyl Ester 38a-e:

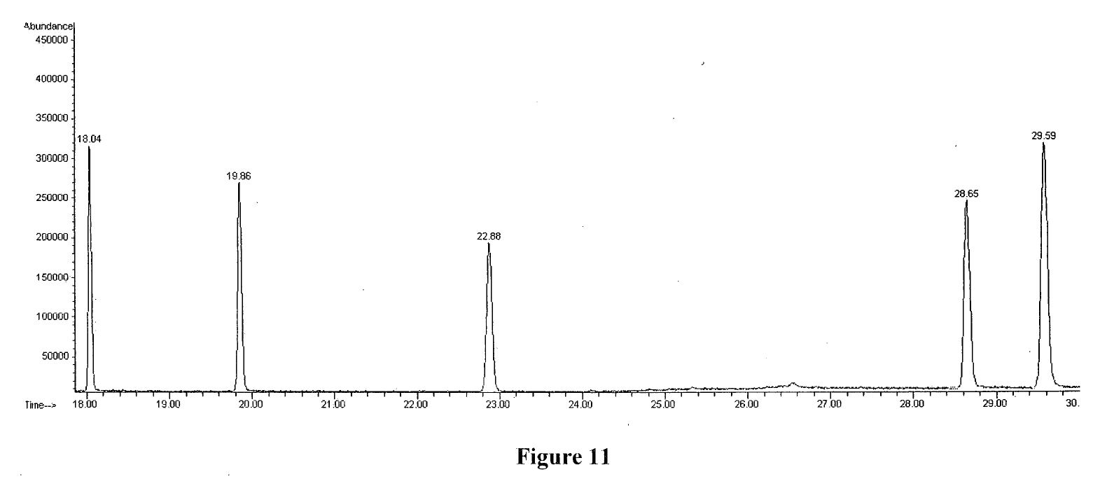

Table 20 below corresponds to the chromatogram of FIG. 11.

TABLE 20
Characterization by GC/MS of the butyl ester library

| 38 | R | Retention time | Molecular mass |
|---|---|---|---|
| 38a | 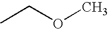 | 16.41 | 232 |
| 38b | 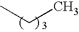 | 17.68 | 244 |
| 38c | 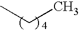 | 19.78 | 258 |
| 38d | 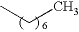 | 25.70 | 264 |
| 38e | 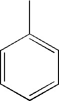 | 26.33 | 286 |

Supported Alkyne 8:

We used the supported alkyne 8 in the Sonogashira reaction with different iodides. This occurred in the presence of PdCl₂(PPh₃)₂ as catalyst and CuI as co-catalyst. After 20 minutes of stirring at ambient temperature, the reaction is complete leading to 39a-f.

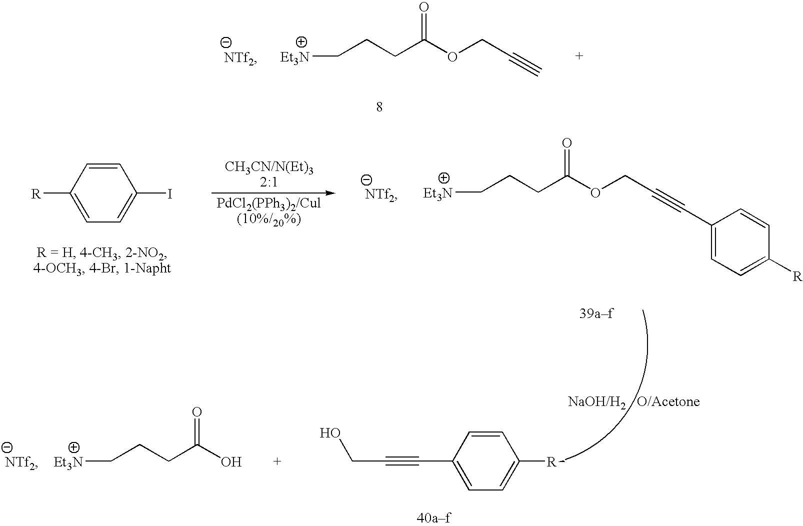

After reaction, the reaction mixtures are evaporated to dryness and washed with ether in order to eliminate the excess of reagents. The oils thus obtained are dissolved in methylene chloride then the solutions are washed with an aqueous solution of K₂CO₃ to release Et₃N from its hydrochloride formed during the reaction. After treatment with Na₂SO₄ and evaporation of the methylene chloride, the salts are isolated with a good yield. This is illustrated in Table 21.

TABLE 21
Yield of products 39a-f

| Input | R | Yield(%) |
|---|---|---|
| 39a | H | 77 |
| 39b | 4-CH₃ | 89 |
| 39c | 2-NO₂ | 81 |
| 39d | 4-OCH₃ | 92 |
| 39e | 4-Br | 80 |
| 39f | 1-Naphth | 86 |

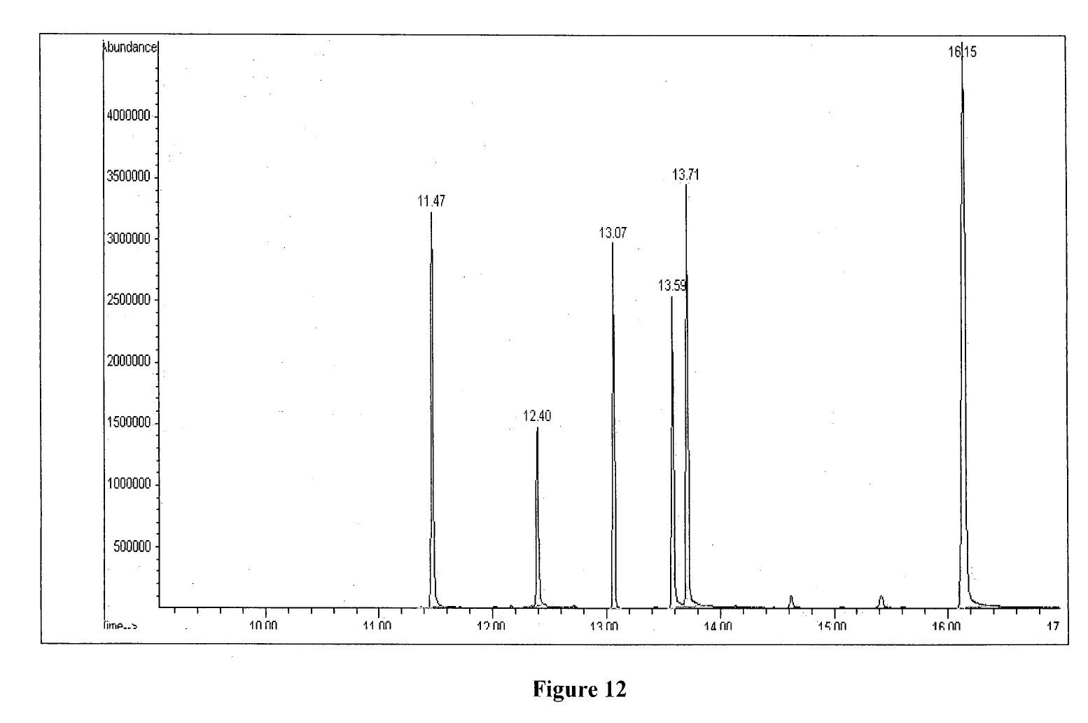

The alcohols formed are extracted with ether after saponification in the presence of an aqueous solution of 5% NaOH in water of the mixtures of the previously isolated salts and then injected into the GC-MS (FIG. 12 and Table 22).

TABLE 22
Characterization by GC/MS of the alcohol library 40a-f

| 40 | R | Retention time | Molecular mass |
|---|---|---|---|
| 40a | H | 11.47 | 132 |
| 40b | 4-CH₃ | 12.40 | 146 |
| 40c | 2-NO₂ | 13.07 | 177 |
| 40d | 4-OCH₃ | 13.59 | 162 |
| 40e | 4-Br | 13.71 | 211 |
| 40f | 1-Naphth | 16.15 | 182 |

### C—Example 3

### Synthesis of α-Amino Acids

The alkylation of the imines derived from glycine and benzophenone was chosen as a model reaction in order to explore the potential of the onium salts as supports in this type of reaction. The advantage of these substrates resides in particular in the possibility of obtaining substituted α-amino acids and optionally carrying out their asymmetric synthesis.

The sequence used uses the alkylation of an iminoester derived from glycine and benzophenone under the phase transfer conditions according to the method described by O'Donnel et al. (1989) in solution and allows synthesis of the higher amino acids according to the following diagram:

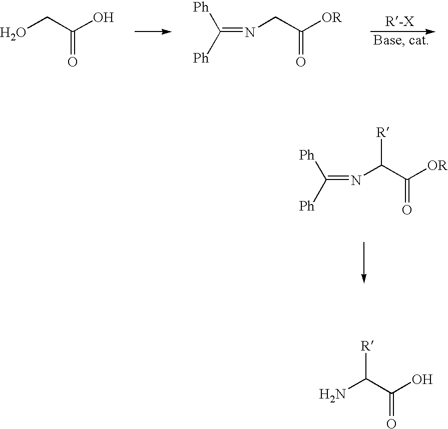

Besides the twenty one natural (L)-α-amino acids known and isolated from protein hydrolyzate, other unnatural (L)-α-aminio acids have useful biological properties. For example, the incorporation of an amino acid having well chosen substituents into a peptide can produce conformational constraints and increase the selectivity for a receptor. For example the inhibition of the decarboxylases, hydrolases or transferases by an α-alkyl amino acid which plays the role of a suicide substrate can be mentioned (Williams, R. M. “Synthesis of Optically Active α-Amino Acids” Pergamon Press, Oxford, 1989).

(D)-phenylglycine (A) and (D)-p-hydroxyphenylglycine (B), marketed by the Dutch company DSM, respectively constitute the raw materials for the production of the antibiotics ampicillin (A) and amoxicillin (B). Sales of these reach 1.5-1.7 billion dollars per year.

Despite the increased demand for α-amino acids, fermentation remains the main method for their preparation. Since the end of the 80s, methods of synthesis have seen their use become established in industry. The unnatural α-amino acids are obtained by two methods:
asymmetric synthesis.
cleavage which remains the method of choice.

Moreover, the synthesis on a solid or soluble PEG-type support is still one of the most effective and simple methods to use in order to attain these molecules (Lindström et al., 2002).

The onium salts were therefore tested as soluble supports for the preparation of the higher α-amino acids according to the following reaction diagram:

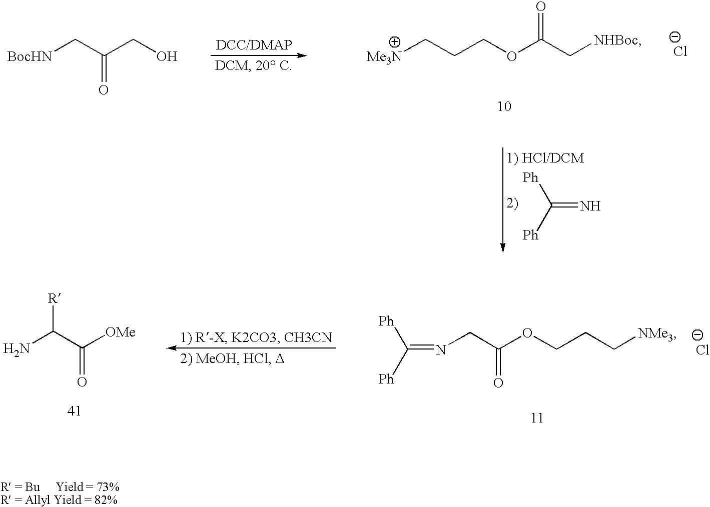

The esterification reaction is carried out directly on N-Boc-glycine in the presence of one equivalent of DCC and 5% DMAP at ambient temperature in dichloromethane (DCM). The Boc protective group is then eliminated in the presence of hydrochloric acid in DCM with a good yield. Similarly, the condensation of amino ester with diphenylmethylene imine leads to the imino ester 11 with an excellent yield and which can be preserved for several days at ambient temperature.

It is to be noted that the support which is an ammonium salt also plays the role of phase transfer catalyst in the stage of alkylation of the Schiff s base 11, and we have found a greater reactivity than that described in the literature for the alkylation of the same substrate supported on PEG or a solid support.

### D—Example 4

### Multi-Component Reactions MCR

Multi-component reactions simultaneously bring together at least three partners under experimental conditions which do not vary over time and allow the creation of several covalent bonds in cascade in a single reactor, by contrast to standard reactions where two reagents lead to a product by creation of a new bond. Thus it is possible to attain a highly functionalized molecule from relatively simple entities in a single stage. Moreover the MCRs combine convergence and economy of atoms, two essential principles in organic synthesis and also in combinatorial chemistry. Finally it is pointed out that these reactions generally take place with a high yield, because they avoid the succession of stages of linear or multi-stage syntheses which, at each stage, cause a drop in yield.

The best known and most highly developed MCRs are those of Passerini and of Ugi. One of the main reagents of these reactions is an isonitrile of general formula RN═C, in which the electron structure of the terminal carbon includes a doublet and an electron hole (carbenic type structure) and allows the transition from a carbon atom which is strictly divalent to a tetravalent carbon atom by adding an electrophile and a nucleophile. The following diagram represents an example of a Passerini reaction (3CC reaction for 3-component condensation).

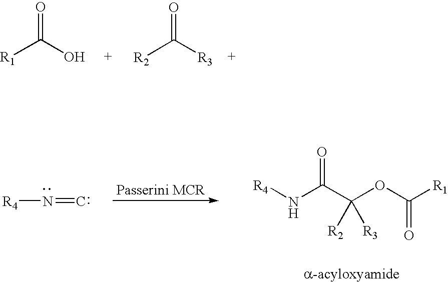

The MCRs were of course transposed onto a solid support. For example a resin with an amine termination was used in a Ugi type reaction in order to lead, after cleavage, to a series of adducts with high purity with yields ranging from average to excellent:

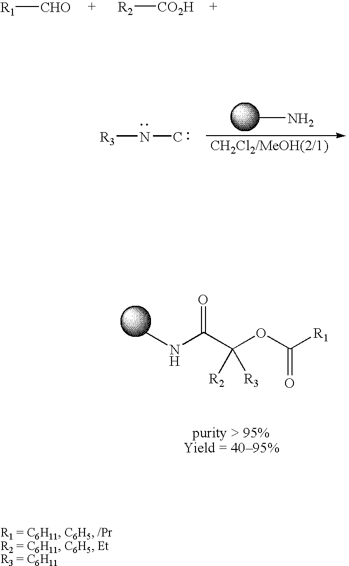

Although the Ugi and Passerini reactions are the best known and most highly developed, other MCRs exist, which satisfy the essential criteria that all the reagents are present from the start of the reaction and the conditions do not vary during these reactions. By contrast to the Ugi and Passerini reactions, these other reactions do not rely on the use of an isonitrile as one of the main players in the creation of new covalent bonds. These different types of reactions allow highly functionalized structures which are varied in a single stage to be attained.

Synthesis of Substituted Quinolines According to the Grieco Reaction:

Substituted quinolines are useful pharmacophores. Their synthesis on a solid support was carried out with a so-called Doebner MCR, using an aniline, an aldehyde and an α-dicarbonyl compound. The quinolines are obtained with high purity and very good yields.

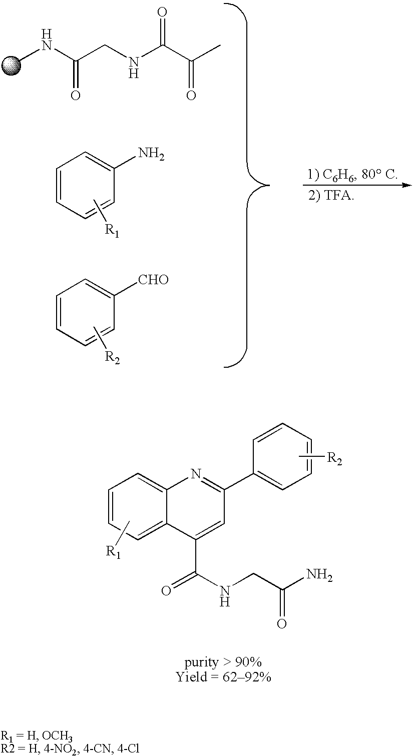

It was decided here to profit from the numerous advantages offered by the onium supports, as demonstrated in the various examples described previously. Thus, it was decided to test them in Grieco-type MCRs (Grieco et al., 1988). This example has been the subject of several works described by W. Armstrong et al. (1997 and 1998) on a solid support and it allowed the preparation of a library of 80 products with yields ranging from 50 to 93%.

a—Use of Supported Aniline 7g in the Grieco Reaction:

In order to do this, the aniline 7g was supported, and brought into the presence of an aldehyde and cyclopentadiene in order to produce tetrahydroquinolines. This three-component example consists of a first condensation of aldehyde and aniline in order to produce imine. This then reacts in what is strictly a Diels-Alder reaction with cyclopentadiene in the presence of a catalytic quantity of trifluoroacetic acid.

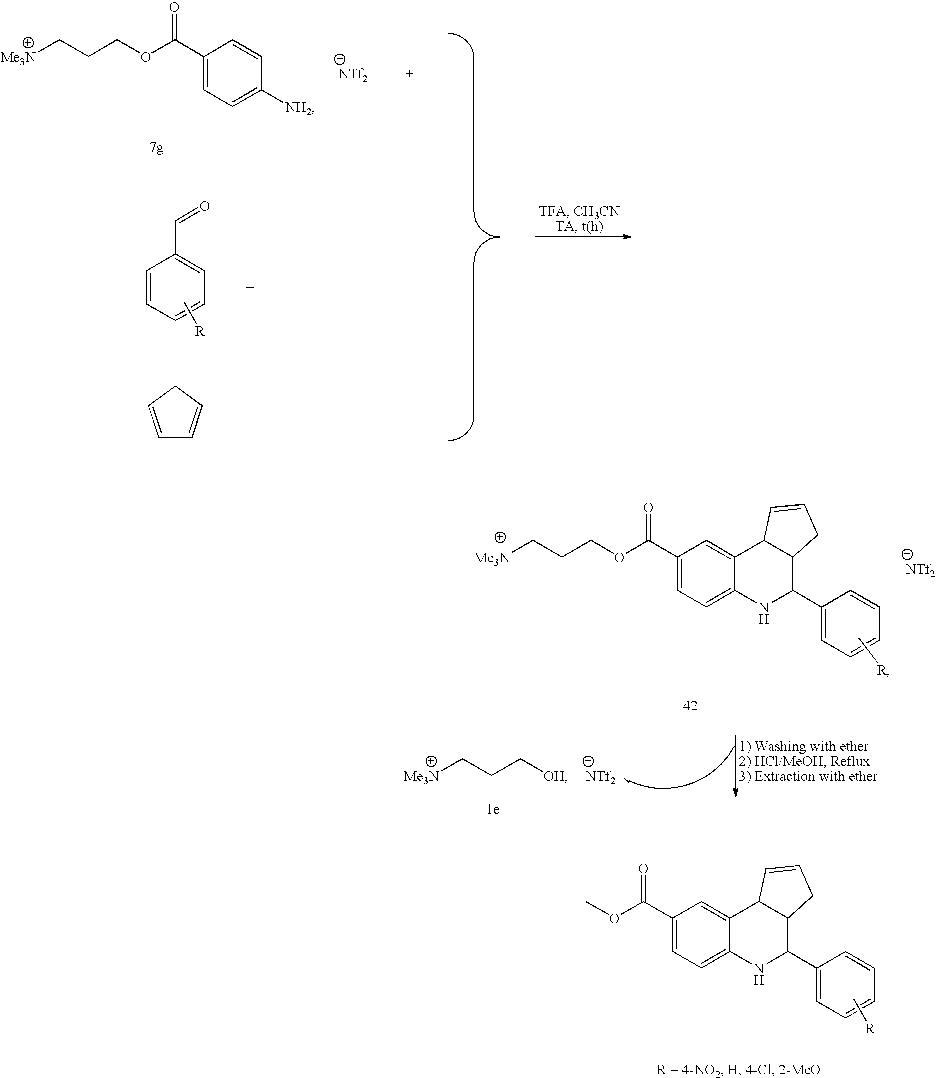

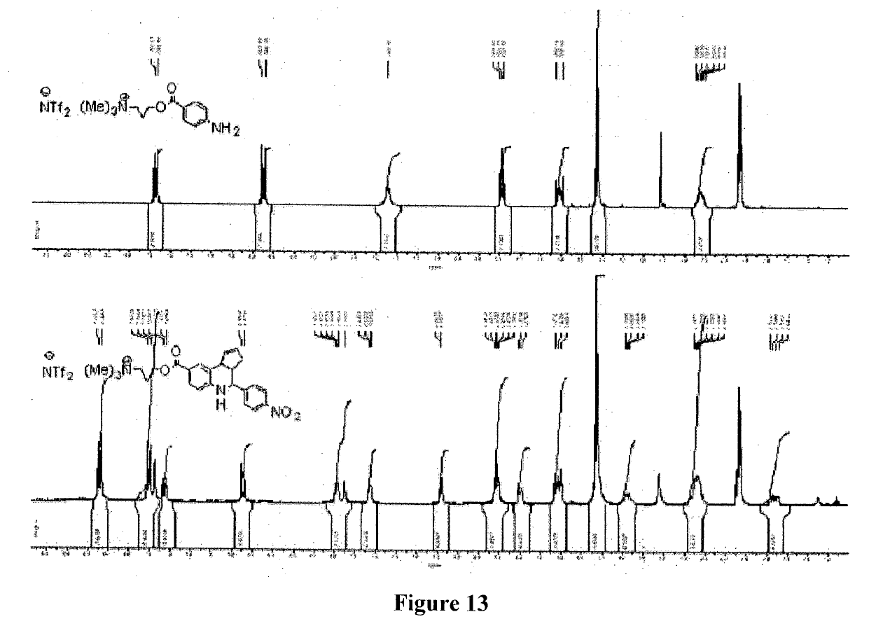

The monitoring of the different reactions was carried out by ¹H NMR (FIG. 13) and a conversion ranging from 80% to 100% was observed according to the nature of the aldehyde. In the presence of electron-rich aldehyde the reaction is slowed down. Thus in the presence of 4-nitrobenzaldehyde the reaction is complete after 12 hours while progress is only 70% in the case of benzaldehyde. The above reaction diagram illustrates the case of 4-nitrobenzaldehyde, after evaporation of the solvent (CH₃CN) and washing with ether in order to eliminate the excess of the two reagents and the trifluoroacetic acid. This diagram also shows that the monitoring of a reaction which leads to complex compounds is possible and with a remarkable clarity. Transesterification with methanol leads to very clean products which are extracted with ether and purified by filtration on silica.

The various examples that we have produced and the results obtained are shown in Table 23 below.

TABLE 23
Grieco reaction carried out on ammonium
salts used as soluble support:

| | | Yield of 42 | Yield of 43 |
|---|---|---|---|
| R | Time in (h) | in (%) | in (%) |
| 4-NO₂ | 12 | 98 | 82 |
| H | 12 | 70 | 68 |
| 4-OMe | 12 | 60 | 54 |
| 4-Cl | 14 | 96 | 83 |

Example: Synthesis of Tetrahydroquinoline 43 Derived from Benzaldehyde:

100 mg of supported amine 7g, 500 μl of a 1 M solution of para-nitrobenzaldehyde in acetonitrile, 500 μl of a 1 M solution of cyclopentadiene in acetonitrile and 50 μl of a 1% TFA solution in acetonitrile are mixed under a flow of argon. The reaction mixture is stirred overnight at ambient temperature. After evaporation to dryness and washing with ether, a yellow solid is obtained.

Yield=71%

¹H NMR (200 MHz, Acetone D₆): 1.55-1.8 (m, 1H); 2.35-2.58 (m, 3H); 3.01-3.2 (m, 1H); 3.4 (s, 9H); 3.7-3.9 (m, 2H); 4.1-4.22 (m, 1H); 4.42 (t, 2H, J=5.81 Hz); 4.9-5.0 (m, 1H); 5.58-5.75 (m, 1H); 5.7-5.8 (m, 1H); 5.93-6.05 (m, 1H); 6.9 (d, 1H, J=8.4 Hz); 7.6-7.95 (m, 4H); 8.28 (d, 2H, J=8.6 Hz).

¹³C NMR (50 MHz, Acetone D₆): 22.92; 31.25; 45.35; 45.40; 52.96 (t, J_{C-N}=4.07 Hz); 56.46; 60.67; 64.28; 115.40; 119.45; 120.13 (q, J_{C-F}=321.194 Hz), 123.40; 124.65; 127.68; 128.17; 129.70; 130.98, 134.26; 147.20; 150.12; 150.50; 165.77

b—Use of the Supported Aldehyde 7h in the Grieco Reaction:

In this work, the supported aldehyde 7h was used in the Grieco reaction with different amines and olefins, in acetonitrile as solvent and in the presence of TFA as catalyst as shown in the following diagram:

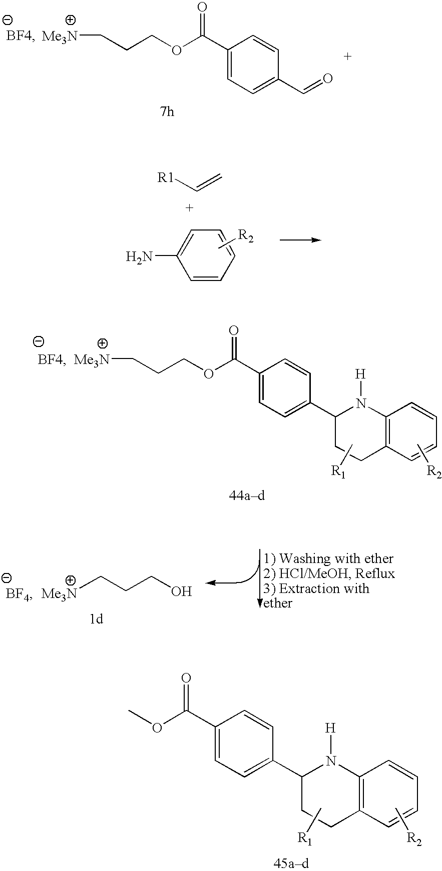

After stirring a solution of 0.85 mol/l of 7h in acetonitrile in the presence of 1.2 equivalents of TFA, 1 equivalent of amine and 2 equivalents of olefin at ambient temperature for two hours, the monitoring of the reaction carried out by HPLC shows that it is complete after 2 hours. After the addition of ether the salts formed 44a-d are isolated by filtration followed by a stage of washing with ether. The products 45a-d are isolated by extraction with ether after a transesterification reaction at reflux of the methanol in the presence of a catalytic quantity of hydrochloric acid. The medium is then neutralized by adding a diluted solution of K₂CO₃ after evaporation of the solvent. Table 24 shows the yields of 44 and 45 isolated.

TABLE 24
Yields of products 44 and 45 isolated.

| | | | Yield of 44 | Yield of 45 |
|---|---|---|---|---|
| Products | R₁ | R₂ | in % | in % |
| 44a | Cyclopentadiene | 3-NO₂ | 90 | 85 |
| 44b | Cyclopentadiene | 4-Br | 88 | 77 |
| 44c | Cyclopentadiene | H | 77 | 70 |
| 44d | Indene | 4-Br | 92 | 67 |

Example: Synthesis of 44c:

1 eq of aniline, 2 eq of cyclopentadiene and 1.2 eq of TFA are added to a solution of 100 mg (0.3 mmol) of 7h in 0.4 ml of acetonitrile. The reaction mixture is stirred for two hours at ambient temperature, evaporated to dryness and then washed with ether. The product of the reaction is isolated by filtration after crystallization in ether.

¹H NMR (300 MHz, Acetone D₆): 1.58-1.75 (m, 1H); 2.40-2.65 (m, 3H); 2.97-2.98 (m, 1H); 3.00-3.15(m, 1H); 3.40 (s, 9H); 3.77-3.92 (m, 2H); 4.03-4.15 (m, 1H); 4.46 (t, 2H, J=5.94 Hz); 4.68-4.76 (m, 1H): 5.55-5.62 (m, 1H); 6.58-7.13 (m, 4H); 7.60 (d, 2H, J=8.3 Hz); 8.05 (d, 2H, J=8.4 Hz).

¹³C NMR (75 MHz, Acetone D₆): 23.58; 32.19; 46.69; 47.06; 53.67 (t, J=3.8 Hz); 58.16; 62.42; 64.81; 117.00; 119.49; 126.47; 126.88; 127.59; 129.52; 129.63; 130.18; 130.43; 135.44; 146.90; 149.82; 166.57.

Mass spectrometry (APCI) for [C₂₅H₃₁N₂O₂][BF₄]:

| | |
|---|---|
| Theoretical mass calculated for (C⁺) | 391.5 |
| Mass found | 391.4 |

Synthesis of Tetrasubstituted Olefins:

a—Individual Synthesis of Tetrasubstituted Olefins:

Tetrasubstituted olefins can be obtained by a McMurry reaction or by a Wittig olefination reaction. However, the regio- and stereoselectivities are the main problems associated with these two methods. Other approaches use the carbolithiation of alkynes, reactions of oxiranes carrying a CF₃ group, organosilanes, electrotelluration. However, these approaches generally use reagents which are not readily available and are also sometimes accompanied by insufficient regio- and stereoselectivity.

Tetrasubstituted olefins can be prepared by an intermolecular addition reaction of an arylpalladium intermediate with an internal alkyne, followed by a coupling reaction with the organometallic derivatives of boron, tin or zinc.

In 2003, Zhou et al. developed a method for the synthesis of tetrasubstituted olefins using palladium as catalyst. This method uses the intermolecular coupling of an iodoaryl, an internal alkyne and an arylboronic acid⁷.

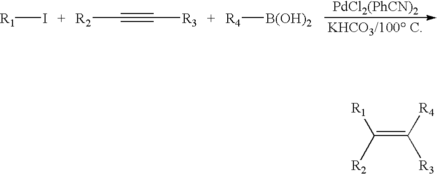

These olefins were synthesized on an onium salt support. In order to do this, as internal alkyne the salt 34i obtained by Sonogashira reaction between the supported iodide 6b and phenylacetylene, is used. The reaction is carried out at 100° C. in a DMF/H₂O mixture (80/20) as solvent, KHCO₃ as base and PdCl₂ (PPh₃)₂ as catalyst.

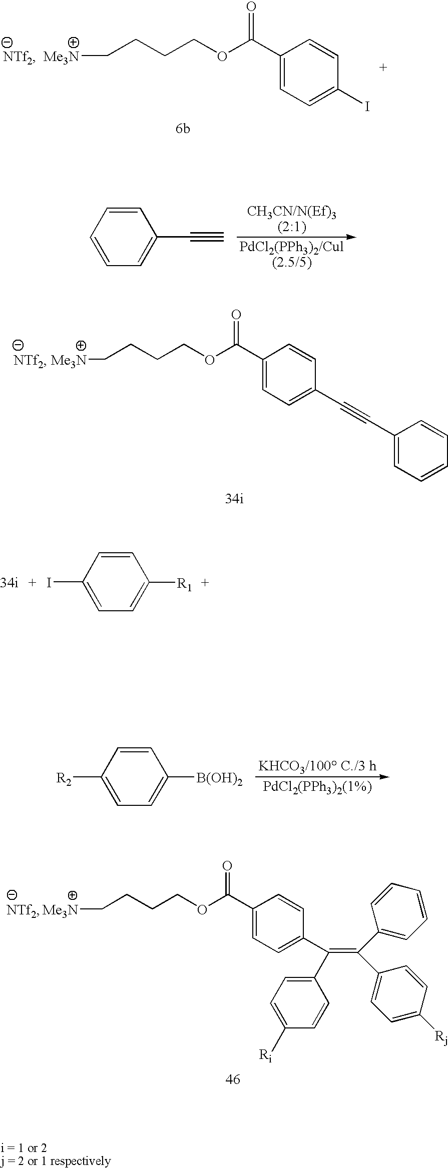

Table 25 shows the yields of isolated salts 46 after heating at 100° C. for 3 hours.

TABLE 25
Synthesis of olefins* 46.

| Input | R₁ | R₂ | Yield(%) |
|---|---|---|---|
| 1 | H | H | 67 |
| 2 | CH₃ | H | 60 |
| 3 | CH₃O | H | 70 |
| 4 | H | 1-Naphth | 68 |
| 5 | CH₃O | 1-Naphth | 86 |
| 6 | CH₃ | 1-Naphth | 83 |

*Mixture of 2 regioisomeric olefins

b—Synthesis of Tetrasubstituted Olefins 47 in a Mixture:

The supported iodide 6f is used in the same well and under the same conditions as previously in the Sonogashira reaction in the absence of CuI with five different alkynes.

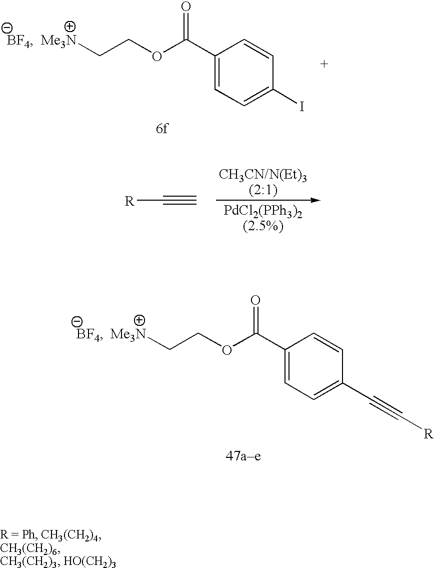

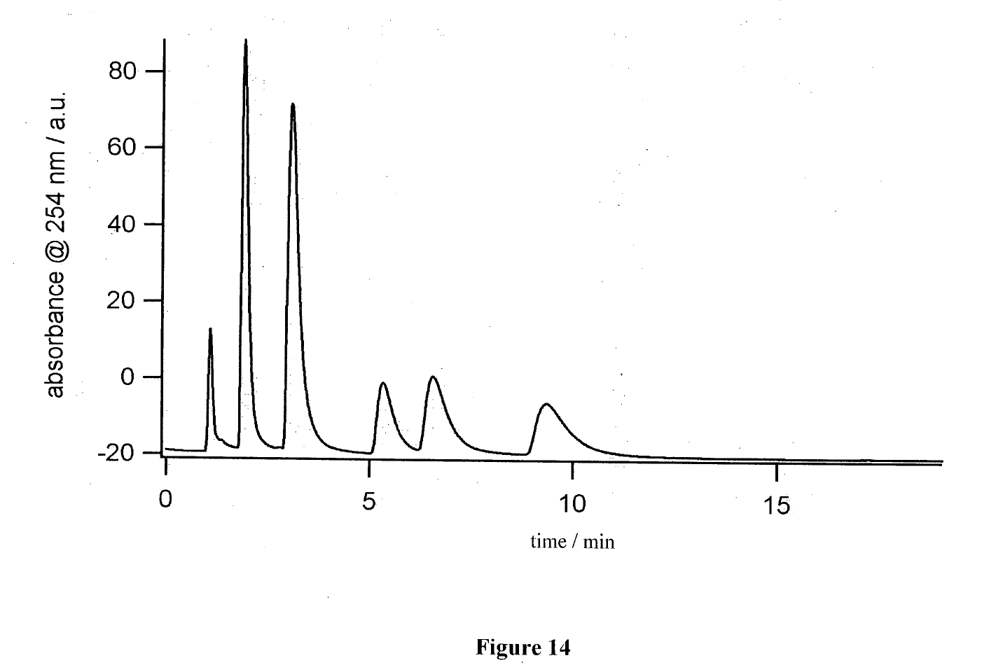

The monitoring of the reaction by HPLC shows the appearance of the Sonogashira coupling products 47 for which the retention times are 1.92, 3.09, 5.33, 6.57 and 9.35 after overnight stirring at ambient temperature (FIG. 14).

After evaporation to dryness of the solvent and washing with ether, the mixture obtained is divided into three parts. Each part is used to form tetrasubstituted olefins without the addition of catalyst. This occurs in the presence of phenylboronic acid and three aryl iodides. After heating at 100° C. for three hours the reaction mixtures are transesterified separately in the presence of methanol and hydrochloric acid.

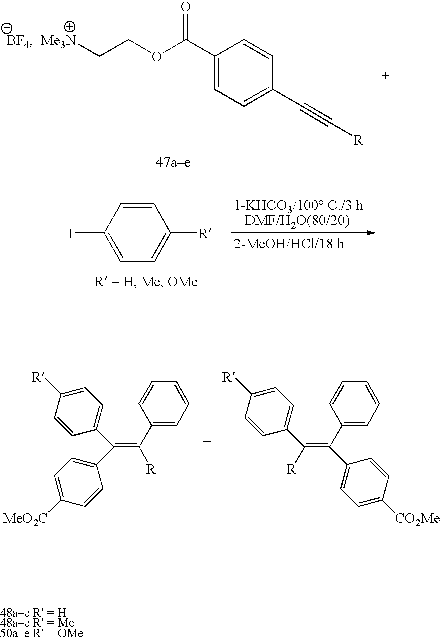

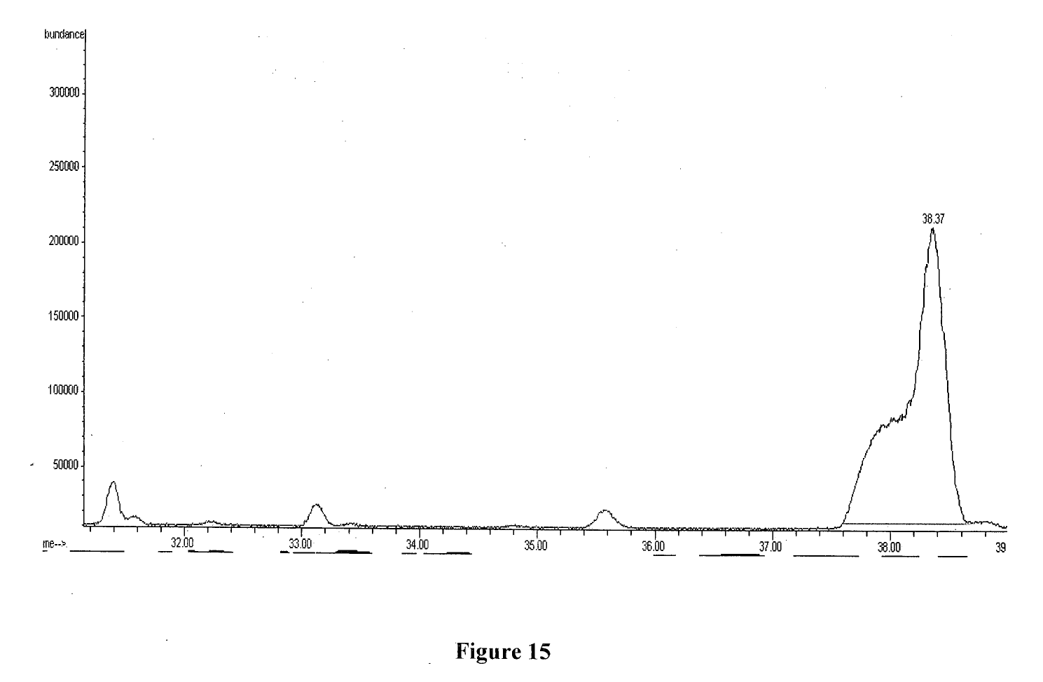

Tetrasubstituted olefins are extracted with ether after evaporation of methanol and injected into the GC/MS. The chromatogram presented in FIG. 15 illustrates the case of 4-iodotoluene (49a-e).

TABLE 26
Characterization by GC/MS of the tetrasubstituted
olefin library 49a-e.

| 49 | R | Retention time | Molecular mass |
|---|---|---|---|
| 49a | CH₃(CH₂)₃ | 31.37 and 31.59 | 384 |
| 49b | CH₃(CH₂)₄ | 33.12 and 33.42 | 398 |
| 49c et49d | HO(CH₂)₃ and Ph | 37.50-38.50 | 386 and 404 |
| 49e | CH₃(CH₂)₆ | 38.80 | 426 |

E—Increase in the Productivity of the Onium Salt Solutions in Conventional Polar Solvents.

It is pointed out that the specific charge of a support is defined by the quantity of reagent which can be supported per gram of support and is expressed in mmol/g. This corresponds to what could be called a specific functionality of a support denoted f which could be expressed in millifunctions per gram (mf/g). In the cases of solutions of onium salts in polar solvents, the molarity is expressed in mol/l or in mmol/ml. Knowing the density of the solutions, it is then easy to convert into mmol/g in order to obtain elements for comparison with the Merrifield resins or PEG-type soluble polymer solutions or others. If the salt is monofunctional, the specific functionality (f expressed in mf/g) will be equal to the specific charge expressed in mmol/g. If the salt carries n times the same function, a solution containing for example one millimole of this salt per gram will have a specific functionality f of n·mf/g.

In the case of the onium salts tested in the preceding part of the examples (the case of the monofunctionalized onium salts), the specific charge is greater than 1 mmol·g⁻¹ and can reach up to 7 mmol·g⁻¹ (see Table 27 below).

TABLE 27

| 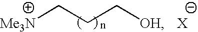 | Molecular mass | Specific charge of the support in (mmol/g) | Charge by weight of a molar solution in mg/ml |
|---|---|---|---|
| 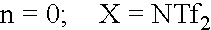 | 384 | 2.60 | 384 |
| 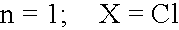 | 153.5 | 6.51 | 153.5 |
| 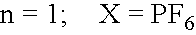 | 263 | 3.80 | 263 |
| 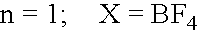 | 205 | 4.87 | 205 |
| 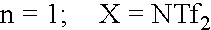 | 398 | 2.51 | 398 |
| 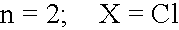 | 167.5 | 5.97 | 167.5 |
| 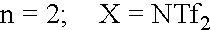 | 412 | 2.42 | 412 |
| 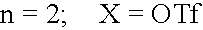 | 283 | 3.53 | 283 |
| 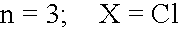 | 181.5 | 5.50 | 181.5 |
| 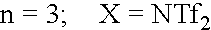 | 426 | 2.34 | 426 |
| 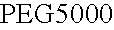 | 5000 | 0.2 | 5000 (5 g) |

By way of comparison, the specific charge of the PEGs, which are the most commonly used soluble supports, is usually comprised between 0.1 and 1 mmol·g⁻¹. Higher values (of the order of 10 mmol g⁻¹) are attained in the very particular case of a PEG possessing a structure of the dendrimer type such as that described by Haag (Haag et al., 2002).

Ammonium salts having two functional arms (or more) were synthesized. The 4 substituents of the nitrogen atom can be simultaneously functionalized by multiplying the functional density of these salts by the same amount.

It is also possible to envisage synthesizing onium salts with a dendrimeric structure, whose specific charge will thus be naturally multiplied.

It must also be pointed out that the solutions of onium salts in the commonly used solvents (CH₂Cl₂, CH₃CN, DMF, H₂O . . . ) are still not very viscous even operating at concentrations greater than 4 moles per liter. This represents a great advantage compared to the PEG solutions the concentration of which is generally less than 1 mol·l⁻¹

1—Bifunctional Ammonium Salts:

The condensation of 3-chloropropanol and of dimethylamine is carried out at reflux in water in order to produce the bifunctionalized salt with a good yield after 24 hours according to the following diagram:

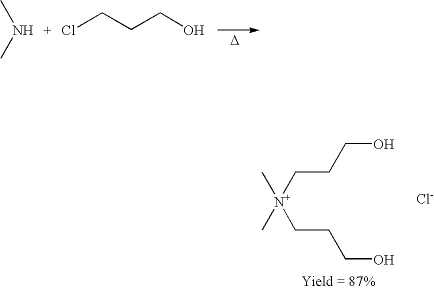

These novel supports were then tested in the same reactions as their monofunctionalized analogues. For this purpose acryloyl esters and halogenated aryls were supported and then used in Diels-Alder cycloaddition and coupling reactions.

The reaction sequences and the results obtained are presented in the diagrams below.

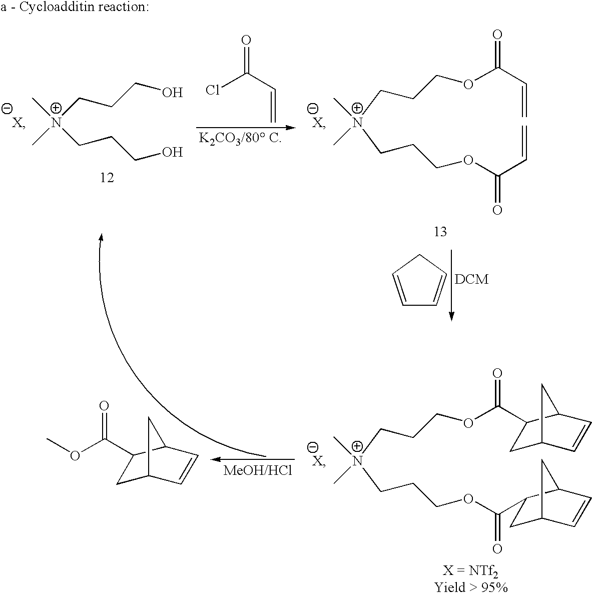

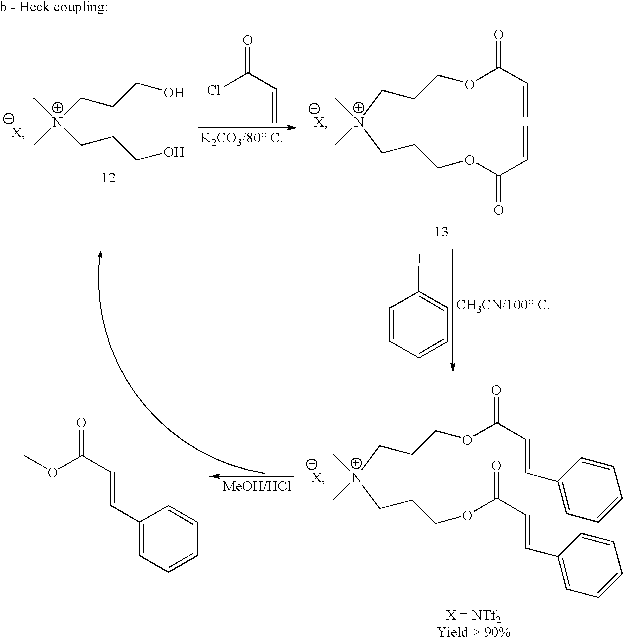

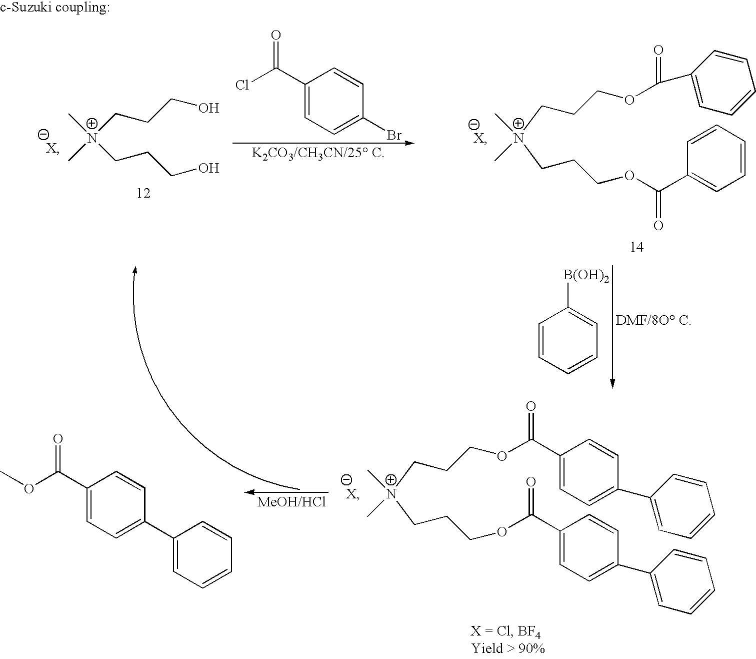

The transposition of the reactions carried out on the monofunctionalized supports to the bifunctionalized analogues causes no difference in reactivity or selectivity. Similarly, the yields of isolated products and their purity remain excellent.

The metathesis of anions was carried out either before the grafting of the substrates (the case of the bis-trifluoromethanesulphonamide anion) or after (the case of the tetrafluoroborate anion).

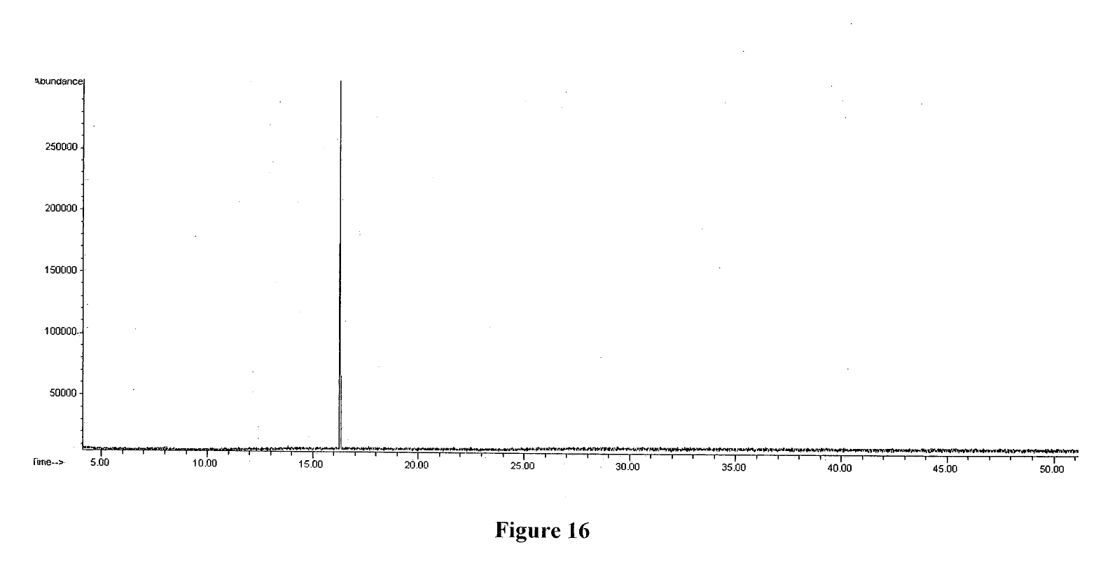

The chromatogram corresponding to the products of Suzuki coupling carried out on the bifunctional ammonium chloride (14, X═Cl) is presented in FIG. 16. This chromatogram demonstrates the purity of the isolated raw product after transesterification with methanol and extraction with diethyl ether with a yield of 92%.

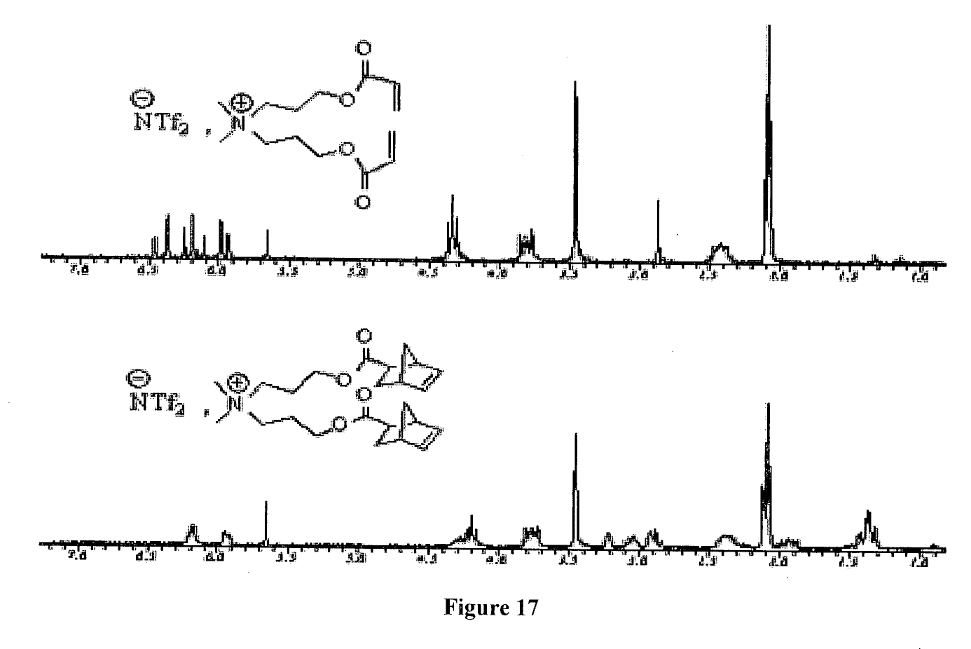

The monitoring of these different reactions was carried out by proton NMR as in the case of the monofunctionalized supports (see FIG. 17).

In a second stage, it was sought to further increase the functional density of the ammonium salts by tri- and tetrafunctionalization according to the following reaction sequences:

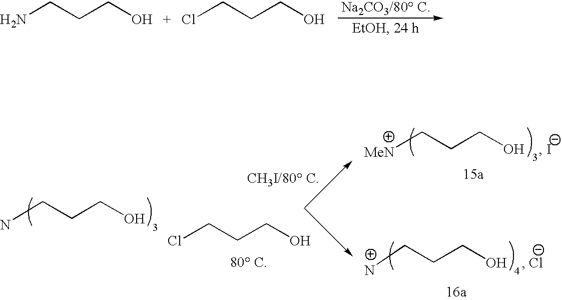

The tri- and tetra-functionalized salts were prepared from tripropanolamine by quaternization using methyl iodide or 3-chloropropanol leading to 15a or 16a respectively.

Ammonium bis-trifluoromethanesulphonamide salts derived from 15a and 16a obtained by metathesis in water were then used to support the acrylic ester. The latter are then used in the cycloaddition reactions as dienophiles in the presence of cyclopentadiene and in the Heck coupling reaction. The cycloaddition reaction is complete after 2 hours and allows the product to be isolated with yields greater than 75% and a purity of 97%. Similarly the Heck coupling was carried out with the same yields as those obtained with mono and bi-functionalized salts (>95%).

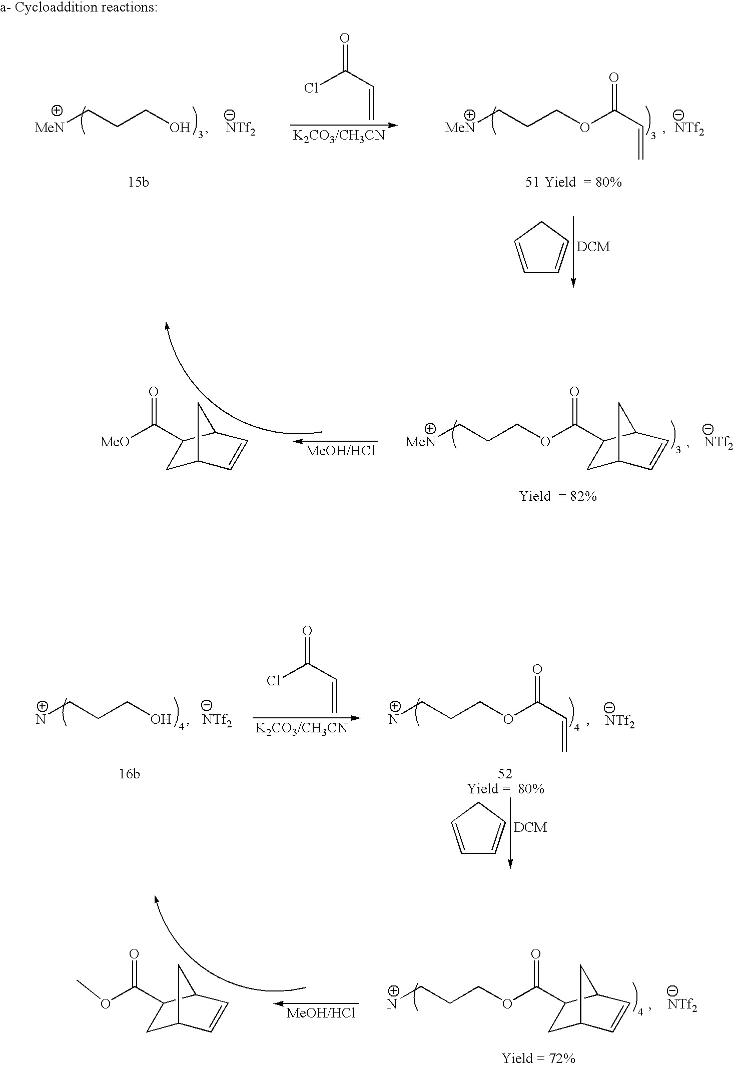

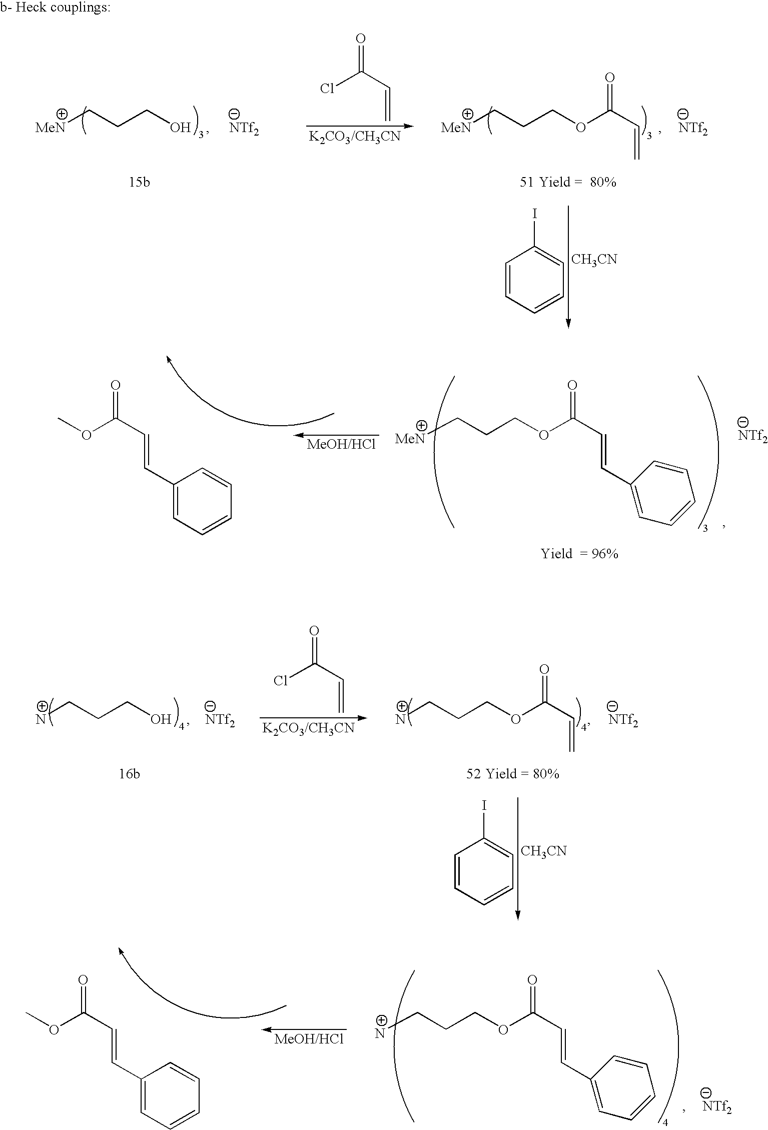

3—Onium Salts Supporting the Different Functions:

During this study, it has been shown that onium salts have very useful potentialities and properties as soluble supports in organic synthesis. In addition to the advantages that were already explained in the first parts of this document, one of the possibilities offered by these novel soluble supports is to carry two functions (or more) of a different nature on the same cation on the condition that they do not interact with each other.

By way of illustration, we shall limit ourselves to describing ammonium salts simultaneously carrying an acrylic ester and an aryl halide of the following formula:

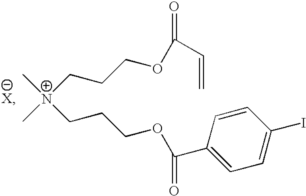

The ammonium salt prepared according to the reaction diagram below was used in the Heck coupling reaction. After one hour at 100° C. in the presence of palladium acetate products were isolated, which after transesterification with methanol in the presence of a few drops of concentrated hydrochloric acid lead to the Heck coupling product with a yield of 66% and a purity greater than 98%. It is to be noted that only the trans isomer was observed in both cases.

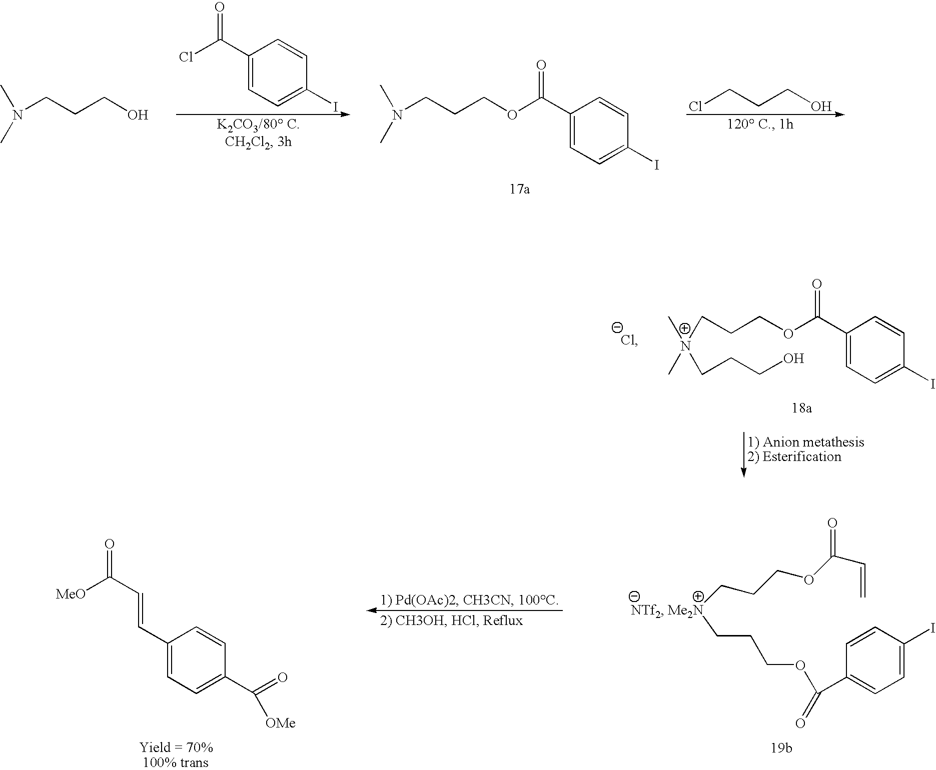

The insolubility of the reaction product before the transesterification in the last stage in different solvents suggests that a polymer-type structure forms:

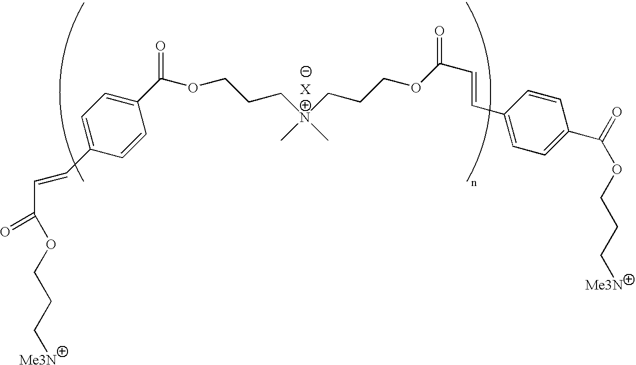

If the number of atoms is carefully chosen to lead to the cyclization product (intramolecular coupling) only the cis-form is obtained. In fact such a cyclization has been already observed under similar conditions.

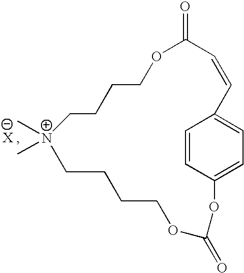

The preliminary results demonstrate the importance of this family of novel supports. The potential applications can moreover also be enriched by supporting a catalyst or ligand on one of the arms, and one or more identical or different reagents on those remaining. This novel technology offers a large and unlimited choice of applications.

### REFERENCES

Alexander, S. K. et Armstrong, R. W. (1997) Tetrahedron Lett., 38, 6163,
Alexander, S. K.; Leonsmith, A. V.; Armstrong, R. W. (1998) Tetrahedron Lett., 54, 7987,
Annunziata, R.; Benaglia, M.; Cinquini, M.; Cozzi, F. (2000) Chem.-Eur. J., 6, 133-138,
Barrett, A. G. M.; Cramp, S. M.; Roberts, R. S.; Zecri, F. (1999) J. Org. Lett., 1, 579-582,
Barrett, A. G. M.; Cramp, S. M.; Roberts, R. S.; Zécri. F. (2000) J. Org. Lett., 2, 261-264,
Barrett, A. G. M.; Cramp, S. M.; Roberts, R. S.; Zécri, F. (2000) J. Comb. Chem. High Throughput Screening, 3, 131-133,
Benaglia, M.; Annunziata, R.; Cinquini, M.; Cozzi, F.; Ressel, S. (1998) J. Org. Chem., 63, 8628-8629,
Berteina, S.; Wendeborn, S.; Brill, K.-D.; De Mesmaeker, A. (1998) Synlett, 6, 676,
Bienayme, H.; Schmitt, P. (2000) Actualité Chimique, 9, 29-34,
Bleicher, K. H.; Wareing, J. R. (1998) Tetrahedron Letters, 39 (26), 4587,
Burgath, A.; Sunder, A.; Frey, H. (2000) Macromol. Chem. Phys., 201, 782-791,
Chang, J.; Oyelaran, O.; Esser, C. K.; Kath, G. S.; King, G. W.; Uhrig, B. G.; et al. (1999) Tetrahedron Lett., 40, 4477-4480,
Corey et al. (1998) Tetrahedron Lett., 39, 5347-5350,
Domling, A.; Ugi, I. (2000) Angew. Chem., Int. Ed., 39(18), 3168-3210,
Domling, A. (2002) Current Opinion in Chemical Biology, 6(3), 306-313,
Elias, H. G. (1997) An Introduction to Polymer Science; VCH: Weinheim; p 163,
Frank, H.; Hagenmaier, H. (1975) Experientia, 31, 131-133,
Franzen. R. (2000) Canadian Journal of Chemistry, 78(7), 957-962,
Gravert, D. J.; Janda, K. D. (1997) Chem. Rev., 97, 489-509,
Grayson, S. M.; Jayaraman, M.; Fréchet, J. M. (1999) J. Chem. Commun., 1329-1330,
Grieco, P.; Bahsas, A. (1988) Tetrahedron Lett., 29, 5855,
Haag, R. (2001) Chem.-Eur. J., 7, 327-335,
Haag, R.; Hebel, A.; Stumbé, J. F. (2002) In Handbook of Combinatorial Chemistry; Nicolaou, K. C., Hanko, R., Hartwig, W., Eds.; Wiley-VCH: Weinheim; pp 24-58,
Haag, R.; Sunder, A.; Hebel, A.; et Roller, S. (2002) J. Comb. Chem., 4, 112-119,
Haag, R.; Sunder, A.; Stumbé, J.-F. (2000) J. Am. Chem. Soc., 122, 2954-2955,
Han, H.; Janda, K. D. (1997) Angew. Chem., Int. Ed. Engl., 36, 1731-1733,
Han, H.; Wolfe, M. M.; Brenner, S.; Janda, K. D. (1995) Proc. Natl. Acad. Sci. U.S.A., 92, 6419,
Harris, J. M. (1992) In Poly(Ethylene Glycol) Chemistry: Biotechnical and Biomedical Applications; Harris, J. M., Ed.; Plenum Press: New York; p 2,
Hodge, P. (1997) Chem. Soc. Rev., 26, 417-424,
Hovestad, N. J.; Ford, A.; Jastrzebski, J. T. B. H.; van Koten, G. (2000) J. Org. Chem., 65, 6338-6344,
Jayaraman, M.: Fréchet, J. M. J. (1998) J. Am. Chem. Soc., 120, 12996-12997,
Kates, Steven A.; Albericio, Fernando (2000) Solid-Phase Synthesis,
Kim, R. M.; Chang, J. (2000) In Combinatorial Chemistry; Fenniri, H., Ed.; Oxford University Press: Oxford; pp 353-371,
Kim, R. M.; Manna, M.; Hutchins, S. M.; Griffin, P. R.; Yates, N. A.; Bernick, A. M.; Chapman, K. T. (1996) Proc. Natl. Acad. Sci. U.S.A., 93, 10012-10017,
Knischka, R.; Lutz, P.; Sunder, A.; Mülhaupt, R.; Frey, H. (2000) Macromolecules, 33, 315-320,
Lindström Ulf M. (2002) Chem. Rev. 102 (8), 2751-2772,
Meier, S.; Reisinger, H.; Haag, R.; Mecking, S.; Mülhaupt, R.; Stelzer, F. (2001) Chem. Commun. 855-856,
Merrifield, R. B. (1963) J. Am. Chem. Soc., 85, 2149,
Mutter, M.; Baeyer, E. (1974) Angew. Chem., Int. Ed. Engl., 13, 88-89,
Mütter, M.; Bayer, E. (1979) In The Peptides; Academic Press: New York, Vol. 2, p 285,
Mutter, M.; Uhmann, R.; Baeyer, E. (1975) Liebigs Ann. Chem., 901-915,
Nicolaou, K. C.; Hanko, R.; Hartwig, W. (2002) Handbook of Combinatorial Chemistry, Volume 2: Drugs, Catalysts, Materials.
Nicolaou, K. C.; Hanko, R.; Hartwig, W. (2002) Handbook of Combinatorial Chemistry. Volume 1: Drugs, Catalysts, Materials,
O'Donnel, M. J.; Wu, S.; Bennett, W. D. (1989) J. Am. Chem. Soc., 111, 2353,
Ranucci, E.; Spagnoli, G.; Sartore, L.; Ferruti, P.; Caliceti, P.; Schiavon, O.; Veronese, F. (1994) Macromol. Chem. Phys., 195, 3469-3479,
Haag, R.; Sunder, A.; Hebel, A. et Roller, S. (2002) J. Comb. Chem., 4, 112-119,
Reed, N. N.; Janda, K. D. (2000) Org. Lett., 2, 1311-1313,
Reichardt, Christian (1988) Solvents and solvent effects in organic chemistry, Weinheim, Bâle, Suisse; Cambridge; New York, N.Y.: VCH,
Seeberger, P. H.; Haase, W.-C. (2000) Chem. Rev., 100, 4349,
Thompson, L. A.; Ellman, J. A. (1996) Chem. Rev., 96, 555,
Toy, P.; Janda, K. D. (2000) Acc. Chem. Res., 33, 546-554,
Ugi, I.; Domling, A.; Ebert, B. (1999) Combinatorial Chemistry, 125-165,
Ugi, I. (2001) Pure and Applied Chemistry, 73(1), 187-191,
Ugi, I.; Heck, S. (2001) J. Comb. Chem. High Throughput Screening, 4(1), 1-34,
V. Krchnia'k et M., W. Holladay (2002) Chem. Rev. 102, 61-91,
Vanden Eynde, J. J.; Mayence, A. (2000) International Journal of Medicine, Biology and the Environment, 28(1), 89-95,
Wasserscheid, P.; Keim, W. (2000) Ang. Chem. Int. Ed., 39, 3772-3789,
Wellings, D. A.; Williams, A. (1987) React. Polym., 6, 143-157,
Welton, T. (1999) Chem. Rev., 99, 2071-2083,
Wendeborn, S.; Berteina, S.; Brill, K.-D.; De Mesmaeker, A. (1998) Synlett, 6, 671,
Zhou, C.; Emrich, D. E.; Larock, R. C. (2003) Org. Lett., 5, 1579-1582.

1. The use of an onium salt functionalized by at least one organic function, as a soluble support, in the presence of at least one organic solvent, for the organic synthesis of a molecule, in homogeneous phase, by at least one conversion of said organic function, said onium salt allowing the release of the synthesized molecule,
said onium salt being presented in liquid or solid form at ambient temperature, and corresponding to the formula A₁⁺, X₁⁻,
in which:
A₁⁺ represents a cation,
X₁⁻ represents an anion,
A₁⁺ being a functional or polyfunctional cation, and/or
X₁⁻ being a functional or polyfunctional anion,
the onium salt being such that in its initial form, i.e. before the first conversion of said organic function, A₁⁺ and X₁⁻ are not bound together by a covalent bond,
and when the anion and the cation respectively carry an organic function, these cannot react with each other before the first conversion of said organic function.

2. The use according to claim 1, characterized in that the onium salt is purified and/or recycled in its initial form after the release of the synthesized molecule.

3. The use according to claim 1 or 2, characterized in that the functional cations and anions correspond to an ionic entity, cationic Y⁺— and anionic Z⁻— respectively, optionally bound by means of an arm, L and M respectively, in particular an alkyl or aralkyl or alkaryl group comprising 1 to 30 carbon atoms, to at least one function Fᵢ and F′ᵢ respectively, Fᵢ varying from F₀ to Fₙ, F′ᵢ varying from F′₀ to F′ₙ, n being an integer varying from 1 to 10,
the functional cation A₁⁺ being able to be represented in the form Y⁺-L-Fᵢ, and
the functional anion X₁⁻ in the form Z⁻-(M)ₖ-F′ᵢ, k being equal to 0 or 1.

4. The use according to any one of claims 1 to 3, characterized in that the organic functions Fᵢ and F′ᵢ are chosen from the standard functions of organic chemistry, such as the hydroxyl functions, carboxylic acid, amide, sulphone, primary amine, secondary amine, aldehyde, ketone, ethenyl, ethynyl, dienyl, ether, epoxide, phosphine (primary, secondary or tertiary), azide, imine, ketene, cumulene, heterocumulene, thiol, thioether, sulphoxide, phosphorated groups, heterocycles, sulphonic acid, silane, stannane or functional aryl.

5. The use according to any one of claims 1 to 4, characterized in that the molecular weight of the functionalized onium salt is less than 1500 g·mol⁻¹, in particular less than 750 g·mol⁻¹, and is preferably comprised from 130 to 500 g·mol⁻¹.

6. The use according to any one of claims 1 to 5, characterized in that A₁⁺ is a functional cation and in that X₁⁻ is a non-functional anion.

7. The use according to claim 6, in which the onium salt A₁⁺, X₁⁻ has as its initial form Y⁺-L-F₀, X₁⁻, for obtaining a molecule G, by conversion of said initial function F₀ according to the diagram
Y⁺-L-F₀,X₁⁻→Y⁺-L-F₁,X₁⁻→ . . . →Y⁺-L-Fₙ,X₁⁻
L being as defined in claim 3,
said molecule G being obtained by cleavage of the function Fₙ,
and the functionalized onium salt being able to be recovered or recycled in its initial form Y⁺-L-F₀, X₁⁻, after the release of G.

8. The use according to any one of claims 1 to 7, characterized in that the functional cation A₁⁺ is chosen from the pyridinium, imidazolium, ammonium, phosphonium or sulphonium cations, cyclic or non-cyclic, substituted or non-substituted, and preferably ammonium or phosphonium.

9. The use according to claim 8, characterized in that the functional cation A₁⁺ is chosen from the quaternary ammonium cations, cyclic or non-cyclic.

10. The use according to any one of claims 1 to 5, characterized in that X₁⁻ is a functional anion and A₁⁺ is a non-functional cation.

11. The use according to claim 10, in which the onium salt A₁⁺, X₁⁻ has as its initial form A₁⁺, Z⁻-(M)ₖ-F′₀, for obtaining a molecule G, by conversion of said initial function F′₀ according to the diagram
A₁⁺,Z⁻-(M)ₖ-F′₀→A₁⁺,Z⁻-(M)ₖ-F′ᵢ→ . . . →A₁⁺,Z⁻-(M)ₖ-F′ₙ
k and M being as defined in claim 3,
said molecule G being obtained by cleavage of the function F′ₙ,
and the functionalized onium salt being able to be recovered or recycled in its initial form A₁⁺, Z⁻-(M)ₖ-F′₀, after the release of G.

12. The use according to claim 10 or 11, characterized in that X₁⁻ is chosen from:
the family of the phosphates: R₁PO₄²⁻, R₁R₂PO₄⁻,
the family of the sulphates: R₁SO₄⁻,
the family of the sulphonates: R₁SO₃⁻,
the family of the carboxylates: R₁CO₂⁻,
or from the following anions: 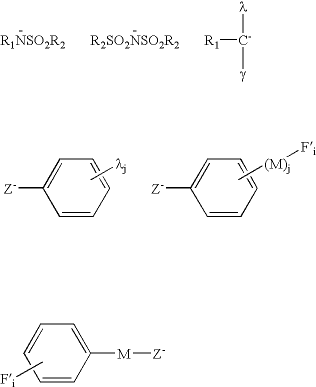
Z⁻, M and F′ᵢ being as defined in claim 3, Z⁻ representing in particular O⁻, SO₃⁻, CO₂⁻, R₁PO₃⁻ or R₁PO₂⁻,
j representing an integer comprised from 1 to 5,
R₁ and R₂ being able to represent independently of one another a functional alkyl group, a vinyl or alkynyl group, optionally functional, comprising from 1 to 20 carbon atoms, or being able to represent a functional aryl group comprising from 6 to 30 carbon atoms,
γ and λ representing an electroattractive group, in particular chosen from the groups: CO₂R′, SO₂R′, CN, NO₂, P(O)(OR′)₂, C(O)R′ and SO₃R′,
R′ representing an alkyl group, optionally functional, comprising from 1 to 20 carbon atoms, or an aryl group, optionally functional, comprising from 6 to 30 carbon atoms.

13. The use according to any one of claims 1 to 5, characterized in that A₁⁺ is a functional cation and X₁⁻ is a functional anion.

14. The use according to claim 13, in which the onium salt A₁⁺, X₁⁻ has as its initial form Y⁺-L-F₀, Z⁻-(M)ₖ-F′₀, for obtaining a molecule G, by conversion of said initial functions F₀ and F′₀ according to the diagram
Y⁺-L-F₀,Z⁻-(M)ₖ-F′₀→Y⁺-L-Fᵢ,Z⁻-(M)ₖ-F′ᵢ→ . . . →Y⁺-L-Fₙ,Z⁻-(M)ₖ-F′ₙ
L, k and M being as defined in claim 3,
and by reaction of Fₙ on F′ₙ in the functionalized onium salt Y⁺-L-Fₙ, Z⁻-(M)ₖ-F′ₙ
leading to the formation of an internal salt of formula:
Y⁺-L-Fₙ₊₁-F′ₙ₊₁-(M)ₖ-Z⁻
said molecule G being obtained by cleavage of the abovementioned internal salt and corresponding to the formula Fₙ₊₂-F′ₙ₊₂,
and the functionalized onium salt being able to be recovered or recycled in its initial form Y⁺-L-F₀, Z⁻-(M)ₖ-F′₀, after the release of G.

15. The use according to any one of claims 1 to 14, characterized in that the onium salt is chosen from the following salts: 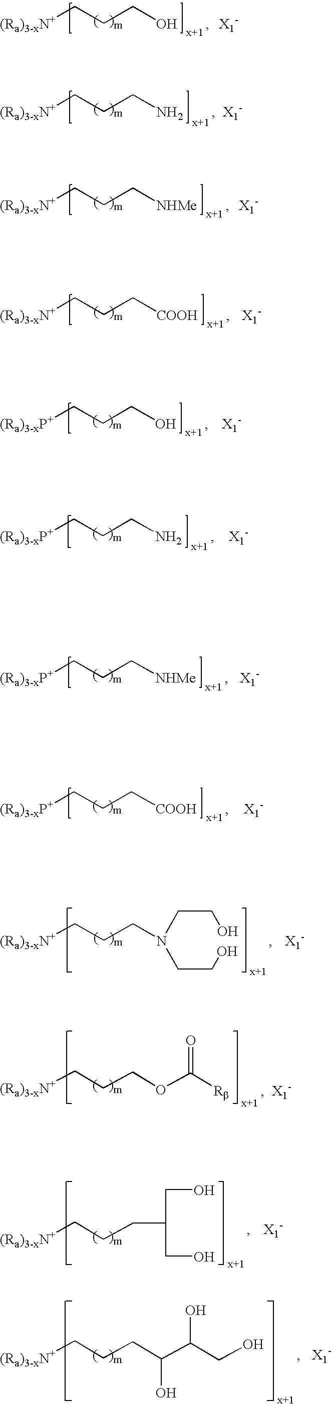 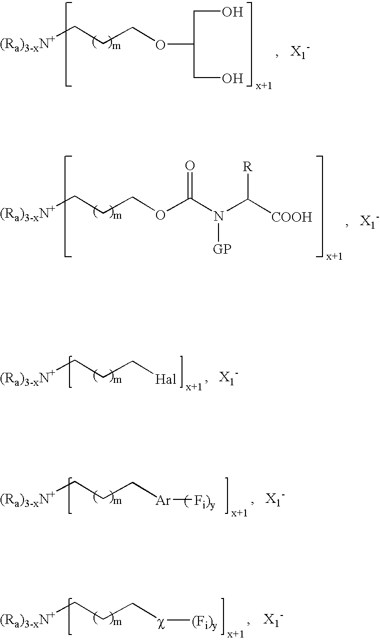
R representing a hydrogen atom, an alkyl group, functional or non-functional, comprising from 1 to 20 carbon atoms, or an aryl group, functional or non-functional, comprising from 6 to 30 carbon atoms,
x representing an integer comprised from 0 to 3,
y representing an integer comprised from 1 to 5,
Ar representing a functional or polyfunctional aromatic ring,
Fᵢ being as defined in claim 4,
Hal representing a halogen atom, in particular chosen from chlorine, bromine and iodine,
λ representing a carbocycle or a functional heterocycle,
X₁⁻ being chosen from: NTf₂⁻, PF₆⁻, BF₄⁻, Cl⁻, Br⁻, I⁻, CF₃SO₃⁻, MeSO₄⁻, EtSO₄⁻, MeSO₃⁻, C₆H₅SO₃⁻, pMeC₆H₄SO₃⁻,
m being an integer comprised from 0 to 20,
R_{β} representing a dienyl, vinyl group, substituted or non-substituted, functional alkyl comprising from 1 to 20 carbon atoms, or functional aryl comprising from 6 to 30 carbon atoms, substituted or non-substituted alkynyl, and being in particular an alkylvinyl, alkylalkynyl, alkylaryl, alkyldienyl, alkylmalonyl, acyl group,
and Rₐ representing a branched or non-branched alkyl group comprising from 1 to 20 carbon atoms, in particular an ethyl, propyl, butyl, pentyl, hexyl, heptyl or octyl group.

16. The use according to any one of claims 1 to 15, characterized in that the solvent(s) used is/are a solvent aprotic, chosen from:
solvents the dielectric constant 8 of which is less than or equal to 2, such as the alkanes, the aromatic carbides such as benzene, toluene or xylene,
solvents the dielectric constant ε of which is comprised between approximately 2 and 15, such as the ethers, halogenobenzenes or dichloromethane, and
solvents the dielectric constant ε of which is greater than 15, such as acetonitrile, nitromethane, DMF or dimethylacetamide.

17. The use according to any one of claims 1 to 16, for continuous, discontinuous, combinatorial or parallel organic synthesis, and/or for the preparation of banks of products.

18. The use according to any one of claims 1 to 17, for the implementation of cycloaddition reactions, preferably for the implementation of the Diels-Alder reaction, according to one of the following reaction diagrams: 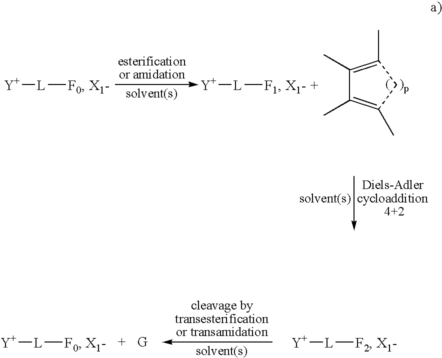
p being an integer varying from 0 to 2,
Y⁺— representing an onium cation as defined in one of claims 3 to 17, and preferably being a trimethylalkylammonium, triethylalkylammonium, tributylalkylphosphonium, N-methylimidazolium or pyridinium cation,
L representing an arm, in particular a linear or branched alkyl group comprising from 1 to 20 carbon atoms, or an optionally functional aralkyl or alkaryl group, comprising from 6 to 30 carbon atoms, and preferably being a linear alkyl group, preferably a linear alkyl group of type (CH₂)ᵣ, r varying from 1 to 20, and preferably from 2 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄⁻³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
the functions F₀, F₁ and F₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 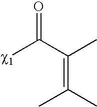
λ₁ being as defined above,
F₂ corresponds to the following formula: 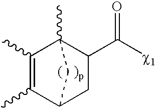
λ₁ being as defined above,
G corresponding to the following formula: 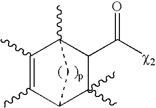
in which λ₂ represents either an OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms, 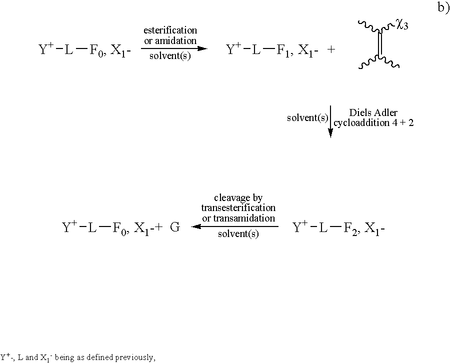
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, or a mixture of these solvents,
the functions F₀, F₁ and F₂ being as defined below:
F₀ represents any function making it possible to attach a 1,3-diene, and is in particular chosen from the carbonyl, amine, alkoxy, silane, stannane and borane functions, comprising from 1 to 20 carbon atoms,
F₁ corresponds to the following formula: 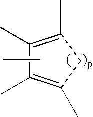
p being an integer varying from 0 to 2,
F₂ corresponds to the following formula: 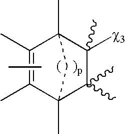
λ₃ representing an electroattractive group, in particular chosen from the cyano, alkoxycarbonyl groups, comprising from 1 to 20 carbon atoms, acyl comprising from 2 to 20 carbon atoms, benzoyl, sulphonyl, dialkoxyphosphonyl comprising from 1 to 10 carbon atoms,
G corresponding to the following formula: 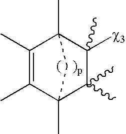
λ3 being as defined above. 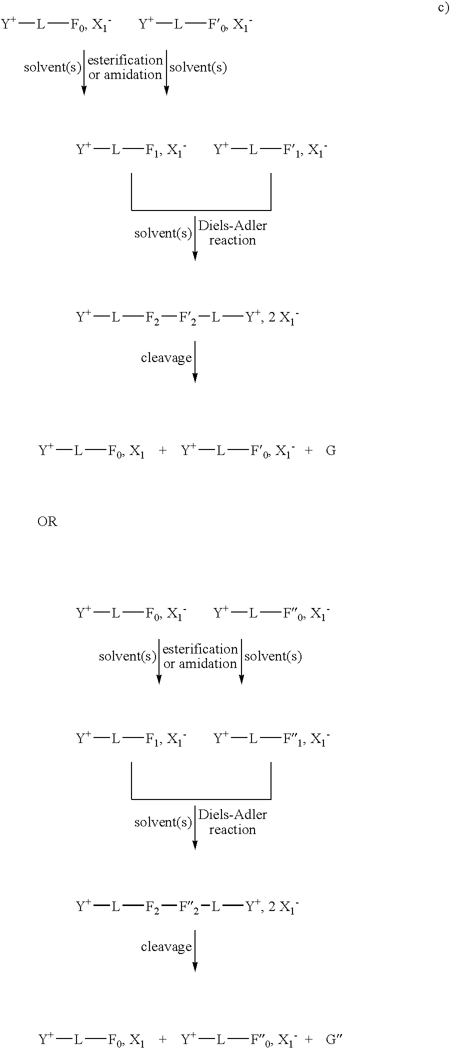
Y⁺—, L and X₁⁻ being as defined previously,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
the functions F₀, F′₀, F″₀, F₁, F′₁, F″₁, F₂, F′₂ and F″₂ being as defined below:
F₀ and F′₀ correspond respectively to a −λ₁H and −λ′₁H group, in which λ₁ and λ′₁, identical or different, represent an oxygen atom or an —NR_{f} group, R_{f} corresponding to a linear or branched alkyl group, comprising from 1 to 20 carbon atoms, or an aryl group comprising from 6 to 30 carbon atoms,
F″₀ corresponds to a —COOH function;
F₁ corresponds to the following formula: 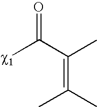
λ₁ being as defined above,
F′ᵢ corresponds to the following formula: 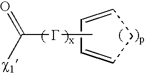
p being an integer varying from 0 to 2,
λ′₁ being as defined above,
x being equal to 0 or 1,
Γ representing an alkyl chain comprising from 1 to 30 carbon atoms, alkaryl, aralkyl, aryl comprising from 6 to 30 carbon atoms,
F′₁ corresponds to the following formula: 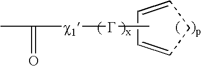
p, x and Γ being as defined above,
λ′₁ being as defined above,
F₂—F′₂ corresponds to the following formula: 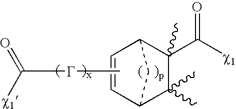
p, λ₁, λ′₁, x and Γ being as defined above,
F₂—F″₂ corresponds to the following formula: 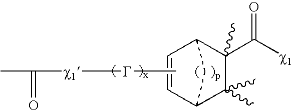
p, λ₁, λ′₁, x and Γ being as defined above,
G corresponds to the following formula: 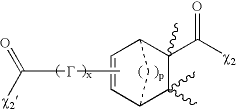
G″ corresponds to the following formula: 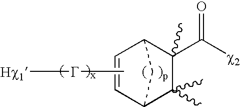
λ₂ and λ′₂, identical or different, represent either an OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms.

19. The use according to any one of claims 1 to 17, for the implementation of coupling reactions such as the Heck, Suzuki, Sonogashira or Ullmann reactions.

20. The use according to claim 19 for the implementation of the Heck reaction, according to one of the following reaction diagrams: 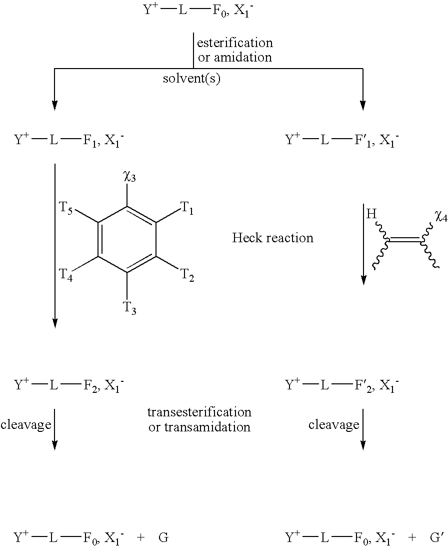
Y⁺— representing an onium cation as defined in one of claims 3 to 17, and preferably being a trimethylalkylammonium, triethylalkylammonium, tributylalkylphosphonium, N-methylimidazolium or pyridinium,
L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 2 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
the functions F₀, F₁, F′₁, F₂ and F′₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to one of the following formulae: 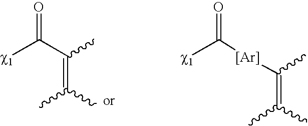
λ₁ being as defined above,
[Ar] representing an aromatic ring, optionally substituted by a linear or branched alkyl group, comprising from 1 to 20 carbon atoms or an aryl group comprising from 6 to 30 carbon atoms, or a functional group in particular chosen from NO₂, CN, COOR, OR, COR, NHCOR, NRR′, SO₂R, I, Br, R and R′ representing independently of one another an alkyl group comprising from 1 to 20 carbon atoms or an aryl group comprising from 6 to 30 carbon atoms, [Ar] preferably corresponding to the following formula: 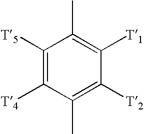
in which T′₁, T′₂, T′₄ and T′₅ represent independently of one another a hydrogen atom, a linear or branched alkyl group, comprising from 1 to 20 carbon atoms or an aryl group comprising from 6 to 30 carbon atoms, or a functional group in particular chosen from NO₂, CN, COOR, OR, COR, NHCOR, NRR′, SO₂R, I, Br, R and R′ representing independently of one another an alkyl group comprising from 1 to 20 carbon atoms or an aryl group comprising from 6 to 30 carbon atoms,
F₂ corresponds to one of the following formulae: 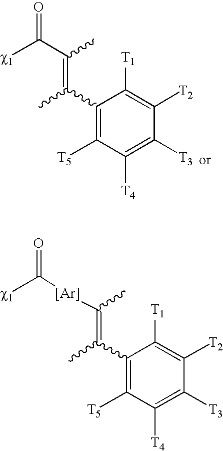
λ₁ and Ar being as defined above, T₄
T₁, T₂, T₃, T₄ and T₅ corresponding to the definition given above for T′₁, T′₂, T′₄ and T′₅
G corresponding to one of the following formulae: 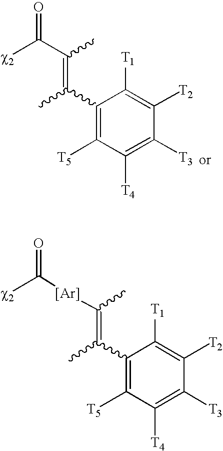
in which λ₂ represents either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms,
λ₃ representing a leaving group, in particular chosen from the I, Cl and Br halides, the mesylate, tosylate, triflate, sulphonate, sulphate or phosphate groups,
the entity 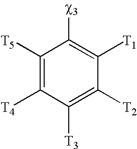
representing in particular the following groups: 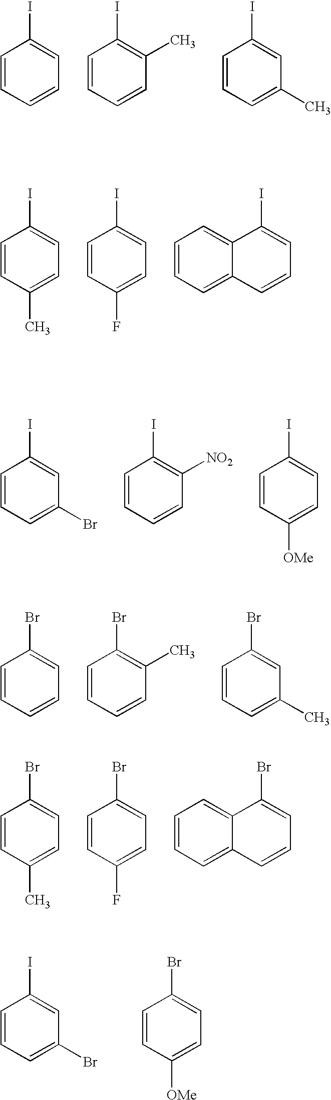
F′₁ corresponds to the following formula: 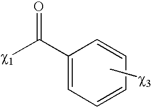
λ₁ and λ₃ being as defined above,
F′₂ corresponds to the following formula: 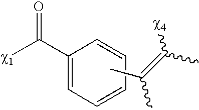
λ₁ being as defined above,
λ₄ representing a functional group of ester, amide, sulphone, phosphonate, silane, borane type, or a functional or non-functional alkyl group, comprising from 1 to 20 carbon atoms, or a functional or non-functional aryl group, comprising from 6 to 30 carbon atoms,
G′ corresponding to the following formula: 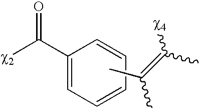
λ₂ and λ₄ being as defined above.

21. The use according to claim 19 for the implementation of Suzuki coupling, according to one of the following reaction diagrams: 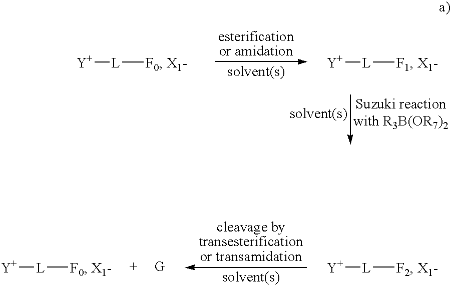
R₃ being chosen from the aryl, heteroaryl, ethenyl, dienyl, allyl, ethynyl groups, substituted or non-substituted, comprising from 2 to 30 carbon atoms,
R₇ representing a hydrogen atom or a branched or linear alkyl group, or a cycloalkyl group comprising from 1 to 12 carbon atoms,
Y⁺— representing an onium cation as defined in one of claims 3 to 17, and preferably being a trimethylalkylammonium, triethylalkylammonium, tributylalkylphosphonium, N-methylimidazolium or pyridinium cation,
L representing an arm, in particular a linear or branched alkyl group comprising from 1 to 20 carbon atoms, or an optionally functional aralkyl group comprising from 6 to 30 carbon atoms, and preferably being a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
the functions F₀, F₁, and F₂ being as defined below:
F₀ is in the form −λ₁H, λ₁ representing an oxygen atom or an —NR_{f} group, R_{f} corresponding to a linear or branched alkyl group, comprising from 1 to 20 carbon atoms, or an aryl group comprising from 6 to 30 carbon atoms,
F₁ is in the form —Rₑ−λ, Rₑ representing an aromatic or heteroaromatic group comprising from 6 to 30 carbon atoms, λ representing a leaving group preferably chosen from Cl, Br, I, OTf, O—CO₂R⁵ or OSO₃—R⁵, R⁵ representing an alkyl group comprising from 1 to 10 carbon atoms or an aralkyl group comprising from 6 to 30 carbon atoms, F₁ preferably corresponding to the following formula: 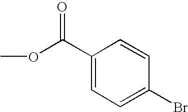
F₂ is in the form —Rₑ—R₂, Rₑ being as defined above and R₂ being chosen from the aryl, heteroaryl, ethenyl, dienyl, allyl, ethynyl groups, substituted or non-substituted, comprising from 2 to 30 carbon atoms, F₂ preferably corresponding to the following formula: 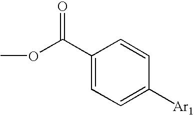
Ar₁ representing an aromatic group preferably chosen from: 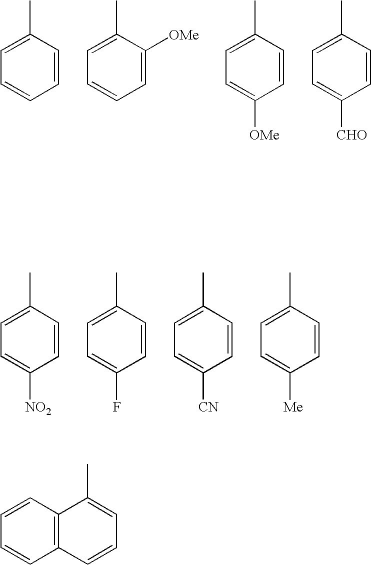
the molecule G being in the form R₂—R₃, R₂ and R₃ being as defined above, and corresponding in particular to the following formula: 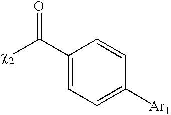
in which λ₂ represents either an —OR_{g} group, R_{g} representing a hydrogen atom or an alkyl group comprising from to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms,
Ar₁ is as defined above, 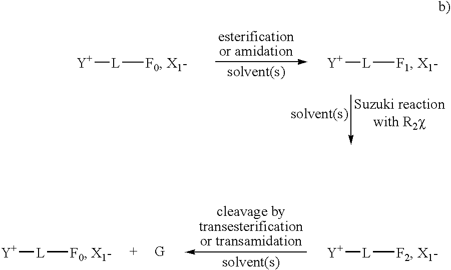
Y⁺— representing an onium cation as defined in one of claims 3 to 17, and preferably being a trimethylallylammonium, triethylalkylammonium, tributylalkylphosphonium, N-methylimidazolium or pyridinium cation,
L representing an arm, in particular a linear or branched alkyl group comprising from 1 to 20 carbon atoms, or an optionally functional aralkyl group comprising from 6 to 30 carbon atoms, and preferably being a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
R₂ being chosen from the aryl, heteroaryl, ethenyl, dienyl, allyl, ethynyl groups, substituted or non-substituted, comprising from 2 to 30 carbon atoms,
the functions F₀, F₁, and F₂ being as defined below:
F₀ is in the form −λ₁H, λ₁ being as defined above,
F₀ is in the form —R_{q}—B(OR₇)₂, R₇ being as defined above, and R_{q} corresponding to an aryl group comprising from 6 to 30 carbon atoms, heteroaryl comprising from 4 to 20 carbon atoms, ethenyl comprising from 2 to 20 carbon atoms, dienyl comprising from 3 to 20 carbon atoms, allyl comprising from 3 to 20 carbon atoms, ethynyl comprising from 2 to 20 carbon atoms, substituted or non-substituted, F₁ preferably corresponding to the following formula: 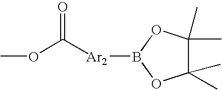
Ar₂ corresponding to an aryl group, substituted or non-substituted, comprising from 6 to 30 carbon atoms,
F₂ is in the form —R_{q}—Rₑ, R_{q} and Rₑ being as defined above, F₂ preferably corresponding to the following formula: 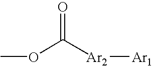
Ar₁ representing an aromatic group preferably chosen from: 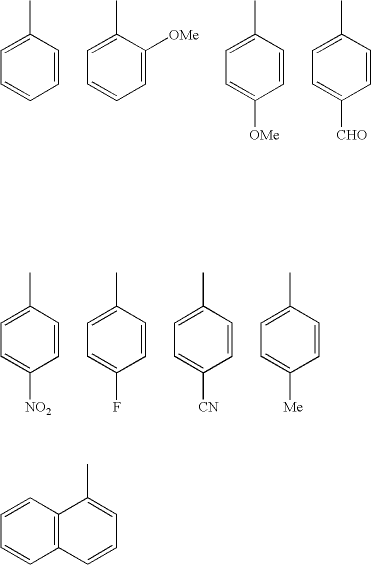
the molecule G being in the form R₂—R₃, R₂ and R₃ being as defined above, and corresponding in particular to the following formula: 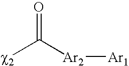
in which λ₂: Ar₁ and Ar₂ are as defined above, 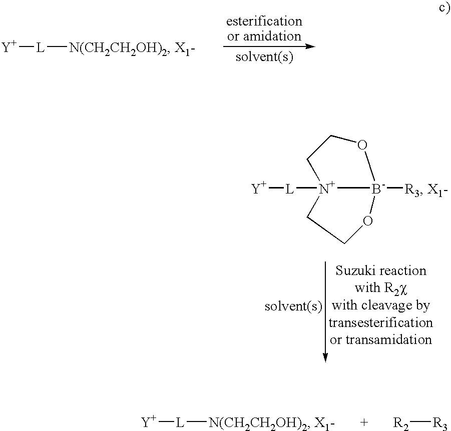
Y⁺—, L, X₁⁻, R₂ and R₃ being as defined above,
R₃ preferably being a phenyl group,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents, 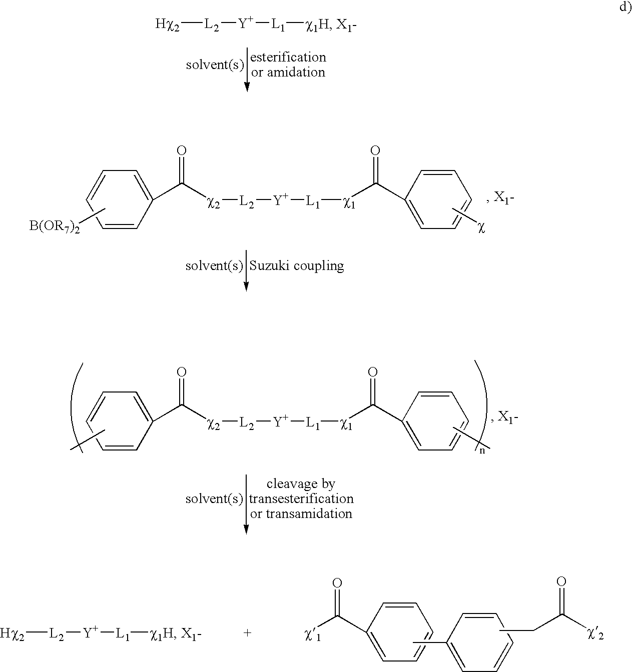
n representing an integer comprised between 1 and 50,
Y⁺— representing an onium cation as defined in one of claims 3 to 17, and preferably being a trimethylalkylammonium, triethylalkylammonium, tributylalkylphosphonium, N-methylimidazolium or pyridinium cation,
L₁ and L₂ representing an arm, identical or different, in particular a linear or branched alkyl group comprising from 1 to 20 carbon atoms, or an optionally functional aralkyl group comprising from 6 to 30 carbon atoms, and preferably being a linear alkyl group preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms, the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
λ₁ and λ₂, identical or different, representing an oxygen atom or an —NR_{f} group, R_{f} corresponding to a linear or branched alkyl group, comprising from 1 to 20 carbon atoms, or an aryl group comprising from 6 to 30 carbon atoms,
λ representing a leaving group preferably chosen from Cl, Br, I, OTf, O—CO₂R⁵ or OSO₃—R⁵, R⁵ representing an alkyl group comprising from 1 to 10 carbon atoms or an aralkyl group comprising from 6 to 30 carbon atoms,
R₇ representing a hydrogen atom, a branched or non-branched alkyl group, or cycloalkyl, comprising from 1 to 12 carbon atoms, or an aryl group, comprising from 6 to 30 carbon atoms,
λ′₁ and λ′₂, identical or different, representing either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms.

22. The use according to claim 19 for the implementation of Sonogashira coupling, according to one of the following reaction diagrams: 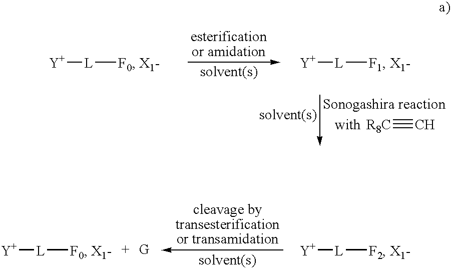
Y⁺— representing an onium cation as defined in one of claims 3 to 17, and preferably being a trimethylalkylammonium, triethylalkylammonium, tributylalkylphosphonium, N-methylimidazolium or pyridinium cation,
L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
R₈ representing an ORₕ, NRₕRᵤ, CORₕ, CN, SO₂Rₕ, SRₕ, group, an alkenyl, ethynyl, dienyl group, Rₕ and Rᵤ representing, independently of one another, a hydrogen atom, an alkyl group comprising from 1 to 20 carbon atoms or an aryl group comprising from 6 to 30 carbon atoms,
or R₈ representing an alkyl group, branched or linear, optionally functional, comprising from 1 to 20 carbon atoms, or an aryl group, or an alkaryl or aralkyl group, comprising from 6 to 30 carbon atoms, substituted or non-substituted, said alkyl or aryl groups being able to be substituted by one of the following functional groups: a halogen atom, in particular Cl, an ORₕ, NRₕRᵤ, CORₕ, CN, SO₂Rₕ, SRₕ group, an alkenyl, ethynyl, dienyl, vinyl, alkynyl group, Rₕ and Rᵤ being as defined previously,
R₈ being in particular one of the following groups:
—(CH₂)ₛ—CH₃, —(CH₂)ₛ—CH₂OH, —(CH₂)ₛ—CH₂OMe,
s representing an integer comprised between 0 and 10, 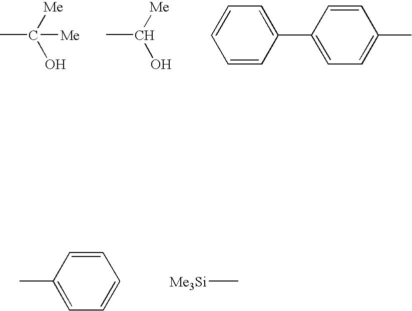
the functions F₀, F₁, and F₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 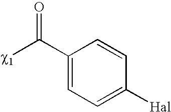
λ₁ being as defined above, and Hal representing a halogen, and preferably being iodine,
F₂ corresponds to the following formula: 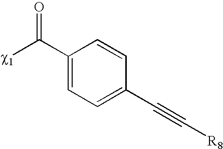
λ₁ and R₈ being as defined above,
G corresponding to the following formula: 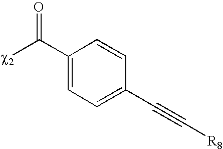
in which λ₂ represents either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms, λ₂ representing in particular an OMe, OEt, OPr or OBu group. 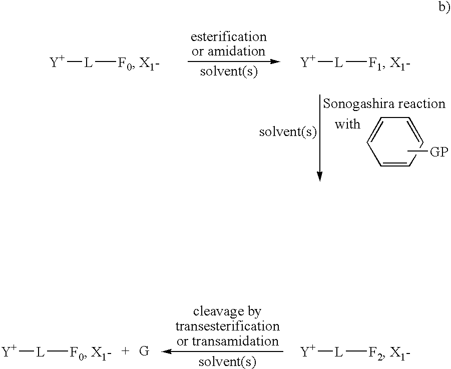
Y⁺— representing an onium cation as defined in one of claims 3 to 17, and preferably being a trimethylalkylammonium, triethylalkylammonium, tributylalkylphosphonium, N-methylimidazolium, alkylpyridinium, dimethylalkylsulphonium or diethylalkyl-sulphonium cation,
L representing an arm, in particular a linear or branched alkyl group comprising from 1 to 20 carbon atoms, or an optionally functional aralkyl or alkaryl group, comprising from 1 to 20 carbon atoms, and preferably being, a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
GP representing a leaving group, and being in particular Cl, Br, I or OTf,
the functions F₀, F₁, and F₂ being as defined below:
F₀ corresponds to a —COOH group,
F₁ corresponds to the following formula: 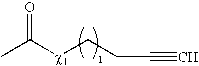
in which l represents an integer varying from 1 to 20, and λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₂ corresponds to the following formula: 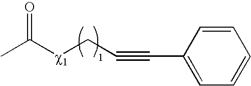
λ₁ and l being as defined above,
G corresponding to the following formula: 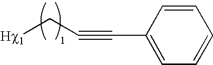
in which λ₁ and l are as defined above.

23. The use according to any one of claims 1 to 17, for the implementation of the Baylis-Hilman reaction, according to one of the following reaction diagrams: 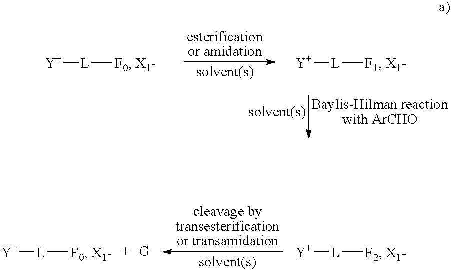
Y⁺— representing an onium cation as defined in one of claims 3 to 17, and preferably being a trimethylalkylammonium, triethylalkylammonium, tributylalkylphosphonium, N-methylimidazolium or pyridinium cation,
L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
the functions F₀, F₁, and F₂ being as defined below:
F₀ represents an —OH group,
F₁ corresponds to the following formula: 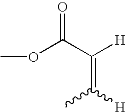
F₂ corresponds to the following formula: 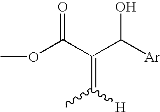
G corresponding to the following formula: 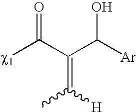
λ₁ representing an —OH group, or an —OR_{g} group, R_{g} representing a linear or branched alkyl group, comprising from 1 to 20 carbon atoms,
Ar representing an aromatic or heteroaromatic group, substituted or non-substituted,
ArCHO being in particular chosen from: 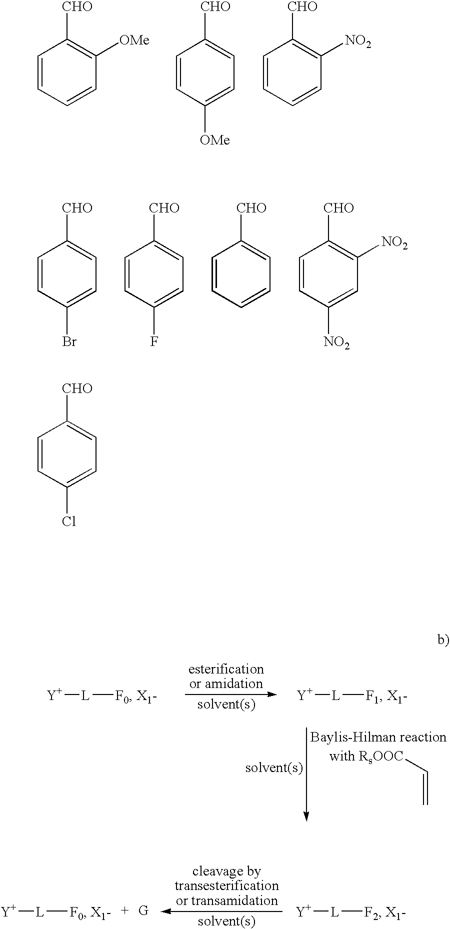
Y⁺— representing an onium cation as defined in one of claims 3 to 17, and preferably being a trimethylalkylammonium, triethylalkylammonium, tributylalkylphosphonium, N-methylimidazolium, alkylpyridinium, dimethylalkylsulphonium or diethylalkyl-sulphonium cation,
L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
Rₛ representing a hydrogen atom or an alkyl group comprising from 1 to 20 carbon atoms or aralkyl or alkaryl comprising from 7 to 30 carbon atoms,
the functions F₀, F₁ and F₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 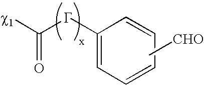
λ₁ being as defined above,
x being equal to 0 or 1,
Γ representing an alkyl chain comprising from 1 to 20 carbon atoms, alkaryl, aralkyl comprising from 6 to 30 carbon atoms,
F₂ corresponds to the following formula: 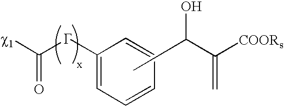
λ₁, x, R, and Γ being as defined above
G corresponding to the following formula: 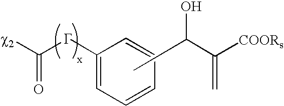
λ₂, x, Rₛ and Γ being as defined above
in which λ₂ represents either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms, λ₂ representing in particular an OMe, OEt, OPr or OBu group. 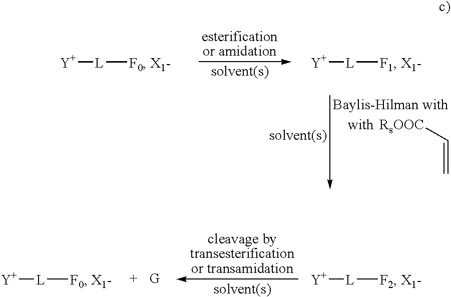
Y⁺— representing an onium cation as defined in one of claims 3 to 17, and preferably being a trimethylalkylammonium, triethylalkylammonium, tributylalkylphosphonium, N-methylimidazolium or pyridinium cation,
L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
Rₛ representing a hydrogen atom or an alkyl group comprising from 1 to 20 carbon atoms or aralkyl or alkaryl comprising from 7 to 30 carbon atoms,
the functions F₀, F₁, and F₂ being as defined below:
F₀ corresponds to a —COλ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 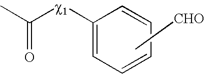
F₂ corresponds to the following formula: 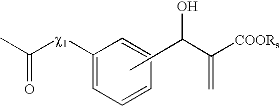
G corresponding to the following formula:

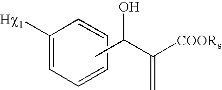

24. The use according to any one of claims 1 to 17, for the synthesis, optionally asymmetrical, of α-amino acids, according to the following reaction diagram: 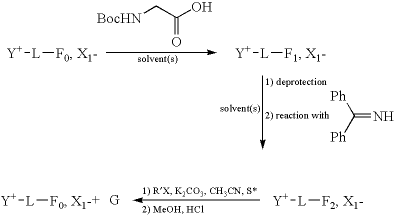
Y⁺— representing an onium cation as defined in one of claims 3 to 17, and preferably being a trimethylalkylammonium, triethylalkylammonium or tributylalkylphosphonium cation,
L representing an arm, in particular a linear or branched alkyl group comprising from 1 to 20 carbon atoms, or an optionally functional aralkyl group comprising from 1 to 20 carbon atoms, and preferably being a linear alkyl group, preferably a linear alkyl group of type (CH₂)ᵣ, r varying from 1 to 20, and preferably from 3 to 6,
X₁⁻ being as defined in one of claims 1 to 17, and being in particular Cl⁻, Br⁻, I⁻, ⁻N(SO₂CF₃)₂, BF₄⁻, PF₆⁻,
the solvent or solvents being chosen from: acetonitrile, dichloromethane, tetrahydrofuran, dioxane, toluene, chlorobenzene or a mixture of these solvents,
R′ representing a linear or branched alkyl group, comprising from 1 to 30 carbon atoms, optionally functional,
S* representing a chiral phase transfer agent such as O(9)-allyl-N-9-anthracenyl-methylcinchonidinium bromide,
the functions F₀, F₁ and F₂ being as defined below:
F₀ corresponds to —OH,
F₁ corresponds to the following formula: 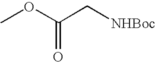
F₂ corresponds to the following formula: 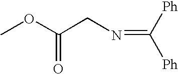
G corresponding to the following formula:

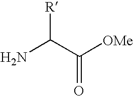

25. The use according to any one of claims 1 to 17, for the implementation of multi-component reactions, in particular for the Grieco-type reaction according to one of the following reaction diagrams: 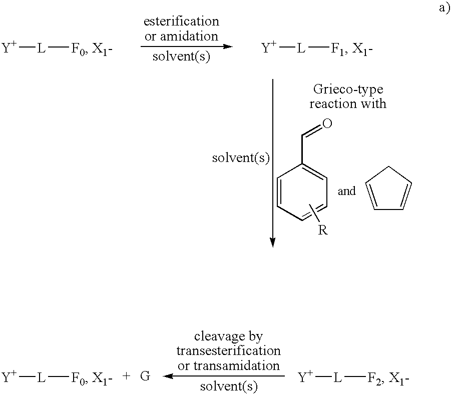
Y⁺— representing an onium cation as defined in one of claims 3 to 17, and preferably being a trimethylalkylammonium, triethylalkylammonium, tributylalkylphosphonium, N-methyl-N′-alkylimidazolium, N-alkylpyridinium, dimethylalkylsulphonium or diethylalkylsulphonium cation,
L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
R representing a hydrogen atom, a nitro group in para position, a chlorine atom in para position or a methoxy group in ortho position,
the functions F₀, F₁ and F₂ being as defined below:
F₀ represents an —OH group,
F₁ corresponds to the following formula: 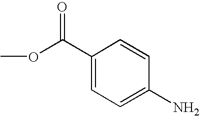
F₂ corresponds to the following formula: 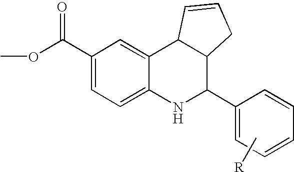
G corresponding to the following formula: 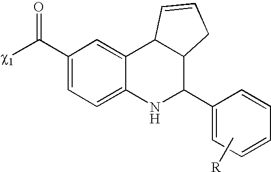
λ₁ representing an —OH group, or an —OR_{g} group, R_{g} representing a linear or branched alkyl group, comprising from 1 to 20 carbon atoms, 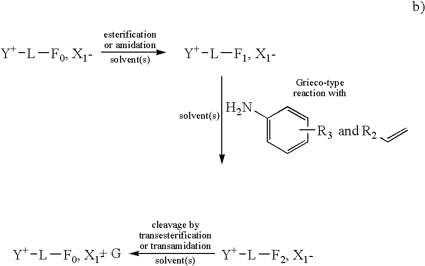
Y⁺— representing an onium cation as defined in one of claims 3 to 17, and preferably being a trimethylalkylammonium, triethylalkylammonium, tributylalkylphosphonium, N-methyl-N′-alkylimidazolium, N-alkylpyridinium, dimethylalkylsulphonium or diethylalkylsulphonium cation,
L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
R₂ representing a functional or non-functional alkyl group, comprising from 1 to 20 carbon atoms, or a functional or non-functional aryl group, comprising from 6 to 30 carbon atoms, or an aralkyl or alkaryl group, functional or non-functional, comprising from 7 to 50 carbon atoms,
R₃ representing a hydrogen atom, a linear or branched alkyl group, comprising from 1 to 20 carbon atoms or an aryl group comprising from 6 to 30 carbon atoms, or an aralkyl or alkaryl group, functional or non-functional, comprising from 7 to 50 carbon atoms, or a functional group in particular chosen from NO₂, CN, COOR, OR, COR, NHCOR, NRR′, SO₂R, I, Br, R and R′ representing independently of one another an alkyl group comprising from 1 to 20 carbon atoms or an aryl group comprising from 6 to 30 carbon atoms,
the functions F₀, F₁, and F₂ being as defined below:
F₀ represents an —OH group,
F₁ corresponds to the following formula: 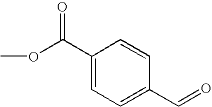
F₂ corresponds to the following formula: 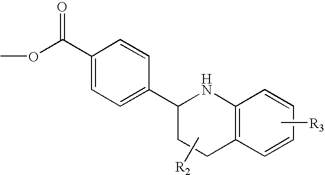
G corresponding to the following formula: 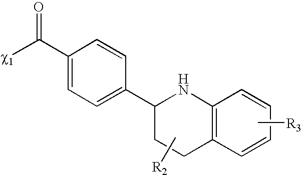
λ₁ representing an —OH group, or an —OR_{g} group, R_{g} representing a linear or branched alkyl group, comprising from 1 to 20 carbon atoms. 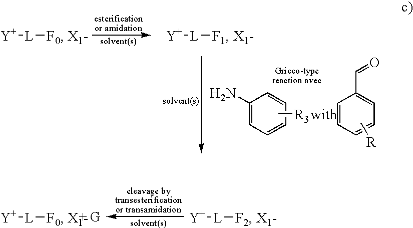
Y⁺— representing an onium cation as defined in one of claims 3 to 17, and preferably being a trimethylalkylammonium, triethylalkylammonium, tributylalkylphosphonium, N-methyl-N′-alkylimidazolium, N-alkylpyridinium, dimethylalkylsulphonium or diethylalkylsulphonium cation,
L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
R representing a hydrogen atom or a functional group such as a nitro group in para position, a chlorine atom in para position or a methoxy group in ortho position, or a functional or non-functional alkyl group, comprising from 1 to 20 carbon atoms, or a functional or non-functional aryl group, comprising from 6 to 30 carbon atoms, or an aralkyl or alkaryl group, functional or non-functional, comprising from 7 to 50 carbon atoms,
R₃ representing a hydrogen atom, a linear or branched alkyl group, comprising from 1 to 20 carbon atoms or an aryl group comprising from 6 to 30 carbon atoms, or an aralkyl or alkaryl group, functional or non-functional, comprising from 7 to 50 carbon atoms, or a functional group in particular chosen from NO₂, CN, COOR, OR, COR, NHCOR, NRR′, SO₂R, I, Br, R and R′ representing independently of one another an alkyl group comprising from 1 to 20 carbon atoms or an aryl group comprising from 6 to 30 carbon atoms,
the functions F₀, F₁, and F₂ being as defined below:
F₀ represents any function making it possible to attach and release a radical carrying an olefin, preferably an ester, or an amide.
F₁ corresponds to one of the following general formulae: 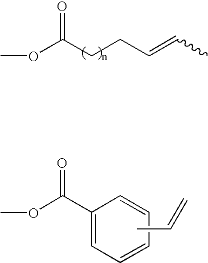
n representing an integer varying from 1 to 10
F₂ corresponds to one of the following general formulae: 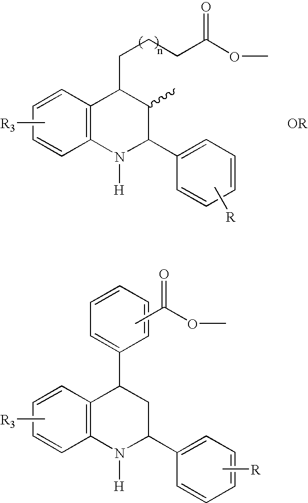
G corresponding to one of the following general formulae: 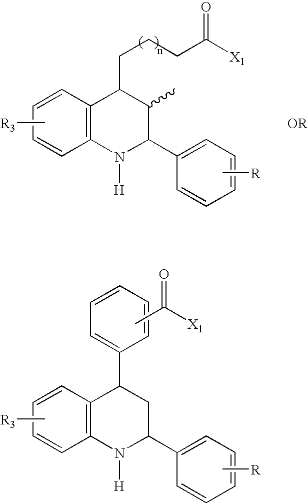
n, R and R₃ being as defined above, and
λ₁ representing an —OH group, or an —OR_{g} group, R_{g} representing a linear or branched alkyl group, comprising from 1 to 20 carbon atoms.

26. The use according to any one of claims 1 to 17, for the implementation of multi-component reactions, in particular for the synthesis of tetrasubstituted olefins, according to the following reaction diagram: 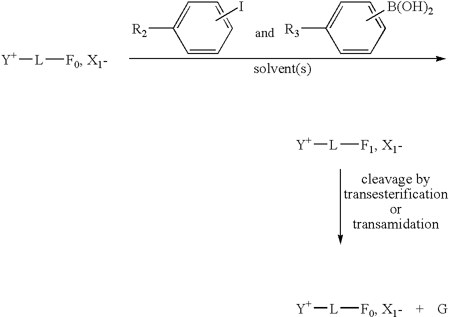
Y⁺— representing an onium cation as defined in one of claims 3 to 17, and preferably being a trimethylalkylammonium, triethylalkylammonium, tributylalkylphosphonium, N-methyl-N′-alkylimidazolium, N-alkylpyridinium, dimethylalkylsulphonium or diethylalkylsulphonium cation,
L representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 1 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄, SbF₆, R₁SO₃, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
R₂ and R₃, preferably in para position, representing a hydrogen atom, a linear or branched, optionally functional alkyl group comprising from 1 to 30 carbon atoms, an optionally substituted and/or functional aryl group, comprising from 6 to 30 carbon atoms, a functional group, preferably a methoxy, mono-alkylamino, dialkylamino, arylamino, cyano, ester, nitro, ketone, sulphonyl, alkylthio, sulphoxide group,
the functions F₀ and F₁ being as defined below:
F₀ corresponds to the following formula: 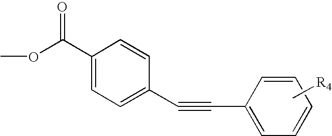
R₄ representing a group as defined for R₂ and R₃ above,
F₁ corresponds to one of the following formulae: 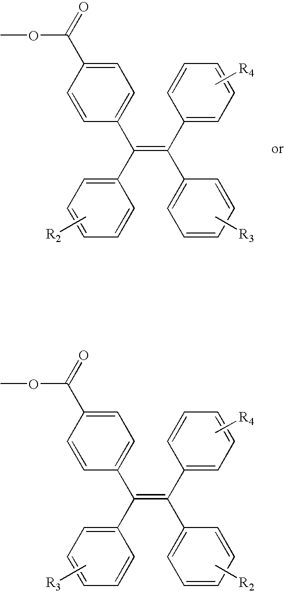
R₂, R₃ and R₄ being as defined above,
G corresponds to one of the following formulae: 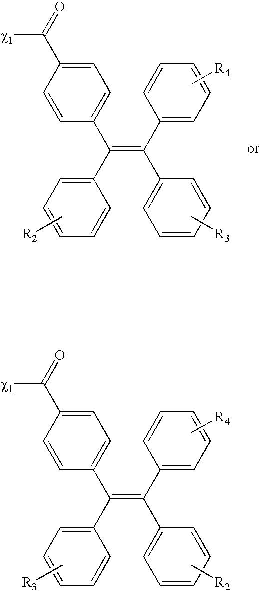
λ₁ representing an —OH group, or an —OR_{g} group, R_{g} representing a linear or branched alkyl group, comprising from 1 to 20 carbon atoms.

27. The use according to any one of claims 1 to 17, for the implementation of cycloaddition reactions, preferably for the implementation of the Diels-Alder reaction, according to the following reaction diagram: 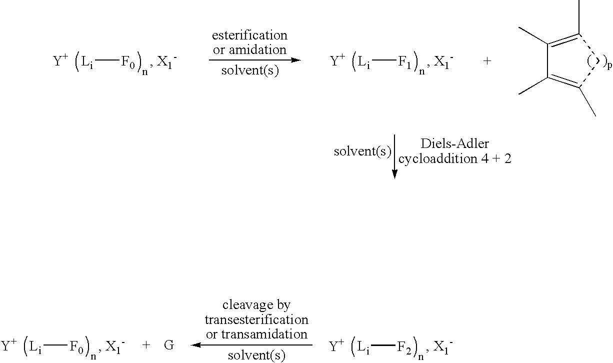
n being an integer varying from 2 to 4, as defined below,
i being an integer varying from 1 to n,
p being an integer varying from 0 to 2,
Y⁺ representing an onium cation as defined in one of claims 3 to 17, of formula (R_{b})ₓ₋ₙΛ⁺ in which x represents an integer equal to 3 or 4, n being equal to 2, 3 or 4 when x is equal to 4 and n being equal to 2 or 3 when x is equal to 3, R_{b} represents an alkyl group comprising from 1 to 20 carbon atoms, an aryl group comprising from 6 to 30 carbon atoms or an aralkyl or alkaryl group comprising from 6 to 30 carbon atoms, said abovementioned alkyl, aryl, aralkyl or alkaryl groups being non-functional, and in which Λ⁺ represents an ammonium, imidazolium, phosphonium or sulphonium cation, Y⁺ representing in particular an alkylammonium, alkylphosphonium or alkylsulphonium cation, and preferably being a tetraalkylammonium, tetraalkylphosphonium, dialkylimidazolium, trialkylsulphonium cation,
Lᵢ representing an arm, in particular a linear or branched alkyl group comprising from 1 to 20 carbon atoms, or an optionally functional aralkyl or alkaryl group, comprising from 6 to 30 carbon atoms, and preferably being a linear alkyl group, preferably a linear alkyl group of type (CH₂)ᵣ, r varying from 1 to 20, and preferably from 2 to 10, the arms Lᵢ being able to be identical or different,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, diimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
the functions F₀, F₁ and F₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 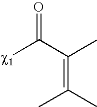
λ₁ being as defined above,
F₂ corresponds to the following formula: 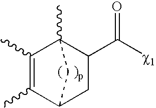
λ₁ being, as defined above,
G corresponding to the following formula: 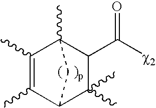
in which λ₂ represents either an OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms.

28. The use according to claim 19, for the implementation of the Heck reaction, according to the following reaction diagram: 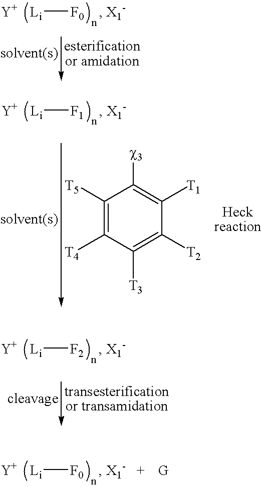
n being an integer varying from 2 to 4,
i being an integer varying from 1 to n,
Y⁺ representing an onium cation as defined in one of claims 3 to 17, of formula (R_{b})ₓ nΛ⁺ in which x represents an integer equal to 3 or 4, n being equal to 2, 3 or 4 when x is equal to 4 and n being equal to 2 or 3 when x is equal to 3, R_{b} represents an alkyl group comprising from 1 to 20 carbon atoms, an aryl group comprising from 6 to 30 carbon atoms or an aralkyl or alkaryl group comprising from 6 to 30 carbon atoms, said abovementioned alkyl, aryl, aralkyl or alkaryl groups being non-functional, and in which Λ⁺ represents an ammonium, imidazolium, phosphonium or sulphonium cation, Y⁺ representing in particular an alkylammonium, alkylphosphonium or alkylsulphonium cation, and preferably being a tetraalkylammonium, tetraalkylphosphonium, dialkylimidazolium, trialkylsulphonium cation,
Lᵢ representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 2 to 10, the arms Lᵢ being able to be identical or different,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
the functions F₀, F₁ and F₂ being as defined below:
F₀ corresponds to a −λ₁H group, in which λ₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁ corresponds to the following formula: 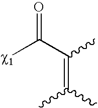
λ₁ being as defined above,
F₂ corresponds to the following formula: 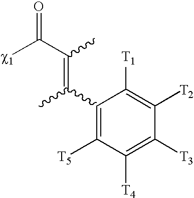
λ₁ being as defined above,
G corresponding to the following formula: 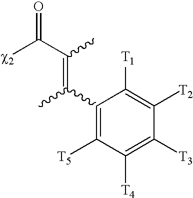
in which 72 represents either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms,
λ₃ representing a leaving group, in particular chosen from the I, Cl and Br halides, the mesylate, tosylate, triflate, sulphonate, sulphate or phosphate groups,
T₁, T₂, T₃, T₄ and T₅ representing independently of one another a hydrogen atom, a linear or branched alkyl group, comprising from 1 to 20 carbon atoms or an aryl group comprising from 6 to 30 carbon atoms, or a functional group in particular chosen from NO₂, CN, COOR, OR, COR, NHCOR, NRR″, SO₂R, I, Br, R and R″ representing independently of one another an alkyl group comprising from 1 to 20 carbon atoms or an aryl group comprising from 6 to 30 carbon atoms,
the entity 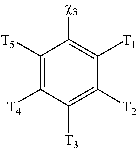
representing in particular the following groups:

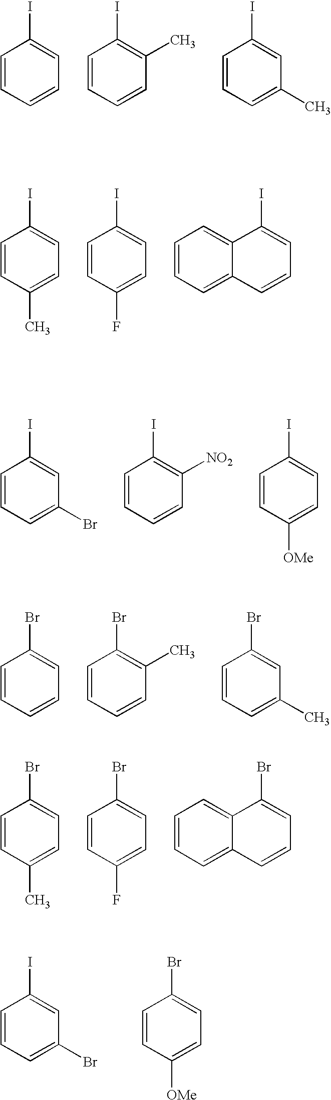

29. The use according to claim 19, for the implementation of Suzuki coupling, according to the following reaction diagram: 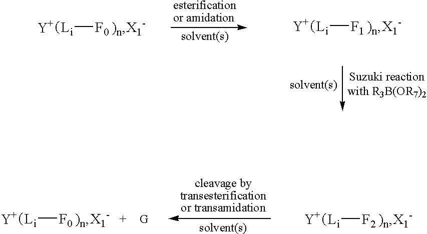
R₃ being chosen from the substituted or non-substituted aryl, heteroaryl, ethenyl, dienyl, allyl, ethynyl groups, comprising from 2 to 30 carbon atoms,
R₇ representing a hydrogen atom or a branched or linear alkyl group, or a cycloalkyl group comprising from 1 to 12 carbon atoms,
n being an integer varying from 2 to 4,
i being an integer varying from 1 to n,
Y⁺ representing an onium cation as defined in one of claims 3 to 17, of formula (R_{b})ₓ₋ₙΛ⁺ in which x represents an integer equal to 3 or 4, n being equal to 2, 3 or 4 when x is equal to 4 and n being equal to 2 or 3 when x is equal to 3, R_{b} represents an alkyl group comprising from 1 to 20 carbon atoms, an aryl group comprising from 6 to 30 carbon atoms or an aralkyl or alkaryl group comprising from 6 to 30 carbon atoms, said abovementioned alkyl, aryl, aralkyl or alkaryl groups being non-functional, and in which Λ⁺ represents an ammonium, imidazolium, phosphonium or sulphonium cation, Y⁺ representing in particular an alkylammonium, alkylphosphonium or alkylsulphonium cation, and preferably being a tetraalkylammonium, tetraalkylphosphonium, dialkylimidazolium, trialkylsulphonium cation,
Lᵢ representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 2 to 10, the arms Lᵢ being able to be identical or different,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄⁻³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
the functions F₀, F₁ and F₂ being as defined below:
F₀ is in the form −λ₁H, λ₁ representing an oxygen atom or an —NR_{f} group, R_{f} corresponding to a linear or branched alkyl group, comprising from 1 to 20 carbon atoms, or an aryl group comprising from 6 to 30 carbon atoms,
F₁ is in the form —Rₑ−λ, Rₑ representing an aromatic or heteroaromatic group comprising from 6 to 30 carbon atoms, X representing a leaving group preferably chosen from Cl, Br, I, OTf, O—CO₂R⁵ or OSO₃—R⁵, R⁵ representing an alkyl group comprising from 1 to 10 carbon atoms or an aralkyl group comprising from 6 to 30 carbon atoms, F₁ preferably corresponding to the following formula: 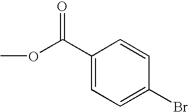
F₂ is in the form —Rₑ—R₂, Rₑ being as defined above and R₂ being chosen from the aryl, heteroaryl, ethenyl, dienyl, allyl, ethynyl groups, substituted or non-substituted, comprising from 2 to 30 carbon atoms, F₂ preferably corresponding to the following formula: 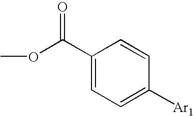
Ar₁ representing an aromatic group preferably chosen from: 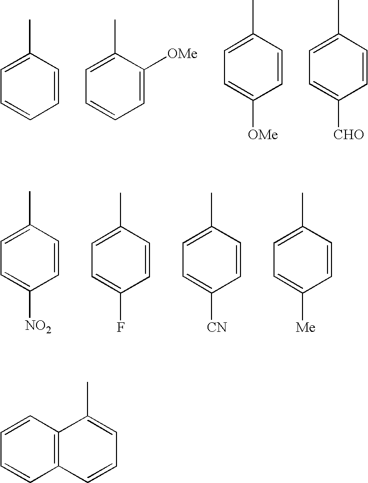
the molecule G being in the form R₂—R₃, R₂ and R₃ being as defined above, and corresponding in particular to the following formula: 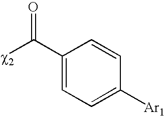
in which λ₂ represents either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms,
Ar₁ is as defined above.

30. The use according to claim 19, for the implementation of the Heck reaction, according to the following reaction diagram: 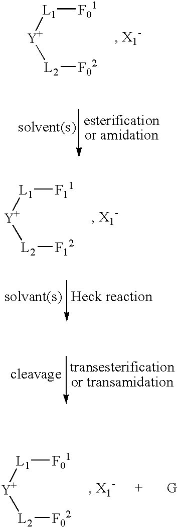
Y⁺ representing an onium cation as defined in one of claims 3 to 17, of formula (R_{b})ₓ₋₂Λ⁺ in which x represents an integer equal to 3 or 4, R_{b} represents an alkyl group comprising from 1 to 20 carbon atoms, an aryl group comprising from 6 to 30 carbon atoms or an aralkyl or alkaryl group comprising from 6 to 30 carbon atoms, said abovementioned alkyl aryl, aralkyl or alkaryl groups being non-functional, and in which Λ⁺ represents an ammonium, imidazolium, phosphonium or sulphonium cation, Y⁺ representing in particular an alkylammonium, alkylphosphonium or alkylsulphonium cation, and preferably being a tetraalkylammonium, tetraalkylphosphonium, dialkylimidazolium, trialkylsulphonium cation, Λ⁺ representing an ammonium or phosphonium cation when x=4 and a sulphonium cation when x=3,
L₁ and L₂, identical or different, representing an arm, in particular a linear or branched alkyl group comprising from 1 to 20 carbon atoms, or an optionally functional aralkyl or alkaryl group, comprising from 1 to 20 carbon atoms, and preferably being a linear alkyl group, preferably a linear alkyl group of type (CH₂)ᵣ, r varying from 1 to 20, and preferably from 2 to 10,
X₁⁻ being as defined in one of claims 1 to 17, and being in particular Cl⁻, Br⁻, I⁻, CF₃CO₂⁻, CH₃CO₂⁻, BF₄⁻, PF₆⁻, CF₃SO₃⁻, ⁻N(SO₂CF₃)₂, SO₄²⁻, R₁SO₄⁻, SbF₆⁻, R₁SO₃⁻, FSO₃⁻, PO₄⁻³⁻, R₁ representing an alkyl group comprising from 1 to 20 carbon atoms,
the solvent or solvents being chosen from: dichloromethane, tetrahydrofuran, dioxane, acetonitrile, dimethylformamide, dimethylacetamide, N-methylpyrrolidinone, propionitrile, acetone, toluene, chlorobenzene, nitrobenzene, dichlorobenzene, nitromethane, nitroethane, or a mixture of these solvents,
the functions F₀¹, F₁¹, F₀² and F₁² being as defined below:
F₀¹ corresponds to a −λ1₁H group, in which λ¹₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₀² corresponds to a −λ²₁H group, in which λ²₁ represents an oxygen atom or an —NR_{f} group, R_{f} corresponding to a linear or branched alkyl group, comprising from 1 to 20 carbon atoms, or an aryl group comprising from 6 to 30 carbon atoms,
F₁¹ corresponds to the following formula: 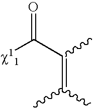
λ¹₁ being as defined above,
F₁² corresponds to the following formula: 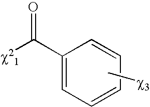
λ²₁ being as defined above, and
λ₃ representing a leaving group, in particular chosen from the I, Cl and Br halides, the mesylate, tosylate, triflate, sulphonate, sulphate or phosphate groups,
G corresponding to the following formula: 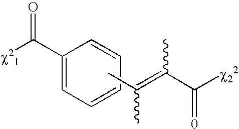
in which λ₂¹ and λ₂², identical or different, represent either an —OR_{g} group, R_{g} representing a hydrogen atom or an alkyl group comprising from 1 to 20 carbon atoms, or an —NRₕRᵤ group, Rₕ and Rᵤ representing independently of one another a hydrogen atom, an alkyl group comprising from 1 to 20 carbon atoms or an aryl group comprising from 6 to 30 carbon atoms.

31-60. (canceled)
